(19) United States
(12) Patent Application Publication
(10) Pub. No.: US 2026/0124750 A1
(43) Pub. Date: May 7, 2026

(54) BIPEDAL ACTION MODEL FOR HUMANOID ROBOT

(71) Applicant: Figure AI Inc., San Jose, CA (US)

(72) Inventors: Corey Lynch, San Jose, CA (US); Toki Migimatsu, San Jose, CA (US); Yeygen Chebotar, San Jose, CA (US); Michael Ahn, San Jose, CA (US); Ivan Babushkin, San Jose, CA (US)

(21) Appl. No.: 19/378,092

(22) Filed: Nov. 3, 2025

Related U.S. Application Data
(60) Provisional application No. 63/715,117, filed on Nov. 1, 2024.
(60) Provisional application No. 63/715,270, filed on Nov. 1, 2024.
(60) Provisional application No. 63/722,057, filed on Nov. 18, 2024.
(60) Provisional application No. 63/725,279, filed on Nov. 26, 2024.
(60) Provisional application No. 63/753,670, filed on Feb. 4, 2025.
(60) Provisional application No. 63/760,617, filed on Feb. 19, 2025.
(60) Provisional application No. 63/776,429, filed on Mar. 24, 2025.
(60) Provisional application No. 63/792,998, filed on Apr. 23, 2025.
(60) Provisional application No. 63/795,722, filed on Apr. 28, 2025.
(60) Provisional application No. 63/801,451, filed on May 7, 2025.
(60) Provisional application No. 63/808,832, filed on May 20, 2025.
(60) Provisional application No. 63/819,533, filed on Jun. 6, 2025.
(60) Provisional application No. 63/836,517, filed on Jul. 1, 2025.
(60) Provisional application No. 63/860,403, filed on Aug. 8, 2025.
(60) Provisional application No. 63/860,580, filed on Aug. 8, 2025.
(60) Provisional application No. 63/905,666, filed on Oct. 26, 2025.
(60) Provisional application No. 63/905,711, filed on Oct. 26, 2025.

(51) Int. Cl. B25J 9/16; B25J 9/00; B25J 13/08

(52) U.S. Cl. CPC B25J 9/1664; B25J 9/0081; B25J 9/163; B25J 9/1661; B25J 9/1697; B25J 13/087

(57) ABSTRACT

The present disclosure provides a control system for a humanoid robot comprising a bipedal action model (BAM) with hierarchical architecture including a beta model executing cognitive tasks at lower frequency, ingesting multimodal sensory inputs including visual data and natural language instructions, and an alpha model executing reactive tasks at higher frequency, communicatively coupled to the beta model. The BAM is trained on retargeted robot training data derived from robot-free training data. At runtime, the BAM outputs continuous control commands as parallel-generated action chunks controlling at least 18 degrees of freedom. The system includes a wearable collection apparatus capturing movement data from a human operator without physical connection to the robot, and a retargeting module translating robot-free training data into robot training data by solving embodiment mismatches between human and robot kinematic structures.

### CROSS-REFERENCE TO RELATED APPLICATIONS

This application claims the benefit of and priority to U.S. Provisional Patent Application Nos. 63/715,270, filed Nov. 1, 2024, 63/722,057, filed Nov. 18, 2024, 63/725,279, filed Nov. 26, 2024, 63/753,670, filed Feb. 4, 2025, 63/760,617, filed Feb. 19, 2025, 63/776,429, filed Mar. 24, 2025, 63/801,451, filed May 7, 2025, 63/819,533, filed Jun. 6, 2025, 63/860,403, filed Aug. 8, 2025, 63/860,580, filed Aug. 8, 2025, 63/905,666, filed Oct. 26, 2025 and 63/905,711, filed Oct. 26, 2025, each of which is expressly incorporated by reference herein in its entirety.

### TECHNICAL FIELD

This disclosure relates to systems, methods, and techniques for developing and deploying a bipedal action model (BAM) to control a humanoid robot. The humanoid robot includes a plurality of hardware and software components that are configured to substantially mimic the movements, functionality, and capabilities of a human.

### BACKGROUND

The field of robotics has long pursued the goal of creating humanoid robots capable of performing complex tasks in unstructured, human-centric environments. A significant challenge in this pursuit is the development of control systems that can manage the vast number of degrees of freedom (DoF) inherent in a humanoid form. Conventional robotic control systems have traditionally been limited in their scope and capability. Many existing models are narrowly focused, designed to control only a specific part of the robot, such as a 7-DoF end-effector or arm. This approach effectively treats the robot as a disembodied limb, failing to coordinate the entire body. As a result, such systems cannot perform actions that require dynamic balance, postural adjustments, or the use of the torso and legs to extend reach and navigate obstacles. The movements produced are often rigid and limited to a constrained set of pre-programmed motions.

Furthermore, a common deficiency in conventional systems is their reliance on generating discrete, or “binned,” action outputs. This method breaks down continuous motion into a finite set of poses or commands. The result is often jerky, imprecise, and unnatural movement, akin to a video with a low frame rate. This discretization introduces compounding errors over time, causing the robot to deviate from its intended path and struggle with tasks requiring fluid, continuous adjustments. These systems lack the temporal consistency needed for smooth, long-horizon tasks and are not robust enough to adapt to the unpredictable nature of real-world environments.

Therefore, a significant need exists for a more advanced control architecture that can overcome these fundamental limitations. There is a demand for a system that can provide comprehensive, whole-body control over a high-degree-of-freedom humanoid robot and generate continuous, real-time control outputs to produce fluid, human-like motion, thereby enabling more effective and reliable performance in complex, dynamic settings.

### SUMMARY

The presently disclosed subject matter is directed to a control system for a humanoid robot. The system comprises a bipedal action model (BAM) comprising a hierarchical architecture including a beta model configured to execute on one or more processors to perform cognitive tasks at a first, lower frequency, the beta model ingesting multimodal sensory inputs including visual data and natural language instructions, and an alpha model configured to execute on one or more processors to perform reactive tasks at a second, higher frequency, the alpha model being communicatively coupled to the beta model. The BAM is trained on a dataset comprising retargeted robot training data derived from robot-free training data. The BAM is configured to, at runtime, output a sequence of continuous control commands as parallel-generated action chunks to control a full-body motion of the humanoid robot, said full-body motion comprising at least 18 degrees of freedom.

The presently disclosed subject matter is directed to a system for generating a bipedal action model (BAM) for a humanoid robot. The system comprises a data collection system configured to generate robot-free training data, said data collection system comprising a wearable collection apparatus configured to be worn by a human operator, wherein the wearable collection apparatus includes a plurality of sensors configured to capture movement data of the human operator while the operator performs tasks without a physical or kinematic connection to the humanoid robot. The system comprises a retargeting module communicatively coupled to the data collection system, the retargeting module comprising one or more processors configured to receive the robot-free training data and translate the robot-free training data into retargeted robot training data by applying a motion retargeting methodology to solve an embodiment mismatch between a kinematic structure of the human operator and a kinematic structure of the humanoid robot. The system comprises a training subsystem configured to train the bipedal action model (BAM) using the retargeted robot training data, wherein the trained BAM is configured to ingest multimodal sensory inputs and output continuous control commands to control a plurality of degrees of freedom of the humanoid robot.

The presently disclosed subject matter is directed to a method for training a bipedal action model (BAM) to control a humanoid robot. The method comprises collecting robot-free training data from a human operator wearing a wearable collection apparatus, wherein the wearable collection apparatus captures movement data from a plurality of sensors as the human operator performs a task, and wherein said collecting is performed without kinematic coupling to the humanoid robot. The method comprises translating, via a retargeting module, the robot-free training data into retargeted robot training data, wherein said translating resolves an embodiment mismatch between a kinematic structure of the human operator and a kinematic structure of the humanoid robot. The method comprises training the BAM using the retargeted robot training data, wherein said training adjusts weights and biases of the BAM to identify non-linear correlations between multimodal inputs and continuous control commands. The method comprises configuring the trained BAM to, during runtime, ingest multimodal sensory inputs and output a sequence of the continuous control commands as floating-point action vectors to control a whole-body motion of the humanoid robot.

The presently disclosed subject matter is directed to a method for generating a bipedal action model for controlling a humanoid robot. The method comprises obtaining training data comprising multimodal sensory inputs and corresponding robot control commands. The method comprises processing the training data through a hierarchical architecture comprising a beta model configured to process visual data and natural language instructions to generate latent representations, and an alpha model configured to receive the latent representations and generate continuous robot control commands for a plurality of degrees of freedom of the humanoid robot. The method comprises training the hierarchical architecture using a regression loss function to adjust parameters of the beta model and the alpha model to identify correlations between the multimodal sensory inputs and continuous robot control commands. The method comprises deploying the trained hierarchical architecture to autonomously control the humanoid robot by continuously receiving multimodal inputs, processing the inputs through the beta model and alpha model, and outputting continuous robot control commands as action chunks spanning a future trajectory.

The presently disclosed subject matter is directed to a system for controlling a humanoid robot. The system comprises a humanoid robot having a plurality of degrees of freedom. The system comprises a perception system configured to capture multimodal sensory inputs comprising visual data from onboard cameras, proprioceptive state information from joint encoders, and natural language instructions. The system comprises a bipedal action model comprising a beta model configured to process the visual data and natural language instructions to generate latent representations, and an alpha model configured to receive the latent representations and generate continuous robot control commands for the plurality of degrees of freedom. The system comprises a whole-body controller configured to receive the continuous robot control commands as action chunks and generate low-level actuator-based controls for the humanoid robot, wherein the bipedal action model operates in a closed-loop configuration with feedback from executed actions.

The presently disclosed subject matter is directed to a data collection system for generating training data for robotic control models without requiring a physical robot. The system comprises a wearable collection apparatus configured to be worn by a human operator, the apparatus comprising a base mount, articulated arms pivotably attached to the base mount, and sensors positioned to measure movement of the human operator. The system comprises a control system coupled to the sensors and configured to collect movement data from the human operator performing tasks. The system comprises a processor configured to process the movement data to generate robot-free training data suitable for training robotic control models, wherein the movement data comprises positional and rotational information of the human operator's body segments captured at sampling rates ranging from 1 Hz to 10 kHz.

The presently disclosed subject matter is directed to a method for retargeting source data to robot control data. The method comprises receiving robot-free training data comprising sequences of human body poses and movements. The method comprises processing the robot-free training data through a kinematic mapping system that establishes correspondences between human joint configurations and robot joint configurations. The method comprises solving an optimization problem to find robot joint angles that minimize a distance between target task-space poses derived from the source data and robot forward kinematics. The method comprises applying constraints comprising joint angle limits, velocity limits, and collision avoidance constraints to ensure physically feasible robot configurations. The method comprises generating robot training data comprising sequences of robot joint configurations corresponding to the source data.

The presently disclosed subject matter is directed to a bipedal action model deployment system. The system comprises a local AI system integrated within a humanoid robot comprising onboard processors. The system comprises a remote AI system comprising servers positioned remotely from the humanoid robot. The system comprises a bipedal action model comprising an alpha model and a beta model, wherein the alpha model and beta model are selectively deployable between the local AI system and the remote AI system according to a deployment configuration, wherein the alpha model is configured to handle reactive tasks at a higher refresh rate and the beta model is configured to handle cognitive tasks at a lower refresh rate.

The presently disclosed subject matter is directed to a glove system for capturing hand and finger movement data. The system comprises a hand receptacle configured to be worn on a human hand. The system comprises a sensor assembly coupled to the hand receptacle and comprising a plurality of hand position sensors including finger encoders, thumb encoders, and pressure sensors. The system comprises deformable connectors coupling the finger encoders to finger portions of the hand receptacle, wherein each deformable connector comprises a deformable member configured to bend in a first inward direction to allow finger curling and bend in a second lateral direction to allow finger abduction, wherein a greater lateral force is required to move the deformable member a predetermined distance in the lateral direction compared to a curling force required to move the deformable member the same predetermined distance in the curling direction. The system comprises a control system configured to collect sensor data from the hand position sensors and generate hand movement data for training robotic control models.

The presently disclosed subject matter is directed to a computer-readable medium storing instructions that, when executed by a processor, cause the processor to perform operations. The operations comprise receiving multimodal inputs comprising visual data from robot cameras, proprioceptive state information, and natural language commands. The operations comprise processing the visual data through a vision encoder to generate vision tokens. The operations comprise processing the natural language commands through a language encoder. The operations comprise processing the proprioceptive state information through a state encoder. The operations comprise feeding the encoded information into a deployed bipedal action model comprising a beta model and an alpha model arranged in a hierarchical architecture. The operations comprise generating action chunks comprising sequences of continuous robot control commands for multiple future timesteps. The operations comprise transmitting the action chunks to low-level controllers of a humanoid robot for execution, wherein the action chunks cover a time horizon spanning 10 to 500 milliseconds.

In some embodiments, a bipedal action model (BAM) employs a hierarchical internal design comprising a beta model and an alpha model that exchange a latent vector. In some embodiments, the beta model is a vision-language model trained on internet-scale corpora comprising billions of image-text pairs with a cross-entropy loss to produce discrete outputs (e.g., tokens and latent summaries), while the alpha model is a cross-attention encoder-decoder transformer trained on robot data, including teleoperation demonstrations and simulated trajectories, using a regression loss (e.g., MAE/L1 or MSE/L2) to generate continuous robot control commands as floating-point action vectors. In some embodiments, the system is trained end-to-end by backpropagating a loss calculated from the alpha model's output through the latent connection into the beta model so that both models learn jointly, and the alpha model ingests the beta model's latent vector via cross-attention during inference.

In some embodiments, the beta model operates at a first, lower frequency between 1 and 20 Hz to perform cognitive tasks such as abstract reasoning, long-horizon planning, and nuanced language understanding, while the alpha model operates at a second, higher frequency between 100 Hz and 10,000 Hz—and, in some embodiments, up to 50 kHz—for reactive tasks including balance control, positioning of end effectors, force compliance, and collision avoidance; in some embodiments, the alpha model processes high-frequency reflexes at approximately 1 kHz and executes zero-moment-point control using real-time kernels. In some embodiments, the BAM outputs action chunks that represent sequences of k future actions spanning 1 millisecond to 10 seconds, which are processed by a whole-body controller with feedback loops to generate altered action chunks based on observed state evolution, enabling online replanning for tasks lasting minutes to hours. In some embodiments, the continuous control commands specify joint torques, velocities, or target positions and control at least 18 degrees of freedom of the humanoid robot and, in some embodiments, at least 62 degrees of freedom, with millisecond-scale latency achieved via cascaded neural network layers.

In some embodiments, the multimodal sensory inputs comprise real-time visual data from onboard cameras, proprioceptive state information from joint encoders and inertial measurement units, force-torque sensor readings from end effectors, and natural-language instructions. In some embodiments, the control system samples at 500-1000 Hz and applies drift-correction algorithms to achieve sub-degree tracking accuracy. In some embodiments, deployment is split, with the beta model executed on a remote AI system and the alpha model on a local AI system physically integrated within the humanoid robot; in other embodiments, both models are fully local or fully remote. In some embodiments, the local AI system includes embedded GPUs, TPUs, or neural processing units and performs tokenization and embedding for the alpha model, while computationally intensive transformer blocks of the beta model are executed remotely with tensor parallelism on elastic server infrastructure, and end-to-end latency is minimized via edge computing nodes and publish-subscribe messaging to support distributed intelligence across multiple robots.

In some embodiments, training data are organized in layers comprising: (i) a foundational layer of internet data and human videos; (ii) a middle layer of simulation and synthetic data generated with physics engines and neural rendering; and (iii) a top layer of real-world humanoid teleoperation data. In some embodiments, robot-free training data are captured with a wearable collection apparatus and translated to robot space via a kinematic mapping methodology that formulates an inverse-kinematics trajectory optimization minimizing Euclidean distance between human task-space and robot task-space poses over time, subject to joint-limit, self-collision-avoidance, and dynamic-stability constraints that maintain the center of mass within the support polygon; in some embodiments, the mapping achieves positional accuracy better than 5 mm and orientation accuracy better than 2°. In some embodiments, an alternative learning-based retargeting method employs an encoder-decoder network that encodes human motion sequences into a domain-invariant latent representation and, conditioned on robot kinematics, decodes predicted robot motions; adversarial training with a discriminator and a cycle-consistency loss encourages realism and reconstruction, and dynamic time warping aligns retargeted actions with robot demonstrations. In some embodiments, the BAM is trained to regress the retargeted trajectories, and the action-chunk interface allows single-step prediction of multiple future actions.

In some embodiments, the wearable collection apparatus includes a torso-mounted base with a pair of articulated arms (S1-S7) whose sensor joints correspond to a target robot's actuators (J1-J7), and gloves coupled to the distal ends. In some embodiments, each glove incorporates hand-position sensors including finger encoders with 12-14-bit resolution, pressure sensors with force thresholds of 2-5 N, and deformable polymer connectors that transmit force while allowing three-dimensional finger motion; each deformable connector may have a proximal end pivotably coupled to a respective finger encoder and a distal portion coupled to a fingertip haptic button, with the distal portion having stiffness 2-3× greater than a deformable mid-section to maintain an eyelet substantially perpendicular to the haptic button. In some embodiments, thumb sensing uses first and second encoders on substantially perpendicular axes corresponding to first and second thumb actuators; the sensor assembly further comprises a six-axis inertial measurement unit and a multi-layer printed circuit board for signal routing. In some embodiments, mechanical linkages are configured to bend more readily in a curling direction than laterally; alternatively or additionally, an electromagnetic-field source and multiple magnetic sensors determine finger pose via field attenuation or phase, and glove-mounted motors provide haptic feedback. In some embodiments, the system monitors for task failures during deployment, collects corrective teleoperation demonstrations on detection, and retrains the BAM to refine performance.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command or be commanded by, control or be controlled by, and/or interact;

FIG. 2 is a block diagram illustrating components of the humanoid robot of FIG. 1;

FIG. 3A is a perspective view of the humanoid robot of FIGS. 1-2;

FIG. 3B is a diagram illustrating actuators contained within the humanoid robot of FIG. 1-3A and the corresponding rotational axes of said actuators;

FIG. 4 is a block diagram of a movement controller for the humanoid robot of FIGS. 1-3B;

FIG. 5 is a block diagram of a behavior manager for the humanoid robot of FIGS. 1-3B;

FIG. 6 is a block diagram of an onboard artificial intelligence (AI) system for the humanoid robot of FIGS. 1-3B;

FIG. 7 is a diagram depicting an interaction of components contained within a computing architecture of the humanoid robot of FIGS. 1-3B;

FIG. 8 is a flowchart illustrating the process of training, running, and retraining a bipedal action model (BAM);

FIG. 9 is a diagram depicting an example architecture of the BAM, wherein said BAM includes an alpha model in the first (lower) layer L1, and an optional beta model in the second (upper) layer L2;

FIG. 10A is a diagram depicting a first deployment configuration of the BAM of FIG. 9, wherein both the alpha and optional beta models are deployed locally on the humanoid robot of FIGS. 1-3B;

FIG. 10B is a diagram depicting a second deployment configuration of the BAM of FIG. 9, wherein an alpha model is deployed locally on the humanoid robot of FIGS. 1-3B, while a beta model is not deployed locally on said humanoid robot;

FIG. 10C is a diagram depicting a third deployment configuration of the BAM of FIG. 9, wherein neither of the alpha nor the optional beta models is deployed locally on the humanoid robot of FIGS. 1-3B;

FIG. 11A is a diagram illustrating an example beta model of FIGS. 9-10C, wherein said beta model is an AI model that has been pretrained with a cross-entropy loss function and outputs discrete data;

FIG. 11B is a diagram illustrating an example alpha model of FIGS. 9-10C, wherein said alpha model is an AI model that has been pretrained with a regression loss function and outputs continuous data;

FIG. 12 is a block diagram depicting a collection of training data that may be used in generating the BAM;

FIG. 13 is a block diagram of a data collection system that may be used in collecting the training data of FIG. 12 and includes a wearable collection apparatus and a display;

FIG. 14 is a perspective view of the wearable collection apparatus and display of FIG. 13;

FIG. 15 is a perspective view of a second embodiment of the wearable collection apparatus of FIG. 13;

FIG. 16 is a perspective view of a first embodiment glove of the wearable collection apparatus of FIGS. 13-15;

FIG. 17 is a perspective view of a second embodiment glove of the wearable collection apparatus of FIGS. 13-15;

FIG. 18 shows a top view of a third embodiment glove of the wearable collection apparatus of FIGS. 13-15;

FIG. 19 is a perspective view of a fourth embodiment glove of the wearable collection apparatus of FIGS. 13-15;

FIGS. 20A-20B illustrates a perspective view of an operator wearing the data collection system and performing a task;

FIGS. 21A-21B are diagrams illustrating a series of screenshots that are captured during the performance of the task shown in FIGS. 20A-20B;

FIG. 22 is a diagram depicting kinematic mapping of source motion to robot motion;

FIG. 23 is a flowchart illustrating a process of learning based motion retargeting of robot-free data to robot data;

FIG. 24 is a flowchart illustrating a process of generating the BAM;

FIG. 25 is a diagram illustrating a training methodology that may be used in the generation of the BAM; and

FIG. 26 is a diagram depicting the deployment of a trained BAM.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

Disclosed herein is a bipedal action model (BAM) architecture characterized by a decoupled dual-system design, comprising a high-level cognitive beta model and a low-level reactive motor alpha model. The beta model, which may be a large, pretrained vision-language model with billions of parameters, is responsible for perception, language understanding, and long-horizon planning. It operates at a low frequency to process complex multimodal inputs, such as a user command like “get me a drink from the fridge,” and generates a task-conditioning latent vector that encapsulates the semantic goal of the task. This latent vector is then passed to the alpha model, a smaller, high-frequency visuomotor policy with millions of parameters, which translates the high-level intent from beta model into precise, continuous robot actions. This separation of concerns allows for independent development and optimization of the reasoning and control components, enabling the robot to benefit from the broad world knowledge of large models while maintaining the real-time responsiveness required for fluid and safe physical interaction in dynamic environments.

The placement of the alpha and beta models offers a range of deployment configurations to balance computational resources, latency, and autonomy. A fully local deployment, with both models running on the bipedal robot or humanoid robot's onboard hardware, minimizes communication latency and enables network-independent operation, which is suitable for tasks in environments with unreliable connectivity, but places a high demand on the robot's computational resources. The BAM's model architecture is highly configurable, allowing for different combinations of single and multiple models for the alpha and beta models to be employed. A system may be composed of a first pool that contains a single beta model and a second pool that contains a single alpha model. Meanwhile. the training of a BAM relies on a layered data structure that is designed to provide the model with a broad understanding of the world while grounding it in the specifics of robotic embodiment. The foundational layer consists of vast quantities of internet-scale text, images, and videos, supplemented by source data collected through robot-free methods like VR/AR systems, which provides a broad base of common-sense knowledge. The middle layer is composed of simulation and synthetic data, which provides a scalable way to generate millions of task-specific training examples in a controlled environment. The top layer contains the highest-fidelity real-world robot data, collected through teleoperation, which is essential for fine-tuning the model, bridging the sim-to-real gap, and ensuring its actions are physically plausible and effective.

Disclosed herein also include embodiments related to a data collection system, said system comprising a wearable collection apparatus configured to be worn by an operator to capture operator movement data. The apparatus may include a base frame supporting a control system, and at least one articulated arm extending therefrom, wherein the distal end of the articulated arm may be coupled to end-of-arm tooling operatively connected to a glove worn by the operator. A plurality of sensors, including but not limited to encoders and inertial measurement units, may be disposed along the wearable apparatus and articulated arms to capture kinematic data corresponding to the operator's movements. Furthermore, an embodiment of the glove may comprise a data acquisition device, including a glove housing that supports a thumb portion and a plurality of finger portions. Said portions may house one or more sensor assemblies, such as tactile sensor assemblies comprising strain gauges, configured to measure load, force, or strain experienced on the digits of the operator. A vision sensor may also be integrated into a palm portion of the glove housing. The data collected from the wearable apparatus sensors and the glove sensors may be processed by the control system and/or a computer to generate training data or real-time control commands for a robot, thereby facilitating intuitive teleoperation and the collection of high-fidelity manipulation data.

Further disclosed herein are methods and systems for acquiring robot-free data (or otherwise referred to as human-only data) to train a robotic model, which may be utilized as an alternative or a supplement to data acquired via active robot teleoperation. This human-only data acquisition approach may offer substantial advantages in scalability, cost-effectiveness, and data diversity, as it decouples the data collection process from the availability of a physical robot and may reduce operator training requirements. In some embodiments, data acquisition may be performed using commercially available devices, such as a virtual reality headset, which independently tracks an operator's head and hand movements and captures a first-person video stream as the operator performs a task, such as a pick-and-place operation or a bimanual towel-folding task. In other embodiments, data may be acquired by an operator utilizing a teleoperation apparatus, such as the wearable collection apparatus, in a passive mode, wherein motion data, including arm kinematics and finger positions, is captured without control commands being transmitted to a robot. This multimodal dataset, comprising, for example, time-synchronized video data and operator state data, may be used to train a model, such as a foundation model or policy, to associate visual scenes with demonstrated actions. Such robot-free data may be used in a hybrid training approach, wherein a model is initially trained on a large corpus of robot-free data before being fine-tuned with a smaller set of robot-specific teleoperation data.

Large volume of robot-free data collected needs to be retargeted to robot data for the purpose of training the BAM. The process may involve translating robot-free data, which may be sourced from mediums such as egocentric video or motion capture, into a format, such as joint-space commands or task-space trajectories, that is executable by a robotic system. Such translation is operative to address a paradigm shift in robot training, moving from costly and low-scale robot-specific teleoperation data collection to leveraging abundant, scalable, robot-free data. A core technical challenge in this translation is the significant embodiment mismatch between the source and the target robot, which may possess different kinematic structures, link lengths, degrees of freedom, and dynamic constraints. Methodologies for effecting this translation may include kinematic mapping approaches, which seek to define a geometric or mathematical relationship between the source and robot. Such kinematic methods may be formulated in joint-space, attempting a direct mapping of source joint angles to robot joint angles, or, more commonly, in task-space. Task-space formulations may identify Cartesian poses of key source end-effectors (e.g., hands, head) and then employ an inverse kinematics (IK) solver to compute a feasible robot joint configuration that satisfies those task-space goals, often as part of an optimization problem that further enforces constraints such as joint limits, self-collision avoidance, and stability, for example by maintaining a center of mass within a support polygon. As an alternative, learning-based methodologies may be employed to learn a complex, non-linear mapping. Given the practical scarcity of large-scale paired source-robot demonstration datasets, such learning systems may be implemented using unsupervised or semi-supervised frameworks that operate on unpaired datasets. These systems, often utilizing encoder-decoder architectures, may seek to learn a shared latent representation by disentangling domain-invariant motion information from domain-specific performer characteristics. The training of such models may be facilitated by adversarial objectives, to ensure generated motions are kinematically plausible for the robot, and cycle-consistency objectives, to ensure motion content is preserved. Furthermore, such systems may employ sequence-level alignment algorithms, such as Dynamic Time Warping or Optimal Transport, to find semantic correspondences between unpaired trajectories and generate synthetic data pairings or intermediate data domains via interpolation to facilitate a smooth adaptation from the source domain to the robot domain.

The training process for a BAM can be adapted to its specific architecture, such as a alpha model-only or a combined alpha/alpha model, and can be based on imitation learning or other types of learning. The process can involve preparing a comprehensive, multimodal training dataset, which is then used to train the selected model configuration. For an alpha model-only, the training focuses on learning a direct mapping from visual and state inputs to actions, making it highly proficient at a specific task. The co-trained of the combined alpha/alpha model can be an end-to-end process, where the error between the alpha model's predicted action and a ground-truth demonstration are backpropagated through both models. This allows the high-level beta model to be fine-tuned and its general knowledge to be grounded in the physical actions of the alpha model, leading to a more robust and generalizable policy.

The deployment of a trained BAM can involve a continuous, closed-loop process of perception, planning, and action. During runtime, the deployed model receives a stream of multimodal inputs, including user commands and real-time sensor and state data from the robot. This data is ingested by the BAM, which outputs a sequence of action chunks representing the desired future trajectory of the robot. These high-level actions can then translated into low-level motor commands by a whole body controller, which also performs a series of safety checks to ensure the commands are kinematically feasible and collision-free before executing them on the robot's actuators. The robot's new state is then fed back into the BAM, allowing for a continuous cycle of action generation that enables the robot to perform long-horizon tasks and dynamically adapt to its environment.

The disclosed BAM integrates artificial intelligence models into a tangible humanoid robot system, providing a particular technological solution to significant, long-standing problems in robotic control. This system is not a mere abstract application of AI, but a concrete apparatus comprising specific hardware, including multi-DoF electromechanical actuators, torque and position sensors, Inertial Measurement Units (IMUs), cameras, depth sensors, real-time motor controllers, and a distributed CPU/GPU/MCU compute architecture. A primary technical improvement offered by the BAM is its revolutionary approach to whole-body, continuous control. Conventional robotic systems are fundamentally limited, often confined to controlling a 7-degree-of-freedom (DoF) end-effector with discrete, binned-value outputs, which results in movements that are characteristically clunky, stilted, and imprecise. The disclosed BAM architecture overcomes this critical deficiency by providing direct, continuous control over the full sixty-two degrees of freedom (62-DoF) of the bipedal or humanoid robot. This high-level control is achieved by fusing multi-kilohertz sensor streams and driving closed-loop actuation at high frequencies, such as 50-350 Hz, while simultaneously coordinating this activity with lower-frequency (1-10 Hz) planning. This process, which utilizes deterministic, pre-emptive real-time scheduling on embedded controllers and hardware-level torque control via real-time message-passing protocols like EtherCAT/CAN-FD, applies real-world control signals to move the robot's mass in 3D space (SE(3)) subject to physical joint, thermal, and current limits. This constitutes a fundamental paradigm shift in control methodology, enabling highly coordinated, human-like motions that leverage the robot's entire physical structure for dynamic balance, extended reach, and sophisticated obstacle negotiation, thereby providing a specific, tangible improvement to the functioning and capability of the robot itself.

Furthermore, the BAM provides particular solutions to the well-known technical problems of compounding errors and command-latency variance inherent in prior art imitation learning and control systems. It solves this by employing a hierarchical planning and execution pipeline that generates, validates, and executes time-aligned, continuous “action chunks” over defined millisecond horizons. This “action chunking,” where a sequence of future actions is predicted and executed in a single inference step, specifically mitigates the accumulation of small prediction errors that cause conventional systems to deviate from desired trajectories. This capability is enabled by a specific, non-conventional internal architecture, such as a particular hierarchy defined by a Beta/Alpha split, with defined frequency ranges and deployment configurations. This architecture includes several technical features to solve latency and safety challenges, such as an asymmetric duplex interface in which L2 planning (e.g., the Beta model) transmits compact latents while L1 (e.g., the Alpha model) returns defined feedback signals, such as low-dimensional task-space Jacobian summaries, to improve manipulability awareness without saturating the communication bus. The system also employs latency-aware co-training that learns task-specific temporal offsets to align low-rate intent with high-rate actuation. Moreover, the architecture incorporates dynamic safety adapters, for instance an “L2.5” layer, that are automatically inserted when runtime safety margins fall below predefined thresholds and are removed when margins recover. This is combined with hardware-gated enforcement-including watchdogs, current and torque limiters, emergency-stop and safe-posture fallbacks, DMA-based sensor ingress, and prioritized interrupts—that constrains all inference outputs to certified safety envelopes. This particular, structured arrangement yields measurable technical benefits on the robot itself, including reduced jitter and overshoot, smoother trajectories, better stability margins, faster recovery from sensor dropouts, lower bus bandwidth for equivalent task success, improved mean-time-between safety stops, and decreased compute and battery load for a given task horizon.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the bipedal or humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

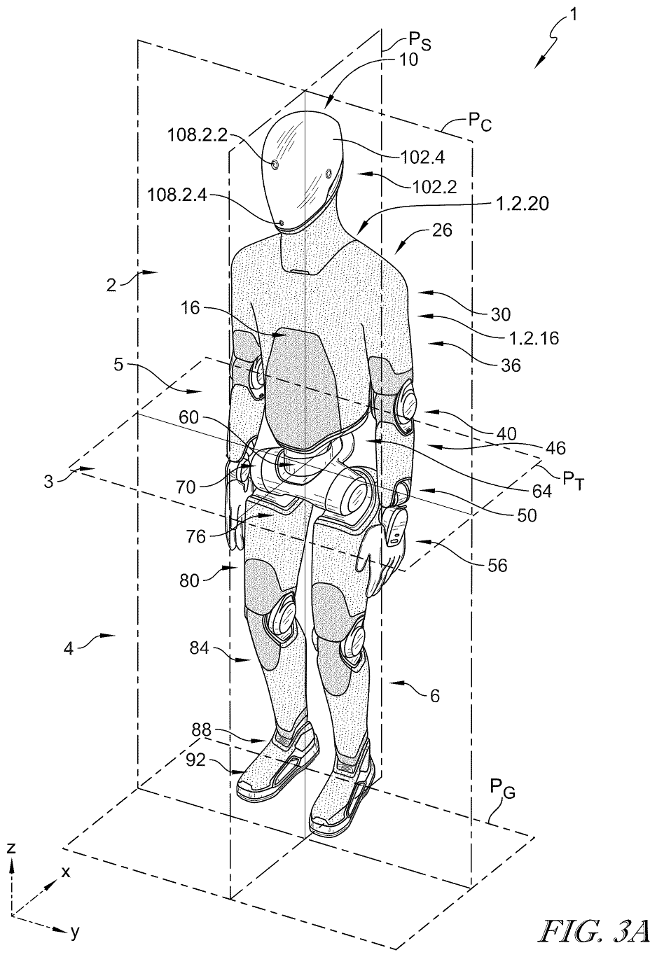

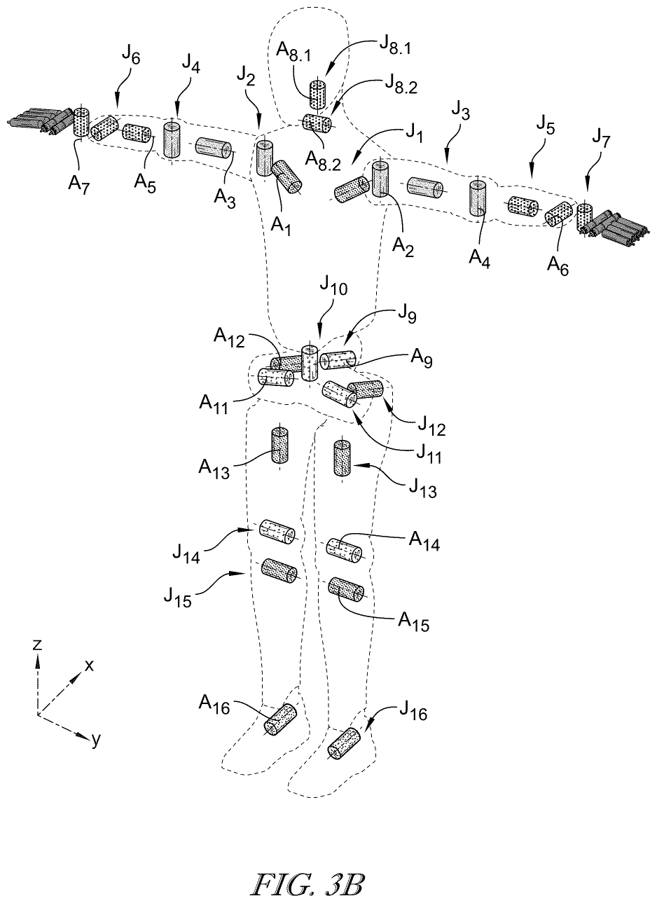

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (A₁) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (An).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

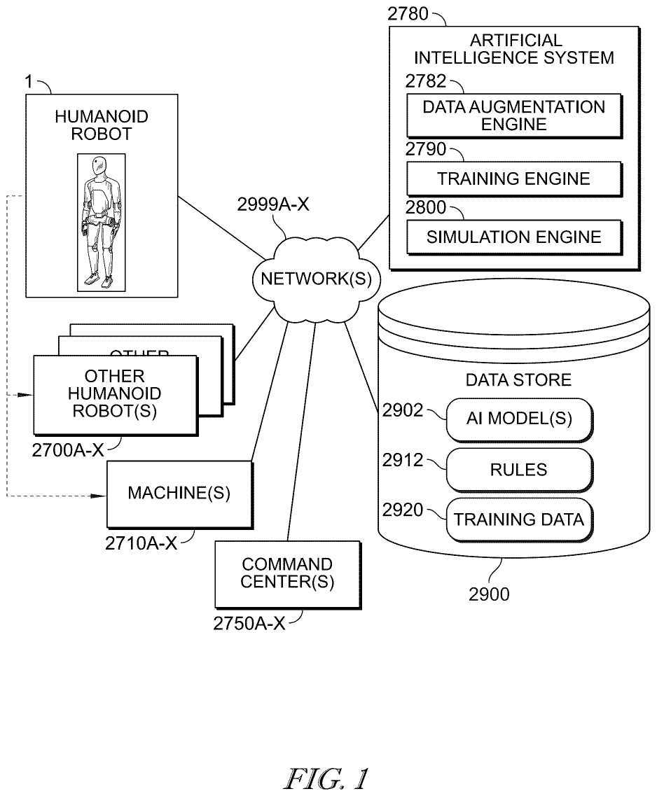

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/IL for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

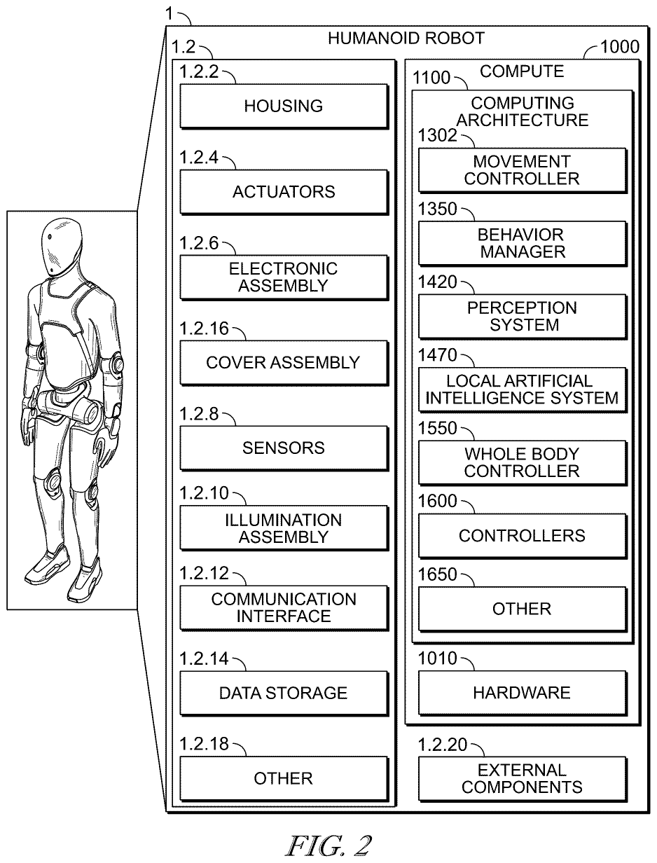

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### i. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

### ii. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### iii. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### iv. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

The actuators 1.2.4 contained within the robot 1 include thirty actuators (JA)-(J16), excluding the end effectors, that are housed within various components of the robot to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm | upper arm x, upper arm roll | A₃ |
| | | twist | | |
| (J4) 374 | 2 | elbow | arm z, arm yaw, | A₄ |
| | | | lower humerus | |
| (J5) 468 | 2 | lower arm | lower arm x, lower arm roll | A₅ |
| | | twist | | |
| (J6) 484 | 2 | wrist flex | wrist/hand y, wrist/hand | A₆ |
| | | | pitch, flick | |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts.

### c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

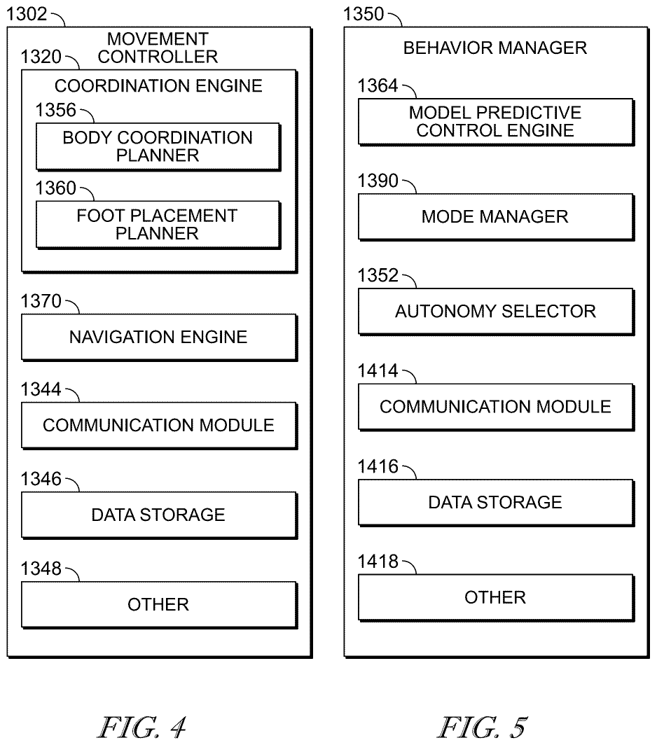

Referring to FIG. 4, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 5, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

### 4. Local AI System

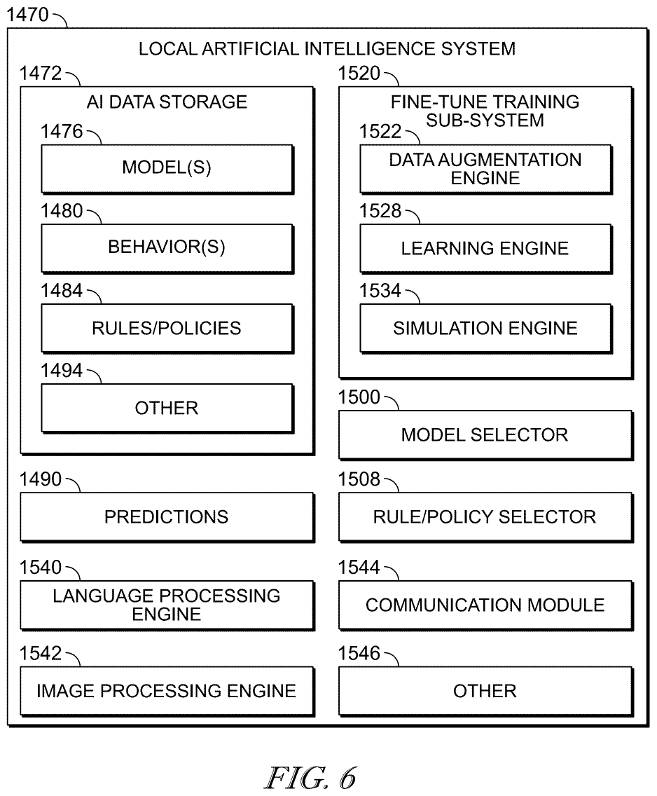

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 6.

Referring now to FIG. 6, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including visual, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### d. Interaction Between Components of the Computing Architecture

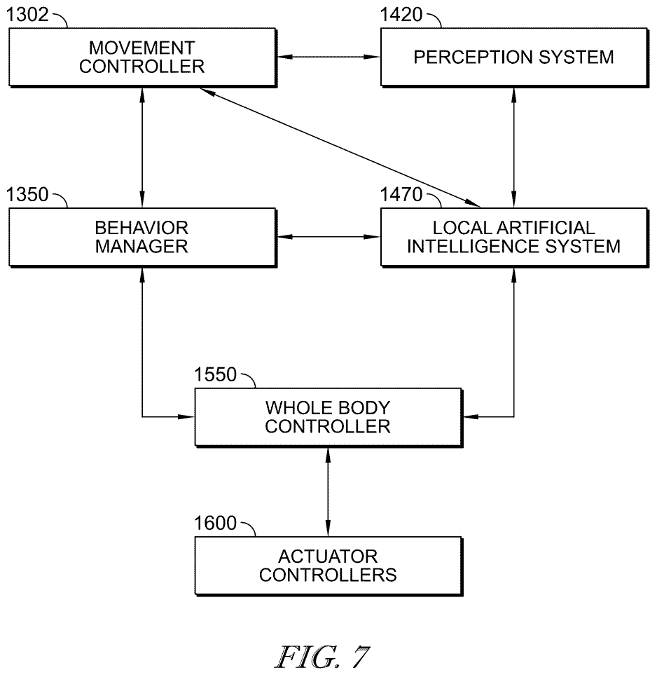

FIG. 7 depicts interactions between components of the humanoid robot 1 during its operation. Upon startup of the humanoid robot 1, the humanoid robot 1 may be in a standby mode or may otherwise remain idle in an initial position (e.g., standing, sitting, lying down, etc.). The robot 1 may initialize and activate its sensors 1.2.8 and obtain data in relation to the environment and surroundings of the robot 1, as well as positional data, audiovisual data, and the like. The movement controller 1302 may be configured to obtain data from its environment using the perception system 1420, while understanding the location and position of the robot 1 within said environment.

As described above, the environmental data and the robot data can be fed into: (i) the BAM, wherein a portion of said BAM (e.g., the alpha model 3101) is running on the local AI system 1470, and (ii) the behavior manager 1350. The BAM can then convert speech to text in order to obtain long-horizon goals, wherein said BAM can subdivide these long-horizon goals into one or more sub-goals or tasks. The BAM can then check with the behavior manager 1350 to confirm that the robot 1 is in the correct state for performing the first sub-goal or task. Once the state of the robot 1 is confirmed or the state of the robot 1 is changed to be in the right state, the BAM can determine the movements and actions to perform for a given specified task. For instance, the beta model 3102 of the BAM may process the task and sensor data to generate information that is provided to a semantic latent vector. This information is passed through said latent vector and into the alpha model 3101 of the BAM. The alpha model 3101 of the BAM may then communicate the detailed movement or action information to the whole body controller 1550, which in turn generates joint current data and/or torque data and transmits the data to the controllers 1600 to effect activity in the actuators 1.2.4 and cause the movement or action to be performed.

Each of the interacting components may provide feedback information to each other as the movements or actions are being performed. For example, the perception system 1420 may relay an indication to the movement controller 1302 that a given task is complete based on audiovisual data received during the performance of an action or movement. As another example, the behavior manager 1350 may be in continuous communication with the whole body controller 1550 to ensure that the movement and positioning of the robot 1 are as instructed and/or planned by the local AI system 1470. As yet another example, the local AI system 1470 may continuously receive data from the perception system 1420, the movement controller 1302, the behavior manager 1350, and the whole body controller 1550 and use the data to refine and optimize the currently executing model given present configurations, conditions, and constraints. It should be understood that the movement controller 1302, behavior manager 1350, perception system 1420, whole body controller 1550, and/or controllers 1600 may be omitted or replaced in alternative embodiments.

### E. Bipedal Action Model

Disclosed herein are systems, methods, and techniques for generating and deploying a bipedal action model (BAM), which is an end-to-end framework designed to control the complex, high-degree-of-freedom movements of humanoid robots 1, 2700A-X. As described herein, the BAM is designed to ingest multimodal sensory inputs, which may comprise a combination of real-time visual data from onboard cameras, proprioceptive state information from joint encoders and inertial measurement units, force-torque sensor readings from end effectors, and natural language instructions. The system outputs a continuous sequence of low-level robot control commands, or “actions,” that can be utilized by the robot 1, 2700A-X to directly specify joint torques, velocities, or target positions or deltas thereof. The disclosed BAM offers several key advantages over existing robotic control approaches, including, but not limited to: zero-shot generalization capabilities that enable the robot to perform novel tasks and interact with unseen objects without task-specific training through learned representations in high-dimensional feature spaces, direct continuous control over high-dimensional action spaces to produce fluid and precise motion, inherent capabilities for multi-robot collaboration through shared world models that maintain geometric and semantic consistency across robot instances, and a design that is commercially ready and fully scalable for deployment across fleets of robots 1, 2700A-X.

### a. BAM Generation

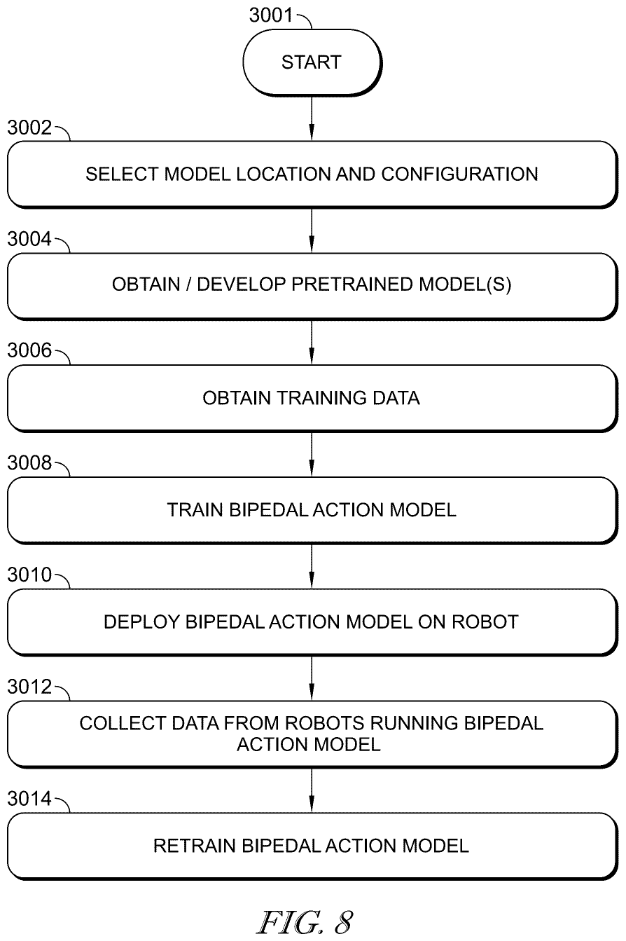

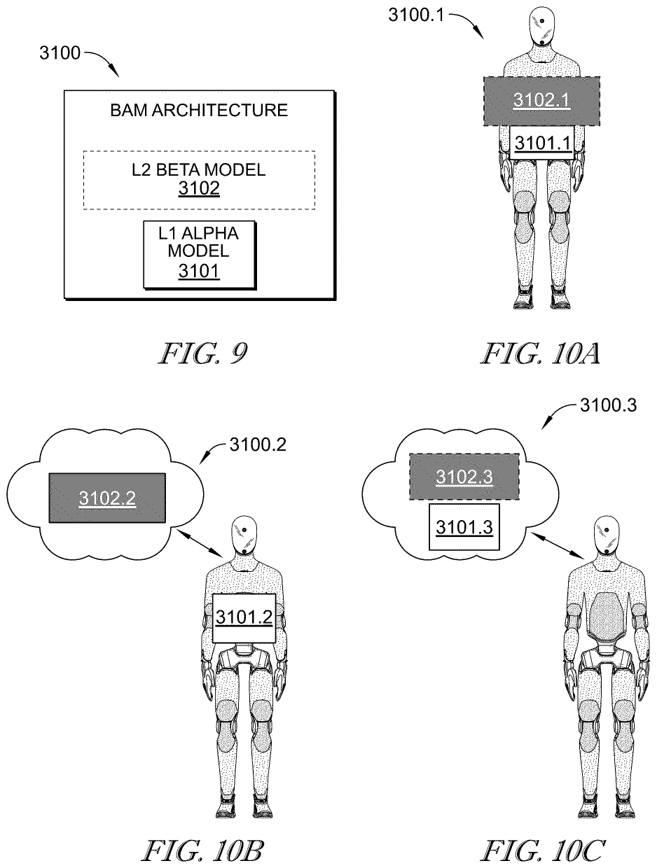

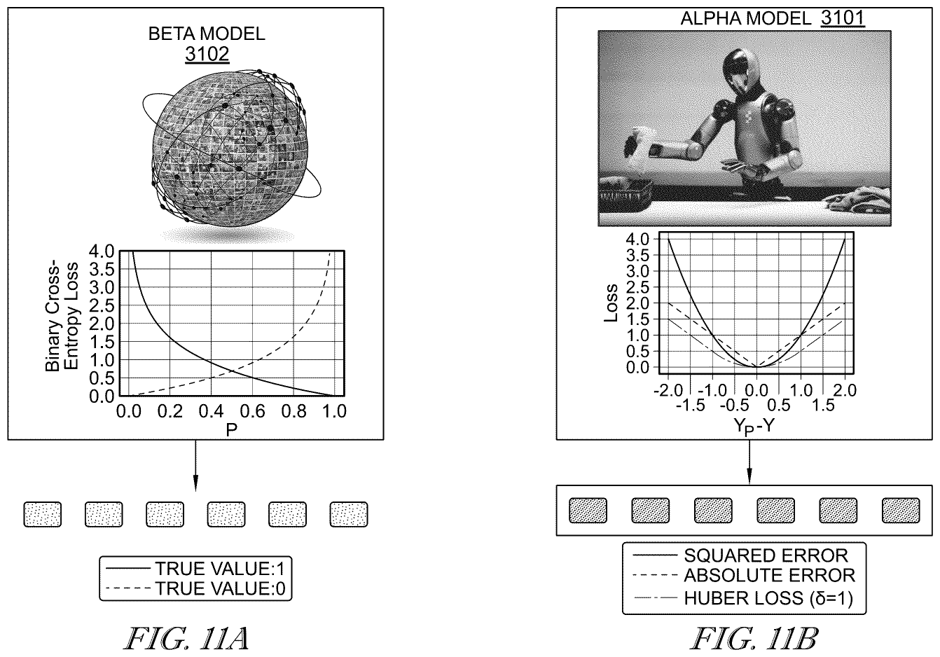

FIG. 8 illustrates a flowchart of a method for the development, deployment, use, and refinement of a bipedal action model (BAM). Following the initiation of the process at step 3001, a selection or development of foundational elements may be performed at step 3002, as shown in FIGS. 9-111B. This step involves specifying: (i) a deployment configuration, which dictates how computational resources are allocated between local onboard processors and remote servers, (ii) an internal architecture, which defines the arrangement and interaction of different model components through attention mechanisms, skip connections, and gradient flow pathways, and (iii) the specific type or types of machine learning models to be contained within the architecture, such as transformer-based models with multi-head attention mechanisms, diffusion-based models with denoising score matching, or hybrid architectures combining convolutional and recurrent elements. As such, step 3002 defines the foundational configuration, architecture, and components of the BAM.

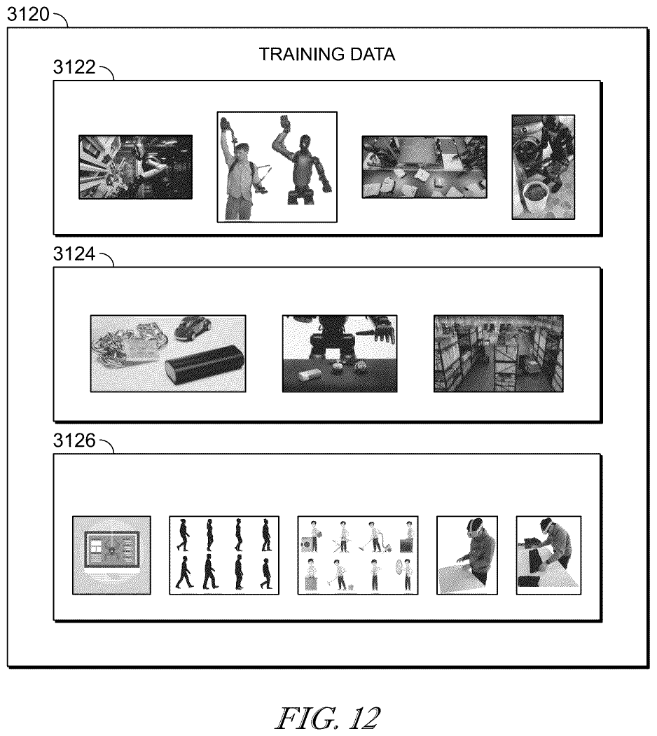

Once the designer has completed step 3002, the constituent software and hardware components of the BAM are obtained or developed in step 3004. As described below, this step of obtaining the components of the BAM may require procuring previously generated and pre-trained models and/or developing new, custom models from the ground up to meet specific performance criteria. Once the components of the BAM are obtained or generated in step 3004, the designer can focus their attention on obtaining training data in step 3006, as shown in FIG. 12. This training data may encompass a wide range of sensory inputs, actions, and environmental contexts relevant to the tasks the BAM is intended to perform, ranging from large-scale internet datasets containing billions of image-text pairs to specific, high-fidelity robot teleoperation logs with synchronized multi-sensor streams.

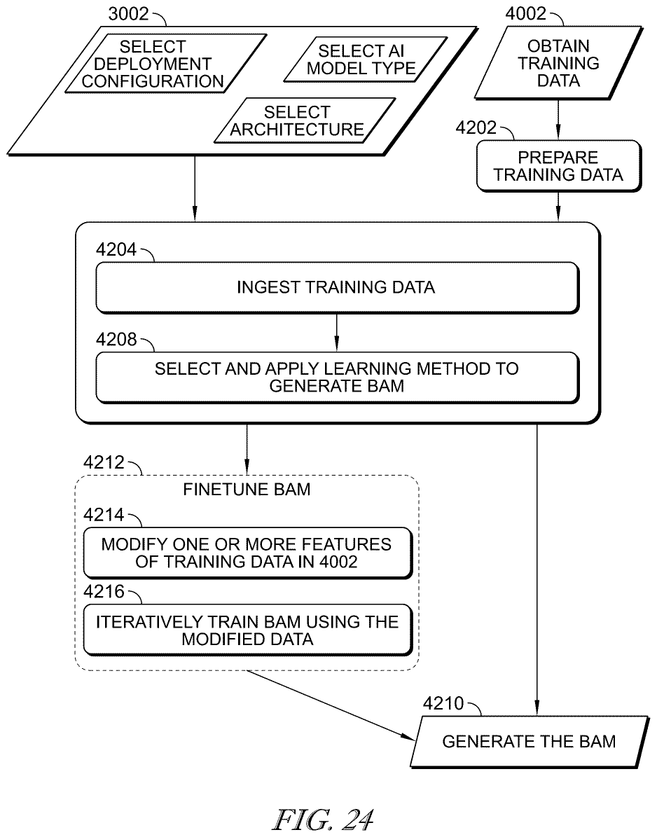

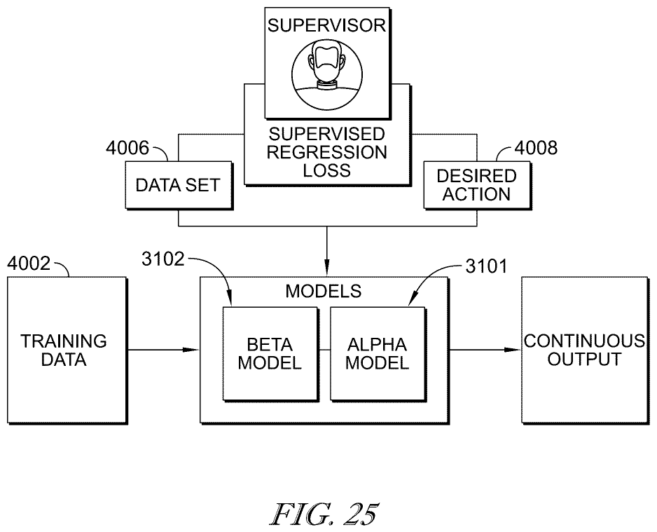

With the training data obtained and preprocessed in step 3006, the BAM may be trained at step 3008, as shown in FIGS. 24-25. This training process can involve the selection or development of a training methodology, wherein said training methodology is designed to adjust aspects of the previously obtained or generated components of said BAM. In particular, the aspects that can be adjusted in this step include the weights and biases of the neural network models contained in the BAM, normalization parameters, attention temperature coefficients, dropout probabilities, and/or other parameters of said models. The adjustment of these aspects is designed to facilitate the identification of complex, non-linear correlations between the multimodal inputs and the output of continuous robot control commands (e.g., not discrete commands—namely, not selected from a subset of values or bins, or “actions”). It should be understood that continuous robot control commands do not refer to a continuous time period, but rather to the fact that the values can be any floating point number (as opposed to being selected from a subset of values).

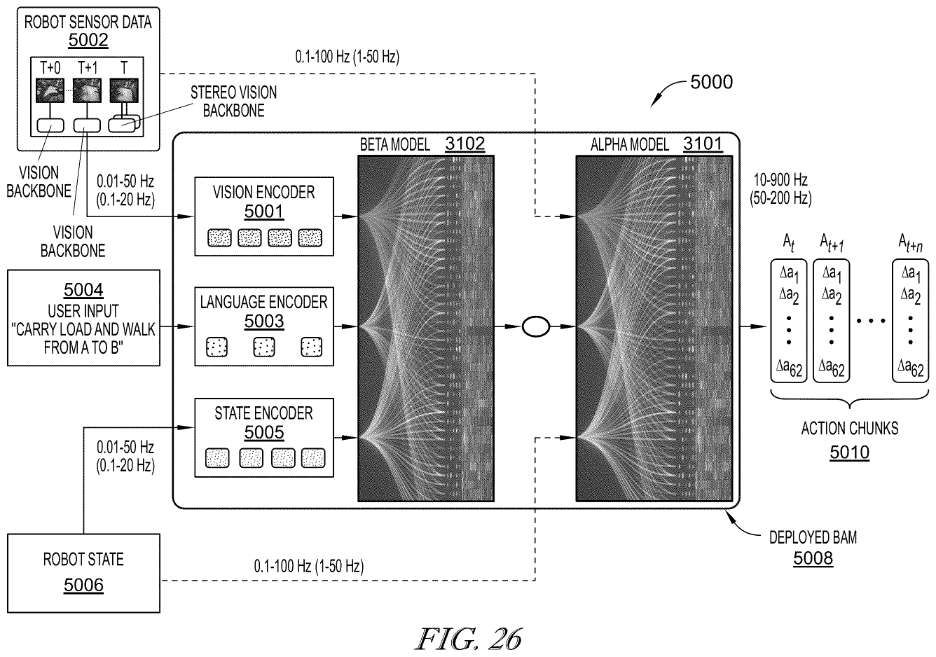

Upon completion of the training, the BAM may be deployed based on the selected or generated deployment configuration and utilized to autonomously control the humanoid robot 1, 2700A-X at step 3010, as shown in FIG. 26. During runtime, the deployed BAM continuously receives multimodal inputs (e.g., video streams at 30-60 frames per second and state information at rates between 1 Hz-50 kHz), processes these inputs through cascaded neural network layers with millisecond-scale latency, and outputs continuous robot control commands. The output of continuous robot control commands can then be organized into action chunks spanning 1 millisecond to 10 seconds of future trajectory. These action chunks can be processed or distributed by the whole-body controller 1550 to generate low-level or actuator-based humanoid controls. Once the low-level or actuator-based humanoid controls are generated and acted upon by the motor drivers and power amplifiers, said low-level or actuator-based humanoid controls can be fed back into the BAM through feedback loops to generate or alter the next action chunk based on the observed state evolution. This closed-loop design enables the robot to perform long-horizon tasks spanning minutes to hours and dynamically adapt its behavior in response to its ever-changing environment through online replanning and reactive control strategies.

While the robot is operating with the deployed BAM, new data can be collected at step 3012. This data may include successful task completions with reward signals, failure cases with diagnostic information, novel interactions with previously unseen objects or environments, and edge cases that expose model limitations. The collected data can then be used to update, retrain, or refine the BAM at step 3014 through techniques such as experience replay, hindsight relabeling, and adversarial training. This updating, retraining, or refining step enables iterative improvement of the model's performance metrics, allowing it to adapt its capabilities based on new experiences and information while maintaining backward compatibility with existing behaviors. This continuous learning loop facilitates creating a generalist model that can improve over time through lifelong learning mechanisms and expand its skill repertoire without forgetting previously learned tasks.

### i. Deployment Configuration

One of the first steps in generating a BAM involves the selection and/or identification of the desired deployment configuration. The BAM may be deployed in the remote AI system 2780 only, in the local AI system 1470 only, and/or split between the remote AI system 2780 and the local AI system 1470. It should be understood that the term “local” is intended to mean that the model or the identified portion of the model is running on computing hardware physically integrated within or attached to the robot 1, 2700A-X, including the above described embedded GPUs, TPUs, or specialized neural processing units. The term “remote” is intended to mean that the model or the identified portion of the model is running on computing hardware that is not local to the robot 1, 2700A-X. In other words, the term “remote” includes all servers, computers, edge computing nodes, and/or other equipment that is not physically integrated within or attached to the robot 1, 2700A-X, but can be located in the same building as the robot 1, 2700A-X, adjacent to the robot 1, 2700A-X, and/or distributed across data centers positioned around the world.

FIGS. 9-10C identify a few possible configurations of the BAM, but other configurations are contemplated by this disclosure. Further, the selection and/or creation of the internal architecture of the BAM is discussed in great detail below, and this subsection is primarily focused on what computing resources may be used to run the BAM. As such, FIG. 10B is a diagram depicting a first deployment configuration 3100.2 of the BAM, wherein a beta model 3102.2 is not deployed locally on the humanoid robot 1, 2700A-X of FIGS. 1-3B, while an alpha model 3101.2 is deployed locally on said humanoid robot 1, 2700A-X. In other words, the beta model 3102.2 is deployed on the remote AI system 2780, while the alpha model 3101.2 is deployed on the local AI system 1470. This arrangement beneficially allows the computationally demanding cognitive tasks (e.g., abstract reasoning, long-horizon planning, nuanced language understanding, etc.) that can run at a lower refresh rate or frequency of 1-100 Hz, and preferably between 1 and 20 Hz to be handled by the extensive resources of powerful remote servers, while performing the less computationally demanding reactive tasks (e.g., balance control, positioning of end effectors, force compliance, collision avoidance, etc.) that need to run at a higher refresh rate or frequency of 100 Hz-50 kHz to be handled by the less power hungry local computing resources optimized for real-time execution.

FIG. 10A is a diagram depicting a second deployment configuration 3100.1 of the BAM, wherein both the alpha model 3101.1 and the beta model 3102.1 are deployed locally on the humanoid robot of FIGS. 1-3B. This configuration can effectively minimize the communication latency between the alpha and beta models 3101.1, 3102.1, thereby enabling exceptionally fast, reactive control and immediate real-time decision-making without network dependencies. However, running both computationally distinct alpha and beta models 3101.1, 3102.1 locally may place high demands on the robot's onboard computing resources, potentially requiring more powerful processors, increased memory, and greater power consumption, which could impact the robot's overall design, weight distribution, and operational endurance. It should be understood that in some embodiments, the beta model 3102.1 may be omitted in this deployment configuration, and the BAM may only include a single alpha model 3101.1 optimized for the specific task domain.

FIG. 10C is a diagram depicting a third deployment configuration 3100.3 of the BAM, wherein neither the alpha model 3101.3 nor the beta model 3102.3 is deployed locally on the humanoid robot of FIGS. 1-3B. This architectural setup minimizes the computational load on the robot to the greatest extent possible through thin-client design principles, as all significant processing including neural network inference, trajectory optimization, and scene understanding is offloaded to scalable remote servers with elastic compute capabilities. This may be particularly advantageous for deploying fleets of robots that are designed to be lightweight with reduced mechanical inertia, energy-efficient with extended battery life exceeding 8 hours, and less expensive due to reduced onboard computing requirements that eliminate the need for high-end processors and cooling systems. It should be understood that the beta model 3102.3 may be omitted in this deployment configuration for simplified control pipelines, and the BAM may only include a single alpha model 3101.3 specialized for the target application domain.

In a further deployment configuration, some layers, functions (e.g., encoding through convolutional layers, decoding through transposed convolutions, attention mechanisms with query-key-value projections) of either the alpha model 3101 or the beta model 3102 may be split between the remote AI system 2780 and the local AI system 1470 using model partitioning strategies. For example, the alpha model 3101 and the tokenization and/or embedding layers associated with the beta model 3102, comprising vocabulary lookups and positional encodings, may be performed/run on the local AI system 1470 with SIMID optimizations, while the remaining computationally intensive transformer blocks of the beta model 3102 containing multi-head attention and feed-forward networks may be performed/run on the remote AI system 2780 with tensor parallelism.

In an alternative example, the high-frequency reflexes operating at 1 kHz and basic stability functions such as zero-moment-point control of the alpha model 3101 may be performed/run on the local AI system 1470 using real-time kernels, while the remaining tasks/functions of the beta model 3102 including trajectory generation and the alpha model 3101 for semantic understanding may be performed/run on the remote AI system 2780. Even further deployment configurations are contemplated, wherein a single remote model may communicate with models locally deployed on a plurality of robots through publish-subscribe architectures, or any other configuration that facilitates distributed intelligence based on this disclosure.

### ii. Internal Architecture

Along with selecting the deployment configuration, the designer must select the internal architecture for the BAM. The internal architecture may include an optional first pool of models and a second pool of models, wherein the first and second pools of models can include: (i) a single model, or (ii) a plurality of models. These pools and their associated models may be fully deployed on the local AI system 1470, fully deployed on the remote AI system 2780 (as described above), or a combination of local and remote deployment. Also, it should be understood that the BAM may have any type of hierarchical internal design, which may span from including two hierarchically arranged pools of models to n layers (e.g., where n is between 3 and 1,000) of hierarchically arranged pools of models. Moreover, as noted below, the BAM may only include a single model, and thus it may not have a hierarchical internal design. Further, the beta model(s) that are contained within the first pool may also be referred to as: (i) a second model, (ii) second sub-system, (iii) large/larger, (iv) slow/slower, (v) backbone, and/or (vi) thinking, while the alpha model(s) that are contained within the second pool may also be referred to as: (i) a first model, (ii) first sub-system, (iii) small/smaller, (iv) fast/faster, (v) actor, and/or (vi) reactive.

In one example, the BAM may include a first pool having a plurality of alpha models 3101, and a second pool having a plurality of beta models 3102. Each model contained in the plurality of alpha models 3101 may be different from all other models contained in said plurality of alpha models 3101. Each model contained in the plurality of beta models 3102 may be different from all other models contained in said plurality of beta models 3102. Further, it should be understood that all alpha models may be different from all beta models. For example, a first beta model 3102a may be designed to provide industrial cognitive reasoning, a second beta model 3102b may be designed to provide household cognitive reasoning, and a third beta model 3102c may be designed to provide retail cognitive reasoning. Likewise, a first alpha model 3101a may be designed to provide industrial reactive movements, a second alpha model 3101b may be designed to provide household reactive movements, and a third alpha model 3101c may be designed to provide retail reactive movements.

In another example demonstrating the flexibility of the architecture, the first pool might contain a first beta model 3102a specialized for fine-grained object recognition and a second beta model 3102b optimized for high-level spatial reasoning. Similarly, the second pool could include a first alpha model 3101a for dexterous, bimanual manipulation, and a second alpha model 3101b for efficient locomotion. At runtime, the humanoid robot 1, 2700A-X can dynamically select one or more of these models from the first and second pools to best suit the current task. For instance, to execute a command like “go to the kitchen,” the humanoid robot 1, 2700A-X might select the second beta model 3102b for its spatial reasoning capabilities and pair it with the second alpha model 3101b specialized locomotion capability. For a more complex task, such as “pick up the red block and place it on the blue one,” a first beta model 3102a with a fused SigLIP and DINOv2 vision encoder for robust perception could be paired with the first alpha model 3101a using a diffusion policy for precise, dexterous manipulation.

As shown in FIG. 9, the alpha models 3101 may have a first size (e.g., have the same number of parameters ranging from 10 million to 100 billion (preferably between 500 million and 30 billion) or the same context window spanning 100 tokens to 500,000 tokens) that is the same as the size of the beta models 3102, enabling balanced computational loads. Also, the alpha models 3101 may operate at a first frequency or refresh rate between 1-100 Hz (preferably between 1 and 20 Hz), which is the same as the frequency or refresh rate of the beta models 3102 for synchronized execution. This architectural modularity also enhances system resilience, as faults or errors in output from the beta model(s) 3102 can be sandboxed away from lower-level outputs of the alpha model(s) 3101, reducing the likelihood of an actuator or the robot behaving erratically in response to erroneous task logic.

In another embodiment, the BAM may include a first pool having a single beta model 3102, and a second pool having a plurality of alpha models 3101. In this embodiment, the BAM may provide a beta model 3102 that can provide general reasoning and a plurality of specialized alpha models 3101 (e.g., one that is tailored for each environment or task, as described above). Additionally, the beta model 3102 may have a higher or larger number of parameters exceeding 5 billion or a higher or larger context window exceeding 30,000 tokens than the number of parameters (e.g., below 1 billion) or the context window (e.g., below 10,000 tokens) of the alpha models 3101. Also, the beta model 3102 may operate at a first frequency or refresh rate of 1-25 Hz that is lower than the second frequency or refresh rate of 100-10,000 Hz of the alpha models 3101.

In a further embodiment and as shown in FIG. 9, the BAM includes an optional first pool having a single beta model 3102, and a second pool having a single alpha model 3101. In this embodiment, the pools of models are consumed by the single model contained in each of said pools. Like the second architecture, the beta model 3102 may be larger (e.g., higher number of parameters, larger context window) and have a lower frequency or refresh rate in comparison to the smaller (e.g., lower number of parameters, smaller context window) and higher frequency or refresh rate alpha model 3101 optimized for real-time execution. Also, as described above, the beta model 3102 may be omitted and the BAM may only include an alpha model 3101.

It should be understood that in other embodiments, the beta models 3102 may have a higher or larger number of parameters or a higher or larger context window than the number of parameters or the context window of the alpha models 3101. Finally, the beta models 3102 may operate at a first frequency or refresh rate that is lower than the second frequency or refresh rate of the alpha models 3101. Finally, the BAM may also be comprised of: (i) a first pool having a plurality of beta models 3102, and a second pool having a single alpha model 3101, (ii) a pool that contains a plurality of alpha models 3101, but omits the beta model 3102, (iii) a pool that contains a single or plurality of beta models 3102, and (iv) any other architecture that is obvious to one of skill in the art based on this disclosure.

### iii. Model Type

The alpha model(s) 3101 and the beta model(s) 3102 may be of any type of artificial intelligence models, machine learning models, neural network-based models, deep learning models, or generative artificial intelligence models. In addition to these general model types, the alpha model(s) 3101 and the beta model(s) 3102 may be classified as one, more than one, or a combination of large language models (LLMs), VLMs, multimodal large language models (MLLMs), audio models, video models, graph models, any combination thereof, and/or any other known model.

Further, the alpha model(s) 3101 and the beta model(s) 3102 may be implemented as and/or including: (i) transformer family architectures (e.g., decoder-only with causal masking; encoder-only (BERT) with bidirectional attention; cross-attention encoder-decoder (T5) with separated encoding and decoding; ViT/DeiT for image patches, Swin with hierarchical windows; Longformer with sparse attention, BigBird with random and global tokens, Reformer with locality-sensitive hashing, Linformer with linear complexity, Performer with kernel-based attention; Transformer-XL with segment-level recurrence, Memorizing Transformer with explicit memory; Cross-Modal Bridges for multi-modal fusion, Q-Former for query-based extraction; Perceiver/Perceiver-IO with latent bottlenecks; Graph Transformers for structured data), (ii) state-space/long-sequence & recurrence models (e.g., S4/S5 with structured matrices; Mamba/Mamba-2 with selective state spaces; RetNet with retention mechanisms; Liquid Models with continuous-time dynamics; Hyena/Long Convolutions with implicit parameterization; Linear-Attention Kernels with softmax alternatives), (iii) recurrent neural networks (e.g., LSTM/GRU/SRU with gating mechanisms; RWKV with linear complexity; RNN-T for sequence transduction), (iv) convolutional neural network architectures (e.g., ResNet/EfficientNet/ConvNeXt with modern design principles; U-Net for dense prediction; Sparse/3D CNNs (Minkowski) for point clouds), (v) graph neural network & geometric architectures (e.g., GCN/GAT/GIN with message passing; GraphSAGE with sampling; EGNN with equivariance; SE(3)—Transformers with group theory; E(n)—Equivariant CNNs preserving symmetries), (vi) spiking neural networks (e.g., Event-Driven SNNs with temporal coding), (vii) MLP-Style Vision architectures (e.g., MLP-Mixer with token mixing; gMLP with gating; MetaFormer-Style Variants abstracting transformer components), (viii) audio-centric backbones (e.g., Conformer combining convolution and attention; TasNet/Conv-TasNet for source separation; wav2vec/HuBERT for self-supervised speech; Diffusion Vocoders for waveform generation), (ix) sets/point clouds/3D representations (e.g., DeepSets/Set Transformer with permutation invariance; PointNet/PointNet++ with hierarchical features; Point Transformer adapting attention; KPConv with kernel convolutions; Minkowski networks for sparse voxels), (x) implicit neural representations/neural fields (e.g., SIREN with periodic activations; NeRF Family Including Mip-NeRF with anti-aliasing, Instant-NGP with hash encoding; DeepSDF for shape representation; 3D Gaussian Splatting for fast rendering), (xi) autoregressive models (e.g., Token/Patch/Audio AR with sequential generation; PixelCNN/RNN for images; AR Transformers with causal masking), (xii) variational autoencoder & latent-variable models (e.g., 3-VAE with disentanglement; Hierarchical VAEs with multiple scales), (xiii) diffusion/score-based models (e.g., LDMs in latent space; DiT with transformers; Video Diffusion with temporal consistency; Vocoders for audio synthesis), (xiv) normalizing flows (e.g., RealNVP with coupling layers; Glow with invertible convolutions; Neural ODE Flows with continuous dynamics; FFJORD with free-form Jacobians), (xv) generative adversarial networks (e.g., StyleGAN with style modulation; BigGAN with class conditioning), (xvi) energy-based models (e.g., Including Boltzmann/RBMs with stochastic units), (xvii) masked/denoising objectives (e.g., BERT-Style MLM for language; MAE for images; Denoising AEs with corruption), (xviii) contrastive/self-distillation methods (e.g., CLIP for vision-language; SimCLR for visual representations; MoCo with momentum encoding; DINO/iDINO with self-distillation), (xix) tokenization/latent tokenizers (e.g., VQ-VAE/VQ-GAN with discrete codes; Tokenizer-Decoder Stacks for compression), (xx) preference/RL fine-tuning (e.g., RLHF/RLAIF with human feedback; DPO for direct optimization), (xxi) mixture-of-experts (MoE) systems (e.g., Switch with routing; GShard with sharding; DeepSeek-MoE with sparse activation), (xxii) retrieval & external memory (e.g., RAG for knowledge grounding; kNN-LM with nearest neighbors; NTM with differentiable memory; DNC with addressing mechanisms), (xxiii) world/dynamics models (e.g., PlaNet/RSSM/Dreamer with latent dynamics; MuZero-Style with planning; Latent ODE Dynamics with continuous time; Diffusion World Models for stochastic environments), (xxiv) multimodal fusion strategies (e.g., Cross-Attention Bridges between modalities; FiLM-Style Conditioning with affine transformations; Gated Fusion with learnable weights; Q-Former/Perceiver Latents for bottleneck processing), any combination thereof through hybrid architectures, and/or any other type that advances the state of the art based on this disclosure.

Additionally, this Application contemplates that the alpha model(s) 3101 and the beta model(s) 3102 could use or include any model type disclosed in any one of the following papers: Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Yao, Lewei, et al. “Filip: Fine-grained interactive language-image pre-training.” arXiv preprint arXiv:2111.07783 (2021), Rombach, Robin, et al. “High-resolution image synthesis with latent diffusion models.” Proceedings of the IEEE CVF conference on computer vision and pattern recognition. 2022, Li, Junnan, et al. “Blip: Bootstrapping language-image pre-training for unified vision-language understanding and generation.” International conference on machine learning. PMLR, 2022, Zhang, Renrui, et al. “Llama-adapter: Efficient fine-tuning of language models with zero-init attention.” arXiv preprint arXiv:2303.16199 (2023), Liu, Haotian, et al. “Visual instruction tuning.” Advances in neural information processing systems 36 (2024), Liu, Haotian, et al. “Improved baselines with visual instruction tuning.” Proceedings of the IEEE/CVF Conference on Computer Vision and Pattern Recognition. 2024, Lin, Ji, et al. “Vila: On pre-training for visual language models.” Proceedings of the IEEE/CVF Conference on Computer Vision and Pattern Recognition. 2024, Jin, Yang, et al. “Unified Language-Vision Pretraining in LLM with Dynamic Discrete Visual Tokenization. arXiv 2024.” arXiv preprint arXiv: 2309.04669, Maniparambil, Mayug, et al. “Do Vision and Language Encoders Represent the World Similarly?.” Proceedings of the IEEE/CVF Conference on Computer Vision and Pattern Recognition. 2024, Liu, Daizong, et al. “A Survey of Attacks on Large Vision-Language Models: Resources, Advances, and Future Trends.” arXiv preprint arXiv:2407.07403 (2024), Chang, Yupeng, et al. “A survey on evaluation of large language models.” ACM Transactions on Intelligent Systems and Technology 15.3 (2024): 1-45, Yin, Shukang, et al. “A survey on multimodal large language models.” arXiv preprint arXiv:2306.13549 (2023), Zhang, Duzhen, et al. “Mm-llms: Recent advances in multimodal large language models.” arXiv preprint arXiv:2401.13601 (2024), Vaswani, A. “Attention is all you need.” Advances in Neural Information Processing Systems (2017), Radford, A. “Improving language understanding by generative pre-training.” (2018), Wang, Wei, et al. “Structbert: Incorporating language structures into pre-training for deep language understanding.” arXiv preprint arXiv:1908.04577 (2019), Radford, Alec, et al. “Language models are unsupervised multitask learners.” OpenAI blog 1.8 (2019): 9, Liu, Yinhan. “Roberta: A robustly optimized bert pretraining approach.” arXiv preprint arXiv:1907.11692 (2019), Sanh, V. “DistilBERT, A Distilled Version of BERT: Smaller, Faster, Cheaper and Lighter.” arXiv preprint arXiv:1910.01108 (2019), Raffel, Colin, et al. “Exploring the limits of transfer learning with a unified text-to-text transformer.” Journal ofmachine learning research 21.140 (2020): 1-67, Brown, Tom B. “Language models are few-shot learners.” arXiv preprint arXiv:2005.14165 (2020), Touvron, Hugo, et al. “Llama 2: Open foundation and fine-tuned chat models.” arXiv preprint arXiv:2307.09288 (2023), Schulman, John, et al. “Proximal policy optimization algorithms.” arXiv preprint arXiv:1707.06347 (2017), Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Chen, Zhe, et al. “Internvl: Scaling up vision foundation models and aligning for generic visual-linguistic tasks.” Proceedings of the IEEE CVF Conference on Computer Vision and Pattern Recognition. 2024, all of which are incorporated herein by reference and in their entirety for any purpose.

As shown in 4202FIGS. 11A-11B, the beta model 3102 may be a vision-language model (VLM) that was trained using internet-scale data comprising billions of image-text pairs with a cross-entropy loss function to output discrete data, whereas the alpha model 3101 is a cross-attention encoder-decoder transformer trained on robot data including teleoperation demonstrations and simulated trajectories using a regression loss function to output continuous data as floating-point action vectors. The selection of an open-weight pre-trained vision-language model is beneficial because it simplifies the training pipeline to provide the model with context awareness through learned representations, reduces data requirements through transfer learning, and enables zero-shot generalization to novel scenarios. Using a robot-trained cross-attention encoder-decoder transformer that outputs continuous data is also beneficial, as the model weights are tailored to the robot's kinematics through embodiment-specific training, offering high precision due to the model's ability to directly predict the floating-point values for each action dimension without quantization artifacts, and avoids discretization errors that arise from binning continuous spaces. The selection of these models represents a significant leap forward over conventional solutions that generate clunky movements with temporal inconsistencies, as these conventional solutions split the continuous action dimension into a finite number of bins resulting in discretization artifacts when predicting the appropriate bin for each degree of freedom.

Moreover, the models 3101, 3102 may incorporate techniques such as Low-Rank Adaptation (LoRA) with rank decomposition, Quantized LoRA (QLoRA) combining quantization and adaptation, Adaptive LoRA (AdaLoRA) with importance-based allocation, Decomposed LoRA (DoRA) separating magnitude and direction, Kronecker/Hadamard Low-Rank Adapters (LoKr/LoHa) with structured matrices, Sparse LoRA with selective updates, Adapter-Based Fine-Tuning (Houlsby Adapters) with bottleneck layers, Pfeiffer Adapters with sequential processing, Parallel Adapters with concurrent paths, Compacter (Parameter-Sharing Adapters) with hypercomplex numbers, MAD-X (Modular Adapter Exchange) for task switching, AdapterFusion combining multiple adapters, AdapterDrop for efficient inference, UniPELT (Unified Parameter-Efficient Tuning) integrating methods, Prefix-Tuning with virtual tokens, Prompt Tuning (Soft Prompts) with learnable embeddings, P-Tuning v2 with deep prompt encoding, Deep Prompt Tuning across layers, Visual Prompt Tuning (VPT) for vision models, BitFit (Bias-Only Fine-Tuning) updating only biases, IA³ (Input-Attention-Activation Multiplicative Adapters) with element-wise scaling, Side-Tuning with parallel networks, Ladder Side-Tuning with hierarchical connections, Knowledge Distillation (Logit Matching) transferring predictions, Feature/Intermediate-Layer Distillation preserving representations, Self-Distillation (Born-Again Networks) with self-teaching, Sequence-Level Distillation for generation tasks, Multi-Teacher/Ensemble Distillation combining knowledge sources, Online Distillation with co-training, Policy Distillation for reinforcement learning, Data-Free Distillation without training data, Post-Training Quantization (PTQ) reducing precision, Quantization-Aware Training (QAT) with simulated quantization, 8-Bit Optimizers for memory efficiency, NF4/FP4 Low-Precision Training with novel formats, GPTQ with Hessian-based quantization, AWQ with activation-aware quantization, SmoothQuant balancing weights and activations, Structured/Unstructured/Movement Pruning removing parameters, N:M Sparsity with hardware acceleration, Low-Rank SVD Adapters decomposing weight matrices, DreamBooth for subject-driven generation, Textual Inversion learning new concepts, HyperNetworks generating weights, Diffusion-LoRA for generative models, any combination thereof implementing hybrid strategies, any technique disclosed in a paper that is incorporated herein by reference advancing the field, and/or any other technique that enhances model efficiency and adaptation based on this disclosure.

The above models 3101, 3102 and incorporated techniques may have been generated using any one or combination of the following loss functions: cross-entropy loss (with label smoothing), negative log-likelihood (token-level NLL/perplexity), regression losses (MSE/l2, MAE/l1, huber/smooth-l1), kullback-leibler (kl) divergence, connectionist temporal classification (CTC) loss, rnn-t loss, infonce/NT-XENT (contrastive) loss, focal loss, dice/IOU (jaccard) loss, perceptual/quality losses (feature-space/VGG, SSIM, LPIPS), adversarial GAN losses (non-saturating/logistic, hinge, WGAN-GP), exact log-likelihood/bits-per-dim (normalizing flows), diffusion objectives (s-prediction MSE, v-parameterization, xo-prediction, variational lower bound), VAE evidence lower bound (ELBO) including p-VAE, autoregressive maximum-likelihood (teacher-forcing NLL), spectral/audio losses (STFT/multi-resolution STFT, SI-SDR/SI-snr with pit), 3D/NERF/point-cloud losses (photometric L1/L2, chamfer distance, earth mover's distance, eikonal regularization), tokenizer/codebook losses (VQ commitment/codebook/ema), multimodal alignment/matching losses (image-text/audio-text contrastive and ITM), distillation objectives (temperature-scaled cross-entropy, KL to teacher, feature/attention transfer), and/or reinforcement-learning fine-tuning objectives (PPO-clip with value/entropy and KL regularization to a reference, direct preference optimization (DPO)).

It should also be understood that the models may be pretrained using any of the following data: (i) image data (e.g., raw image data, annotated image data, synthetic data comprising computer-generated images used to augment real image datasets such as in instances where usable data is scarce, etc.), (ii) video data (e.g., raw video data, annotated video data, synthetic data comprising simulated video data used to train models on dynamic scenarios and interactions, etc.), (iii) text data (e.g., natural language instructions, dialogue data, machine readable instructions, natural language mapping data, etc.), (iv) depth data (e.g., map data, point cloud data from LiDAR or structured light sensors, etc.), (v) robot joint trajectories, (vi) robot joint locations, (vii) robot joint location data (e.g., obtained from teleoperation of a robot), (viii) robot joint rotations data (e.g., obtained from teleoperation of a robot), (ix) other robot sensor data (e.g., inertial measurement unit (IMU) data, force and torque data, proximity sensor data, etc.), (x) simulation data, (xi) robot-free data (e.g., images or videos of humans performing the task), (xii) robot demonstration data (e.g., images or videos of other robots performing the task), (xiii) any combination of the above data, and/or (xiv) any other known data type. It should be understood that the data may be labeled or unlabeled.

### iv. Training Data

The training data 3120 for the BAM can be structured in a layered or pyramidal configuration, as illustrated in FIG. 12, and may include any data type that is disclosed herein. This approach is designed to address the challenge of data scarcity in robotics, where high-quality, embodied data is often costly and time-consuming to acquire at scale. By organizing heterogeneous data sources by their scale and specificity, this structure allows the model to first learn broad visual and behavioral priors from vast, general datasets before being grounded in the specifics of embodied, real-robot execution. The quantity of data generally decreases, while the embodiment-specificity and relevance increase, from the bottom layer to the top layer of the structure. This layered strategy enables the development of a generalist model that is both knowledgeable about the world and proficient in physical interaction.

The foundational layer of the data structure 3126 is composed of vast quantities of internet data and human videos. This layer can provide the largest volume of data and allow for instilling the model with a broad, common-sense understanding of objects, language, and the physical world. The Internet data may include billions of text documents, images, and video clips, which helps the model learn rich semantic representations and the relationships between visual concepts and linguistic descriptions. This is supplemented by large-scale robot-free data, such as egocentric videos of people performing everyday activities. These datasets capture a wide range of real-world human behaviors, including grasping, tool use, cooking, assembly, and other task-oriented activities, providing the model with extensive examples of human-object interactions, affordances, and natural motion patterns.

The middle layer of the data structure 3124 comprises simulation and synthetic data generated through physics engines and neural rendering. This layer serves to bridge the gap between the abstract knowledge gained from internet data providing semantic understanding and the specific requirements of robotic embodiment including dynamics and control. In simulated virtual environments powered by engines like MuJoCo, Bullet, or Isaac Gym, it is possible to generate millions of perfectly annotated trajectories for a wide range of tasks with deterministic repeatability. These simulations can feature diverse objects with varying geometries and material properties, backgrounds with different visual complexities, lighting conditions including shadows and reflections, and physics-based interactions modeling contact, friction, and deformation, allowing for systematic training across a vast parameter space with controlled variations. Techniques such as domain randomization, where the visual and physical properties of the simulation are varied during training across specified distributions, can help the model learn to generalize to real-world conditions through robust feature extraction. This layer provides a scalable method for generating task-specific data that would be impractical to collect in the real world.

In addition to physics-based simulation with analytical models, this middle layer may be augmented with neural-generated synthetic data using generative models. For instance, this process can involve fine-tuning large-scale video generation models such as video diffusion models or autoregressive video transformers on a smaller set of real-world robot trajectories comprising thousands of demonstrations. Once fine-tuned through techniques like LoRA or full fine-tuning, these models can generate a significantly larger volume of novel, high-fidelity video data exceeding millions of samples depicting the robot performing counterfactual scenarios with realistic appearance, such as interacting with new objects with different geometries, executing tasks in different sequences with varied ordering, or recovering from perturbations with adaptive responses. This synthetic data generation effectively multiplies the amount of available training data by creating plausible variations of existing demonstrations through learned priors, which can be used to improve the model's robustness through exposure to edge cases and ability to generalize to unseen situations through interpolation in learned spaces.

The top layer of the data structure 3122 comprises the highest-fidelity, most embodiment-specific data: real-world humanoid data collected from physical robots. While this dataset is the smallest in terms of volume typically containing thousands to tens of thousands of trajectories, it provides essential grounding for the model's learned knowledge in the dynamics and constraints of the physical world including gravity, inertia, and actuator limitations. This data can be primarily collected through teleoperation with various control interfaces, where a human operator controls a humanoid robot to perform a variety of tasks using haptic feedback. The teleoperation system may involve wearable suits with motion capture markers, sensor gloves with force feedback, or VR controllers with spatial tracking to capture the operator's movements with high precision, which can then be translated into control commands for the robot through inverse kinematics and retargeting algorithms. This process generates a rich, time-synchronized dataset containing video from the robot's onboard cameras at multiple viewpoints, the robot's complete state data (e.g., joint positions with encoder readings, velocities from differentiation, and torques from motor currents), proprioceptive signals from IMUs and force sensors, and the operator's motion data serving as supervision signals.

### 1. Data Collection System

The data collection system 3020 may be used to collect data contained within the foundational layer data structure 3126, and is not designed to collect data for the top layer of the data structure 3122. Specifically, the data collection system 3020 includes: (i) a wearable collection apparatus 3200, and (ii) a display 3150. It should be understood that the data collection system 3020 may include any combination of the components described below. Examples of the data collection system 3020 include: (i) only the display 3150, (ii) the display 3150 and a pair of black gloves that do not include sensors, (iii) the display 3150 and any glove that is discussed below, (iv) any one of the below-described gloves without any other component, (v) any of the below disclosed wearable collection apparatus 3200 without any other component, (vi) a combination of wearable collection apparatus 3200 and display 3150, but without any glove, (vii) a combination of wearable collection apparatus 3200 and any glove, but without a display 3150, (viii) any other combination of these components, and/or (ix) any component disclosed herein and any other known component.

Unlike teleoperation systems that are designed to generate data to control a robot 1, the disclosed data collection system 3020 is designed to operate without a robot. This robot-free operation is beneficial because: (i) reduces the cost of the system by eliminating the robot, (ii) drastically reduces components, (iii) allows for less experienced users, (vi) permits data collection with less setup time, and (v) any other benefit that is obvious from the disclosed drawings and disclosure. The data collection system 3020 includes further benefits as the apparatus 3200 includes onboard sensors integrated directly into the wearable structure, and thus generally does not require a quiet acoustic environment. Additionally, the apparatus 3200 is designed to be portable as it is worn by the operator 3003, relatively lightweight in comparison to full exoskeletons, and quicker to manufacture due to simpler mechanics than a full force-feedback exoskeleton. Further, the data collection system 3020 minimizes the infrastructure footprint when compared to fixed base systems and can eliminate the need for a complicated walking base simulator, numerous external wires that may restrict movement, or extensive external tracking components such as ceiling-mounted camera arrays. As a result, a large quantity of movement data can be collected at a relatively low cost per hour, and this data can be used for training the BAM.

The data collection system 3020 simplifies the overall data collection process when compared to some alternatives and may not require a substantial number of additional external sensors or environmental detection devices, such as the external cameras often used for tracking in traditional motion capture systems. For example, the disclosed data collection system 3020 does not inherently require an extensive external camera setup that necessitates controlled lighting, which is a common requirement for purely vision-based motion capture systems that rely on optical markers. Because the primary positional data is collected through integrated sensors directly coupled to the operator 3003 wearing a wearable collection apparatus 3200, there are generally no line-of-sight occlusion or “black-out” spots created by machines, furniture, or other structures present in the training environment. This can be a significant problem for external camera-based systems where occlusions may result in data loss or interpolation errors. In addition to avoiding such black-outs, the disclosed system is less expensive than highly complex, large-scale motion capture setups.

When wearing the data collection apparatus 3200, the operator 3003 generates movement data that may include or relate to: (i) the position and/or movement of the operator 3003 in space while performing a task, including translational and rotational components in three-dimensional space, (ii) the relative spatial locations of anatomical joint centers of rotation, including shoulder, hip, elbow, knee, wrist, ankle, and/or finger joints, (iii) the velocity and acceleration profiles of each tracked body segment, and/or (iv) any other data about the operator that is relevant to the control and training process (e.g., grip force patterns, hand orientation trajectories, or movement timing sequences). The movement data may be captured at sampling rates ranging from 1 Hz to 10 kHz.

In one embodiment, this movement data may encompass: (a) the position and movement of the operator's torso, including actions such as twisting or bending at the waist with angular measurements in roll, pitch, and yaw axes, and the operator's location within a training environment tracked through both relative and absolute positioning methods, (b) the position and movement of the arms of the operator 3003, where such tracking may detail the operator's shoulder motion, elbow flexion and extension, wrist pose (defined by both position and orientation) in six degrees of freedom, and hand or finger gestures, which can be captured via gloves 3400 coupled to the wearable collection apparatus 3200 or other sensors with sufficient resolution to distinguish individual finger movements of the operator 3003, and/or (c) the position and movement of the legs of the operator 3003, where such tracking may detail the operator's hip motion, knee flexion and extension, ankle pose (defined by both position and orientation) in six degrees of freedom.

The movement data can be captured by the wearable collection apparatus 3200 as sensor data, which may then be transferred to another component for further processing or storage through various communication protocols. This recipient component may be: (i) a remote computer (e.g., a command center 2750) connected via wireless or wired networks, or (ii) the computer 3110 integrated with or separate from the apparatus 3200. This data transfer enables the execution of instructions to generate robot-free training data or log data for training the BAM. The data transfer may occur at various rates depending on the application requirements, ranging from batch transfers to real-time streaming.

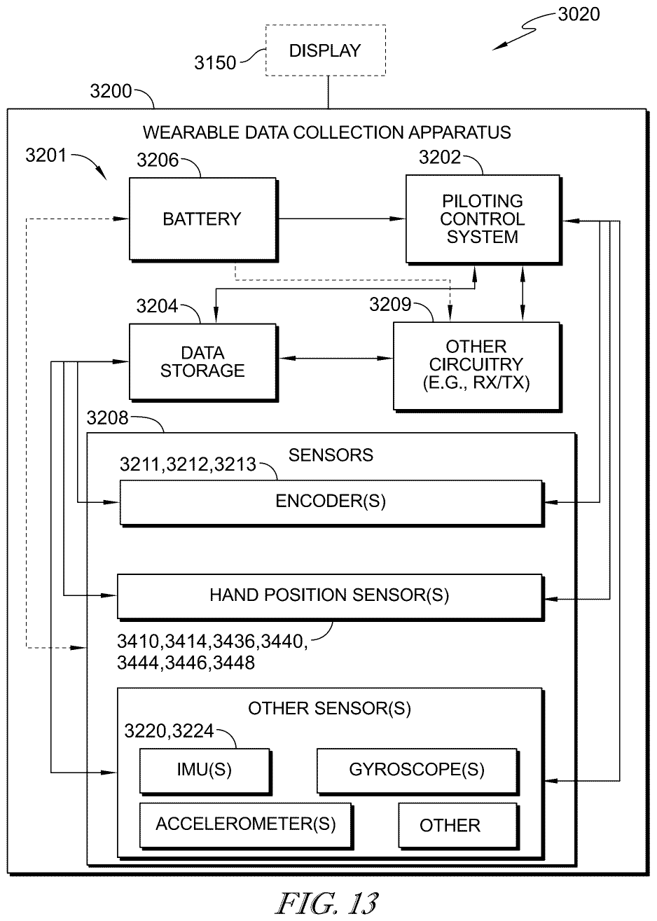

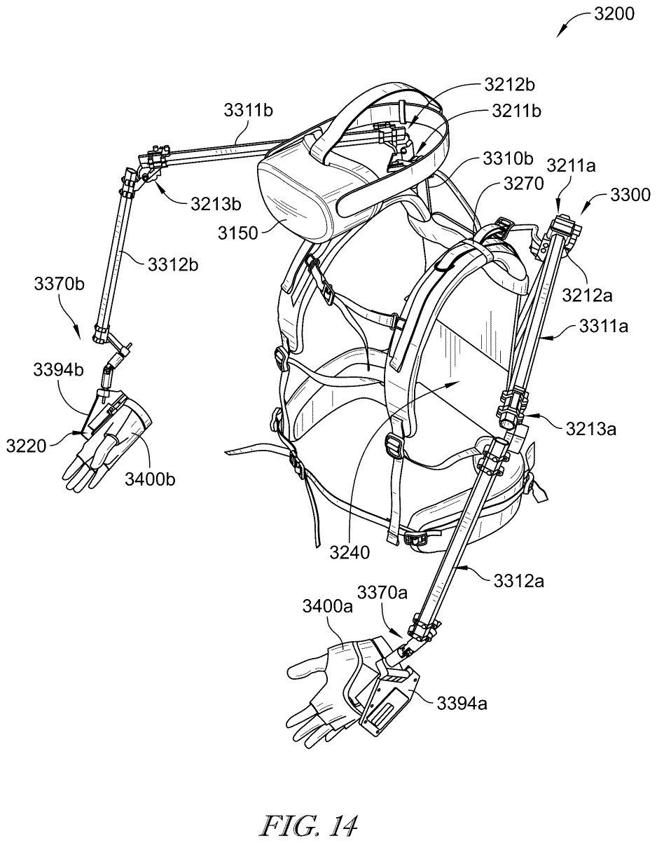

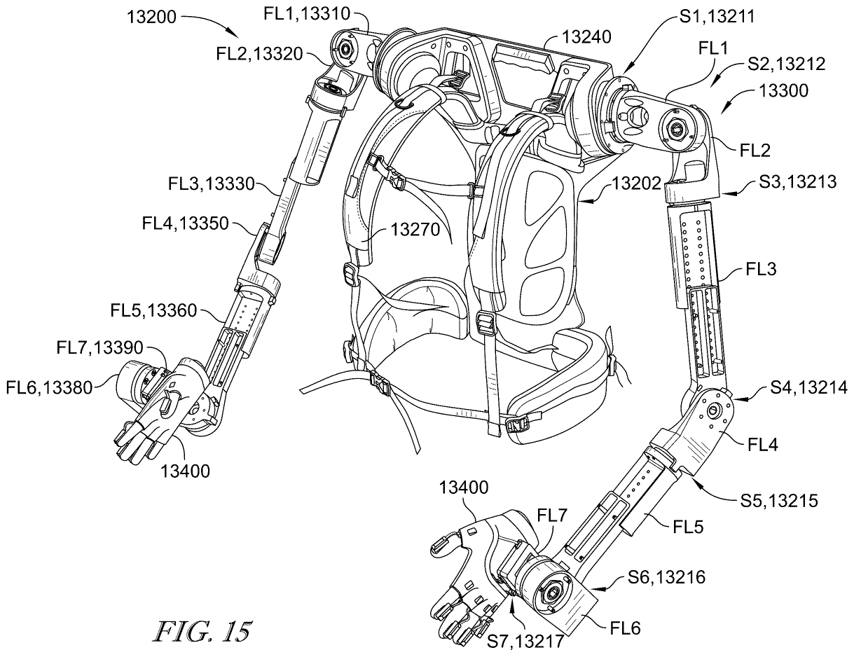

In a first embodiment that is shown in FIG. 14, the wearable collection apparatus 3200 includes (i) a base mount 3240, (ii) left and right articulated arms 3300 pivotably attached to the base mount 3240, (iii) a wrist assembly 3370 coupled to each articulated arm 3300, (iv) a glove 3400 coupled to the wrist assembly 3370 via a glove mount 3394, and (v) an apparatus electronics assembly 3201. The apparatus electronics assembly 3201, as shown in the block diagram of FIG. 13, includes a control system 3202, data storage 3204, a battery 3206, a plurality of sensors 3208, and other circuitry 3209. The wearable collection apparatus 3200 is configured to be worn by a human operator 3003 to perform data collection tasks. The operator 3003 wears the wearable collection apparatus 3200 on the back and secures it in position using the adjustable harness 3270. The operator 3003 also wears the gloves 3400 on each hand. The articulated arms 3300 are configured to move with the arms of the operator 3003 wearing the wearable collection apparatus 3200 as the operator 3003 performs data collection tasks.

The sensors 3208 coupled to the wearable collection apparatus 3200 include encoders 3211, 3212, 3213, IMUs 3220 and 3224, and hand sensors 3410, 3414. The encoders 3211-3213 are fixed to respective rigid frame links 3310-3312 to measure the rotational and positional movement of each rigid frame link. A torso IMU 3224 is coupled to the base mount 3240 and wrist IMUs 3220 may be coupled to the glove mount 3394, or optionally the glove 3400, to provide information regarding the pitch and orientation of the operator's wrist. The gloves 3400 provide additional positional information for the fingers and thumbs of the operator. The movement data is collected by the control system 3202 as the operator 3003 performs tasks. The collected movement data is processed by the control system 3202 and/or computer 3110 to provide robot-free training data.

Similar to the first embodiment, the wearable collection apparatus 13200 that is shown in FIG. 15 is configured to be worn by an operator 3003 to perform data collection tasks across various environments and scenarios. The wearable collection apparatus 13200 may be positioned on the back of the operator and secured in position using the adjustable harness 13270. The wearable collection apparatus 13200 also includes left and right articulated arms 13300 that extend from the base frame 13240 to respective left and right gloves 13400, with each articulated arm 13300 capable of tracking movements across a plurality (e.g., between two and 30, preferably between 3 and 15) degrees of freedom. The gloves 13400 are worn on each hand of the operator 3003 and coupled to the left and right articulated arms 13300 through secure mechanical interfaces, e.g., 13380, 13390.

The articulated arms 13300 are configured to move with the arms of the operator 3003 while performing data collection tasks, maintaining kinematic correspondence with the operator's natural movements. The articulated arms 13300 include a plurality of rigid frame links FL1-FL7 (e.g., 13310, 13320, 13330, 13350, 13360, 13380, 13390), where the first frame link 13310 (FL1) is coupled to the base frame 13240 and the seventh frame link 13390 (FL7) is configured to couple to the glove 13400. The frame links FL1-FL7 are coupled by joint connections S1-S7, where joint sensors (e.g., encoders) positioned within the joint connections S1-S7 measure the rotational and positional movement at the joint connection with angular resolution better than 0.1 degrees. Specifically, the articulated arms 13300 include sensor joints (S1-S7) that substantially correspond with the relative location and orientation of the actuators (J1-J7) of the arm assembly 5 of the robot 1. The correspondence between sensor joints S1-S7 and robot actuators J1-J7 enables direct kinematic mapping with minimal computational transformation. In some embodiments, one or more of the individual frame links (FL1-FL7) may be configured to have an adjustable length. Although the lengths of the individual frame links (e.g., FL1-FL7) do not directly correspond to the measurements of the robot components (e.g., upper humerus 30, lower humerus 36), the orientation of sensor joints (S1-S7) generally align with the actuator axes (A1-A7) of the robot 1. As such, the relationship of the individual frame links of the articulated arms 13300 can be kinematically mapped to the arm assembly 5 using standard Denavit-Hartenberg parameters or modified conventions.

Further, the sensor joints (S1-S7) of the articulated arms 13300 are configured to accommodate encoders 13211-13217 that are the same or substantially similar to the sensors associated with actuators (J1-J7) of the arm assembly 5 of the robot 1, ensuring consistent measurement characteristics. In the illustrative embodiment, the encoders 13211-13217 may be optical encoders that are substantially similar to the optical encoders used for measurements of the actuators (J1-J7) in the robot 1, with resolution capabilities of 6-128 bits per revolution. Moreover, the individual frame links include limit projections and hard stops that are configured to limit motion of the articulated arms 13300 and to substantially match the range of motion of the individual actuators (J1-J7) in the robot 1, preventing operator movements beyond robot capabilities. These mechanical limits in rotation prevent the operator 3003 from making movements that would not be within the range of motion of the robot 1, thereby ensuring all collected data represents achievable robot configurations.

Additionally, positional sensors 13410, 13414 (not shown) are included in the glove 13400 to provide information regarding the position of the operator's hand, including individual finger positions with millimeter-level accuracy. The sensor data is collected by the pilot control system 13202 of the wearable collection apparatus 13200 as the operator 3003 performs tasks and communicated in the network environment to the robot 1, computer 13110, or another computing device through low-latency communication protocols. The collected movement data includes sensor data from the encoders 13211-13217, hand positional sensors 13410, and other sensors and that can be output as robot-free training data.

### a. Glove

The data collection system 3020 may include a glove 3400 coupled to the glove mount 3394 of the articulated arms 3300 through mechanical interfaces designed for quick attachment and removal. The glove 3400 is configured to be worn on the hands of an operator 3003 to capture the location data of the operator's hand, palm, and/or fingers with sufficient resolution for dexterous manipulation tasks. To achieve this, the glove 3400 may include a plurality of hand position sensors 3410 arranged to capture comprehensive hand kinematics. In some embodiments, the IMU 3220 may be coupled to the glove mount 3394 near the glove 3400, maintaining proximity to the hand for accurate measurements. In certain embodiments, the glove 3400 may include an IMU 3220, for example, located on the dorsal side of the hand at the connection of the glove 3400 to the glove mount 3394, providing six-axis motion sensing.

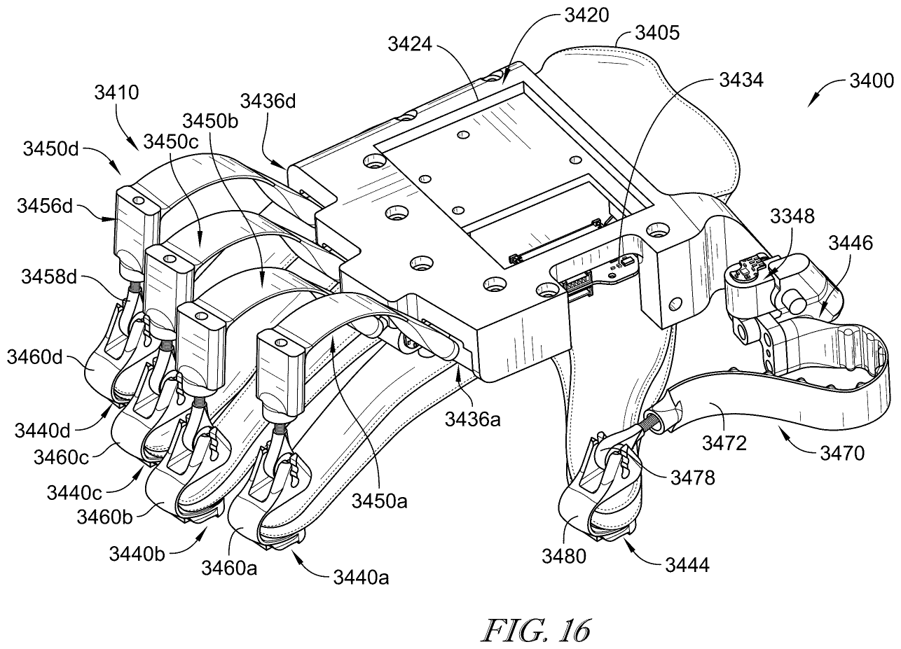

As best shown in FIG. 16, the gloves 3400 of the wearable collection apparatus 3200 utilize mechanical linkages to determine the location of the operator's hands and fingers. The glove 3400 includes a hand receptacle 3405 constructed from a flexible textile with a sensor assembly 3420 coupled to it through secure mounting interfaces. The sensor assembly includes a plurality of hand position sensors 3410 including encoders 3436a-d, 3446, 3448 and pressure sensors 3440a-d and 3444. In particular, the glove sensor assembly 3420 includes: (i) a housing 3424 configured to couple to the glove mount 3394, (ii) a multi-layer PCB 3434 for signal routing, (iii) finger encoders 3436a-d with resolution of 12-14 bit, (iv) thumb encoders 3446, 3448 providing two axis-tracking, (v) pressure sensors 3440a-d and 3444 with force thresholds of 2-5 N, and (vi) deformable connectors 3450a-d and 3470 constructed from flexible polymer materials. In various embodiments, the glove 3400 may also include an IMU 3220 providing 6-DOF hand orientation data. Each of the finger encoders 3436a-d, thumb encoders 3446, 3448, pressure sensors 3440a-d, 3444 are communicatively coupled to the hand PCB 3434 contained in the housing 3424 through flexible circuit connections.

The deformable connector 3450 includes a deformable member 3452 with a proximal end 3454 configured to pivotably couple to a finger encoder 3436 positioned within the housing 3424 and a distal portion 3456 configured to couple to the pressure sensor 3440, which is coupled to a tip of the finger portion on a palmar side of the glove. The deformable member maintains consistent force transmission while allowing 3D finger motion. In the illustrative embodiment, the distal end 3456 is coupled to an eyelet 3458 with an inner diameter of 3-5 mm and tip guard 3460 that couples with the tip of the finger of the glove 3405. By positioning an axis portion of the tip guard 3460 within the eyelet 3458, the movement of the operator's fingers are less restricted and may curl to grasp objects with grip apertures from 0-150 mm.

The distal portion 3456 may be more rigid with a stiffness 2-3× greater and defined than a deformable mid-section of the deformable member 3452. The shape of the distal portion 3456 may be configured to hold the eyelet 3458 in a substantially perpendicular orientation, extending upward with respect to the pressure sensor 3440 when the hand is placed with the palm on a flat support surface. This orientation holds the axis portion of the tip guard 3460 in a substantially parallel arrangement with respect to the axis of the finger encoder 3436, maintaining alignment within 5 degrees. This parallel arrangement reduces error in the measurements to a single-direction for rotation with angular errors under 1 degree.

To make the gloves 3400 more comfortable to wear and use, the deformable member 3452 is configured to: (i) bend or deform in a first inward direction in order to allow the user to curl their fingers towards the palm after the finger encoders 3436a-d have reached their minimum curled position, and (ii) bend or deform in a second lateral direction in order to allow the user to abduct/adduct their fingers. However, a significantly greater lateral force (e.g., any value between 1× and 30×) must be applied on the deformable member 3452 to move said deformable member 3452 a predetermined distance (e.g., 1 mm) in the lateral direction in comparison to the curling force that is applied on the deformable member 3452 to move said deformable member 3452 the predetermined distance in the curling direction. In other words, the deformable member 3452 will move or deform along an arched or curved curling direction a greater amount in comparison to the amount said deformable member 3452 will move or deform in the lateral direction when the same amount of force is applied to the deformable member 3452 in both directions. As such, the deformable member 3452 will move or deform along an arched or curved curling direction with less force than the deformable member 3452 will move or deform along the lateral direction.

The deformable connector 3470 is coupled to the first and second thumb encoders 3446, 3448 coupled to the mounting structure 3430 at the proximal portion 3428 of the housing 3424. In the illustrative embodiment, the first and second thumb encoders 3446, 3448 are positioned with substantially perpendicular axes (900±2°) and generally correspond to the position of the first and second thumb actuators located in the hand 56 of the robot 1. Including two thumb encoders 3446, 3448 in the glove 3400 facilitates the kinematic mapping of the measured positions to control functions for the robot 1. The deformable member 3472 includes a proximal end 3474 that couples to the first thumb encoder 3446 and pivots therewith through ranges of 45 degrees. The distal end 3476 of the deformable member 3472 includes a structure to couple an eyelet 3478 and a tip guard 3480 that are substantially similar to the eyelet 3458 and tip guard 3460 of the deformable connectors 3450 for the fingers. The deformable member 3472 may be configured with ribs protruding from at least one surface with rib heights of 1-2 mm, where the ribs help maintain the orientation of the deformable member 3472 with respect to the two thumb encoders 3446, 3448 as the thumb changes position through its range of motion.

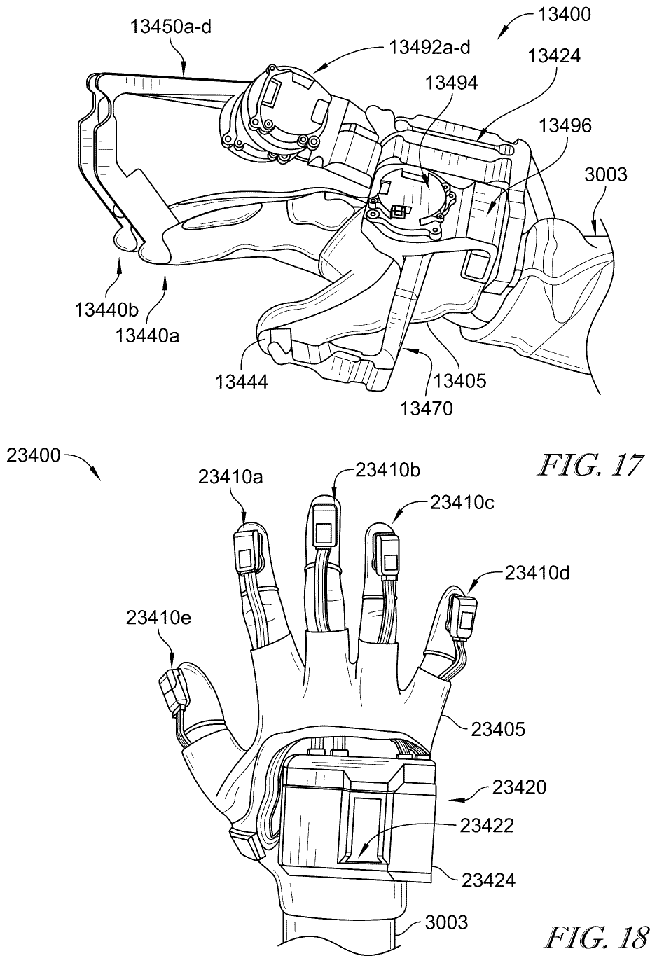

Referring to FIG. 17, a second embodiment glove 13400 may be utilized with the data collection system 13020. In this second embodiment, the data collection system 13020 is substantially similar to the illustrative data collection system 3020, where the wearable collection apparatus 13200 includes an alternative glove 13400, and the control system 13202 is adapted to receive sensor data from glove 13400. For sake of brevity, the above disclosure in connection with the wearable collection apparatus 3200 will not be repeated below, but it should be understood that across embodiments like numbers represent like structures. The primary difference in the wearable collection apparatus 3200 and the alternative wearable collection apparatus 13200 relates to alternative gloves 13400 that are coupled to the articulated arms 13300.

The primary difference between the gloves 3400 of the first embodiment and the gloves 13400 is the addition of motors 13492a-13492d positioned at each finger and thumb motors 13494, 13496. The gloves 13400 include deformable members 13450 that extend forward from electric motors 13492a-13492d to a pressure sensor 13444a-d. Similarly, for the thumb, gloves 13400 include deformable members 13470 that extends forward from electric motors 13494, 13496 to a pressure sensor 13444. This may enable the gloves 13400 to provide forces on the hand that may be experienced when using the glove 13400 in connection with a simulator or may allow for more accurate recording of movement data.

Referring to FIG. 17, the motors 13492a-d are positioned at a distal portion 13426 of the sensor assembly housing 13424. The motors 13492a-d are (i) positioned to align with the finger portion of the hand receptacle 13405 maintaining anatomical correspondence, (ii) configured to couple with deformable connectors 13450a-d, and (iii) are substantially parallel in orientation. In some embodiments, the motors 13492a-d may be angularly offset by a slight angle (e.g., angle less than about 5 degrees) to ensure the operator's finger may move within the hand receptacle 13405 without interfering with the adjacent finger during full flexion. A proximal portion 13428 of the housing 13424 includes a mounting structure 13430 for the first and second thumb motors 13494, 13496 and the deformable connector 13470, positioned to align with natural thumb motion arcs. The motors 13494, 13496 are positioned perpendicular to each other to provide two degrees of freedom. In various embodiments, the finger encoders 13436a-d and thumb encoders 13446, 13448 reside with the motors 13492a-d and thumb motors 13494, 13496.

The control system 13202 may also be configured to integrate various software applications or functionalities. These applications may include, for example: (i) an actuator control application for managing feedback, and (ii) a sensor tracking application, which may incorporate a drift correction algorithm to enhance tracking accuracy. The actuator control application is designed to precisely modulate the torque output or other control signals that are sent to each actuator, such as motors 13492a-d, 13494, 13496 of the glove 13400 to provide haptic feedback. This application may leverage data from multiple diverse sources, including: (i) simulated data that is generated via computational models which predict dynamic interactions and expected loads based on a virtual environment or a task model, and/or (ii) simulated data that is informed by the state of the robot 1, allowing adaptive learning algorithms to refine actuation patterns based on real-world conditions. This sophisticated integration of data sources allows the actuator control application to deliver feedback to the operator 3003 or for more accurate collection of data.

In parallel, the sensor tracking application is tasked with the real-time acquisition of data from the array of sensors 13208 that are distributed across the wearable apparatus 13200. The sensor tracking application communicates this collected sensor data to the computer 13110 for further processing, or it may process the data locally within the control system 13202. The computer 13110 and/or the on-board processors that are located within the control system 13202 then operate to refine the raw sensor data. This refined sensor data can then be utilized, in connection with robot-free training data, to dynamically adjust the data that is provided to the actuator control application (for the purpose of haptic feedback) and to generate the robot-free training data. As will be described in greater detail below, advanced algorithms, including various machine learning models, can be employed to analyze the various data streams, such as the raw sensor data, the refined sensor data, and/or the received robot-free training data, in order to identify patterns, perform sensor fusion, correct for sensor drift, and optimize control strategies. This comprehensive feedback loop, which incorporates data from the operator 3003, the apparatus 13200, and the robot 1, not only improves the performance of the apparatus 13200 in real-time but also contributes to the iterative development of more sophisticated control algorithms (or AI models) that can be tailored to operator-specific training regimens or particular task requirements. This overall system architecture facilitates an adaptive training where the wearable data generation apparatus 13200 can continuously adjust its behavior based on accumulated interaction data from the operator 3003, thereby maximizing both task efficacy and the immersion of the operator 3003.

Referring to FIG. 18, the data collection system 23020 may include a glove 23400 coupled to the articulated arms 23300 through mechanical interfaces designed for quick attachment and removal at the glove mount 23394. The glove 23400 is configured with a hand receptacle 23405 to be worn on the hands of an operator to capture the location data of the operator's hand, palm, and/or fingers with sufficient resolution for dexterous manipulation tasks. To achieve this, the glove 23400 may include sensor assembly 23420 including a plurality of hand position sensors 23410 arranged to capture comprehensive hand kinematics. A first set of hand position sensors 23410 may be positioned at the tips of the fingers and thumb (e.g., 23410a-23410e) for capturing fine motor movements with sub-millimeter precision. In the illustrative embodiment, the hand receptacle 23405 is fingerless, and the sensors 23410a-23410e are positioned on fingertip receptacles 23406 to conform more closely with the hand of the operator 3003. In other embodiments, the sensors 23410a-23410e may be coupled directly to a hand receptacle that extends to include the fingers and thumb of the operator 3003. In some embodiments, the glove 23400 may also include one or more palm sensors 23414 located at the palm of the glove to provide additional data on hand orientation or alternative sensors for additional positional information, such as grip force or contact pressure. In certain embodiments, the glove 23400 may also include an IMU 23220 contained in the housing 23424, for example, located on the dorsal side of the hand at the connection of the glove 23400 to the glove mount 23394, providing six-axis motion sensing. In other examples, the IMU 23220 may be coupled to the glove mount 23394 near the glove 23400, maintaining proximity to the hand for accurate measurements.

The gloves 23400 may include a magnetic field-generating apparatus designed to collect training material by accurately tracking the position and rotation of a human operator's wrist and fingers in three-dimensional space with millimeter-level position accuracy and degree-level orientation accuracy. The apparatus may include a first component that generates a magnetic field with controlled characteristics and a second component (or set of components) that may be positioned on or over the operator's hands and fingers for field detection.

The first component, which is an electromagnetic field (EMF) source, emits controlled EMF signals over a defined space around the operator's hand, typically encompassing a volume of 30×30×30 centimeters. These EMF signals are generated continuously or at predetermined intervals, utilizing specific frequencies and modulation schemes optimized to minimize interference and maximize detection accuracy while maintaining compliance with electromagnetic compatibility standards. For example, the EMF source may operate within a low-frequency range between 10 kHz and 200 kHz, allowing adequate field penetration through biological tissue and reducing susceptibility to environmental noise from common electronic devices. Modulation schemes, such as frequency modulation (FM) with deviation ratios of 5-10, amplitude modulation (AM) with modulation indices of 0.5-0.9, or phase-shift keying (PSK) with phase shifts of 90-180 degrees, may be used to encode synchronization information and unique identifiers within the EMF signals. The EMF source contains an integrated processor with computational capabilities of 100-1000 MIPS and memory of 256 KB-4 MB that manage operational instructions, control signal generation parameters (e.g., frequency stability within ±0.01%, amplitude control within +1%, and waveform shape with harmonic distortion less than 1%), and analyze data received from the sensors with latencies under 1 millisecond.

The second component consists of sensors 23410 coupled to the operator's hands and wrists that detect EMF signals from the EMF source with high sensitivity and selectivity. These sensors may include magnetic flux density sensors with sensitivities of 1-100 nT, magnetic field strength sensors measuring fields from 0.1-100 T, Hall effect sensors with voltage sensitivities of 1-5 mV/mT, and inertial measurement units (IMUs) with gyroscope ranges of 2000 degrees/second and accelerometer ranges of ±16 g, all operating at a high sampling frequency—at least six times, preferably eight times, and most preferably ten times the highest frequency component of the EMF signals—to capture rapid movements accurately without aliasing. For instance, if the highest frequency component of the EMF signal is 100 kHz, the sensors may sample at 600 kHz to 1 MHz to ensure Nyquist criteria are exceeded. The sensors are strategically placed on the fingers, back of the hands, and wrists to capture precise movement and orientation data, with typical sensor spacing of 20-30 mm, and may include magnetometers capable of measuring the amplitude, phase, and frequency of the EMF signals with high precision including amplitude resolution of 12-16 bits and phase resolution better than 0.1 degrees. These sensors may employ technologies such as anisotropic magnetoresistance (AMR) with resistance changes of 2-3% per applied field or giant magnetoresistance (GMR) with resistance changes of 10-20% for enhanced sensitivity. Integrated IMUs provide additional data on angular velocity with resolution better than 0.01 degrees/second and linear acceleration with resolution better than 0.001 m/s², enhancing the overall accuracy of tracking through sensor fusion algorithms.

To determine the position of the operator's hands and wrists, the system analyzes detected EMF signals in conjunction with known properties of the emitted field using specialized algorithms and models implemented in real-time processing hardware. The system measures signal strength attenuation, where the intensity of the EMF signal decreases with distance from the source according to known physical laws, such as the inverse-square law in far-field conditions (distances greater than λ/2π) or more complex near-field equations for distances less than one wavelength of the EMF signal. By measuring the amplitude of the received EMF signals at each sensor with dynamic ranges of 60-80 dB, the system can calculate the approximate distance d between the EMF source and each sensor using calibration curves or mathematical models with accuracies better than 1 mm. Additionally and/or alternatively, phase difference measurement calculates precise distances by analyzing the phase shift between the emitted and received continuous-wave EMF signals with phase measurement accuracies of 0.1-1 degree. The phase difference φ is related to the distance d by φ=(2π d)/λ, where λ is the wavelength of the EMF signal, typically 1.5-30 meters for the operating frequency range. Measuring the phase difference allows for precise distance calculations with millimeter-level accuracy, especially when combined with multiple frequency signals to resolve ambiguity through techniques such as dual-frequency phase unwrapping.

The system may combine magnetic field vector analysis with IMU data to further refine or specify the rotation of the human's wrist and/or finger through complementary filtering techniques. Magnetic field vector measurements reveal the field's direction in three-dimensional components (Bx, By, Bz) at each sensor location with vector magnitude accuracies of 1-2% and direction accuracies of 1-2 degrees, which provides information about the sensor's orientation relative to the EMF source. IMUs add real-time data on angular velocity (gyroscope) with bias stability better than 1 degree/hour and linear acceleration (accelerometer) with bias stability better than 1 mg, enabling tracking of rotational movements (roll, pitch, yaw) with update rates of 100-1000 Hz and correcting for drift over time through zero-velocity updates when stationary conditions are detected. Advanced sensor fusion algorithms, such as Extended Kalman Filters (EKF) with 15-21 state variables or Complementary Filters with tunable time constants of 0.5-5 seconds, integrate data from magnetometers and IMUs, refining and stabilizing orientation estimates of the hands and fingers to achieve accuracies better than 2 degrees RMS. Further, it should be understood that the system may use a combination of the above described algorithms, models, and/or techniques, and/or any one of the above described algorithms, models, and/or techniques in connection with any other known algorithm, model, and/or technique such as Madgwick filters, Mahony filters, or neural network-based sensor fusion. It should be understood that other algorithm(s), model(s) and/or technique(s) that enable said system to determine the rotation and/or pose of the operator's body parts (e.g., wrist and/or fingers) based on the data collected from the wearable magnetic field-generating apparatus may be utilized by said system, including machine learning models trained on labeled motion capture data.

The apparatus provides accurate, real-time tracking of wrist and finger positions and rotations with update rates of 100-1000 Hz and latencies under 10 milliseconds, making it suitable for applications such as training data collection for humanoid robots requiring precise manipulation data, interactive control systems demanding responsive feedback, and immersive virtual and augmented reality environments needing natural hand interaction. This system leverages controlled EMF signal generation with field uniformity better than ±5%, high-frequency sensing at rates exceeding Nyquist requirements, sophisticated processing algorithms achieving sub-millimeter accuracies, and adaptive environmental mapping compensating for field distortions, overcoming limitations of conventional tracking methods that rely on external cameras or markers and are vulnerable to occlusions affecting 10-30% of the capture volume or lighting conditions requiring illumination levels above 500 lux. In one implementation, the apparatus complies with regulatory standards for electromagnetic emissions, as set by the Federal Communications Commission (FCC) Part 15 regulations or the International Commission on Non-Ionizing Radiation Protection (ICNIRP) guidelines, maintaining emissions below −50 dBm in restricted bands.

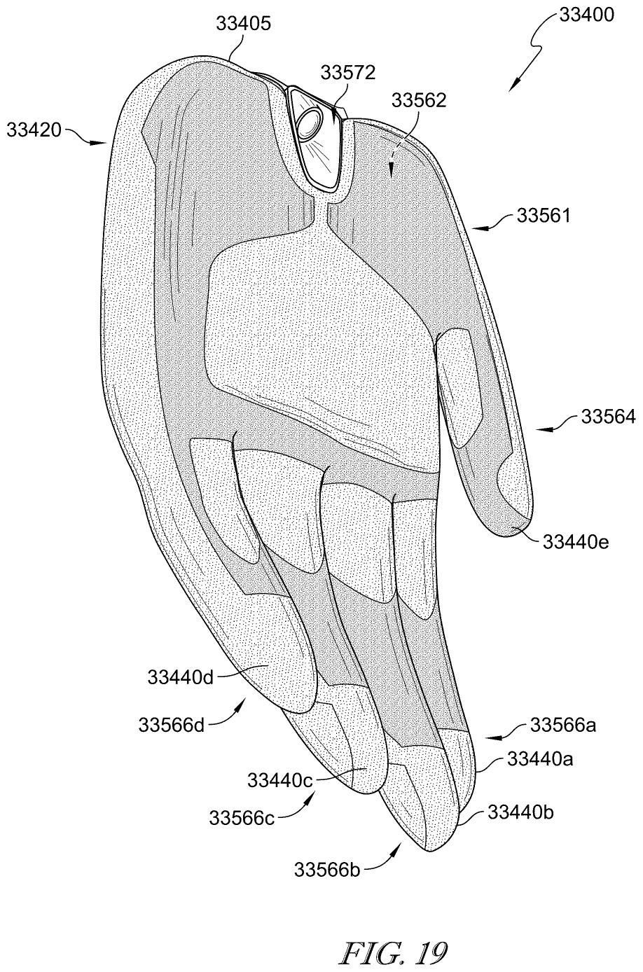

Referring to FIG. 19, a fourth embodiment glove 33400 may be utilized with the data collection system 3020. The glove 33400 includes a hand receptacle 33405 (also referred to as a main enclosure or glove housing) constructed from a flexible textile with a glove sensor assembly 33420 coupled to it through secure mounting interfaces. The glove 33400 is configured with a hand receptacle 33405 to be worn on the hands of an operator to capture the location data of the operator's hand, palm, and/or fingers with sufficient resolution for dexterous manipulation tasks. To achieve this, the glove 33400 may include glove sensor assembly 33420 including a plurality of hand position sensors 33410 (e.g., tactile sensors 33440a-33440e) arranged to capture comprehensive hand kinematics. In some embodiments, the glove 33400 may also include one or more palm sensors 33414 (e.g., vision sensor 33572) located at the palm of the glove to provide additional data on hand orientation.

The hand receptacle 33405 may include a thumb portion 33564 and finger portions 33566a-33566d are configured to move relative to a palm portion surface of said hand receptacle. A first set of hand position sensors 33410 may include tactile sensors 33440a-33440e positioned at the tips of the fingers and thumb for capturing fine motor movements with sub-millimeter precision. In the illustrative embodiment, the glove 33400 includes the vision sensor 33572 coupled to the palm portion and a sensor opening is formed in the palm surface of the hand receptacle 33405. In other embodiments, the sensor opening may be located on another area of the glove. Alternatively, the sensors may be mounted to the exterior of the glove, and as such the opening for the at least one sensor may be omitted. In other embodiments, the glove may completely omit sensors that require an opening to receive information.

In some embodiments, the glove may include more than one vision sensor 33572 on the glove 33400 at respective mounting positions to provide more views of the thumb and finger portions 33564, 33566a-33566d. For example, the glove sensor assembly 33420 may include additional vision sensors (e.g., cameras) arranged on (i) the dorsal surface, (ii) finger portions 33566, (iii) thumb portion 33564, or (iv) other regions of the glove. The thumb and finger portions 33564, 33566a-33566d each houses at least one sensor assembly (e.g., tactile sensors 33440a-33440e). The sensor assembly is configured to measure the load experienced on the finger portions 33566a-33566d of the glove 33400.

Each tactile finger sensor assembly (e.g., tactile sensors 33440a-33440e) is configured to measure the load experienced on the thumb portion 33564 and/or finger portions 33566a-33566d of the glove 33400 using a strain gauge or arrays of strain gauges. The strain gauges measure strain, which may be used to determine the force, stress, torque, pressure, deflection, etc. experienced on the finger portions 33566a-33566d. The feedback provided by these tactile sensor assemblies embedded in the finger portions 33566a-33566d can be combined with data from encoders, torque sensors and/or other sensors that are positioned adjacent to or configured to obtain information from each joint. Said combination of feedback, data, and/or information can be used to generate data for controlling a robot, thereby enabling an operator 3003 to perform complex manipulations that require delicate touch via teleoperation.

The tactile sensor assemblies (i) may be positioned at any location in the glove (e.g., palm portion), (ii) may not be embedded in the assembly, and instead may be integrally formed therewith or directly secured to an outer extent of said assembly, (iii) may be formed in a layer or external covering (e.g., protective cover 33561 of the hand enclosure 33405) that is positioned on top of or over said sensor assembly, and/or (iv) a combination of any one of the described options. An example of possible combinations include: (i) a portion of the tactile sensor assembly positioned in the glove and a portion of the tactile sensor assembly embedded within the glove structure, (ii) a portion of the tactile sensor assembly secured to the exterior of the housing of said glove and a portion of the tactile sensor assembly embedded within the glove structure, (iii) a portion of the tactile sensor assembly positioned in the glove, a portion of the tactile sensor assembly secured to the exterior of the housing of said glove, and a portion of the tactile sensor assembly embedded within the glove structure, (iv) a portion of the tactile sensor assembly positioned in the glove, a portion of the tactile sensor assembly integrally formed with the exterior of the housing of said glove, and a portion of the tactile sensor assembly embedded within the glove structure, and/or (v) any combination or hybrid thereof. As discussed above, the sensor may be incorporated, embedded, and/or attached to the electronics positioned within the glove housing, an energy absorbing assembly and/or the protective cover 33561.

The strain gauges included in the tactile sensor assemblies may be any type of strain gauge including: (i) linear strain gauges, (ii) double linear strain gauges, (iii) shear or torsional strain gauges, (iv) rosette strain gauges (T (or Tee) shaped, rectangular shaped, delta shaped, stacked), (v) diaphragm strain gauges, (vi) biaxial strain gauges, (vii) bi-directional strain gauges, (viii) stacked strain gauges, (ix) cross strain gauges, (x) double shear, (xi) circular, (xii) any hybrid or combination thereof, and/or (xi) any other suitable strain gauge type that is known to one of skill in the art. The strain gauges may be arranged in different configurations including: (i) quarter-bridge configurations, (ii) half-bridge configurations, and/or (iii) full-bridge configurations.

The strain gauges may also be foil strain gauges, semiconductor strain gauges, thin-film strain gauges, ink based strain gauges, thick-film strain gauges, optical, nanocomposite, and/or any combination or hybrid thereof. Further, the strain gauges may be directly integrated into the housings (interior or exterior), coupled to said housings (interior or exterior) after the housing is manufactured, coupled to another structure (e.g., bridge, spring, etc.) positioned within the housing, integrated into or coupled to a motor or motor housing, positioned between housings, and/or any other known configuration or combination thereof. The foil strain gauges may be made from or include: (i) foils that may be or may include constantan (copper-nickel alloy) karma (nickel-chromium alloy) isoelastic (nickel-iron alloy) evanohm (nickel-chromium alloy) nichrome v (nickel-chromium alloy), and (ii) carrier that may be or may include polyimide film, epoxy or phenolic resin, glass-fiber reinforced epoxy, ceramic backing, and/or polyurethane. Finally, the strain gauges may be any gauge that meets, uses, and/or was tested with at least one of the following standards: ASTM E251-13(2018), Standard Test Methods for Performance Characteristics of Metallic Bonded Resistance Strain Gages, ASTM International, ISO 376:2011, Metallic materials Calibration of force-proving instruments used for the verification of uniaxial testing machines, ISO 9513:2012, Metallic materials Calibration of extensometer systems used in uniaxial testing, VDI/VDE 2635 Blatt 2, Experimental structural analysis—Recommendation on the implementation of strain measurements at high temperatures, IEC 61298-3:1998, Process measurement and control devices—General methods and procedures for evaluating performance—Part 3: Tests for the effects of influence quantities, DIN 51301, which is hereby incorporated by reference for all purposes. The strain gauges may be used in combination with other sensors in the sensing assembly or at alternate locations in the glove. Other sensors or technology that may replace or be added to the tactile sensor assemblies are discussed below.

It should be understood that other sensors and/or technology may be used instead of or in combination with the sensor assemblies discussed above. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Bruel & Kjor, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacture), (iv) inductive strain gauges, (v) capacitive strain gauges, (vi) piezoelectric strain gauges, (vii) optical fiber strain gauges, (viii) semiconductor strain gauges, and/or (ix) a hybrid or combination thereof. The strain gauges provide measurements with high accuracy, but may lack high resolution. The additional sensors used in combination with the strain gauges in the sensor assembly would help provide a higher resolution. Alternative or additional sensors/technology may include photodiodes, Hall Effect sensors, capacitive sensors, piezoelectric sensors, piezoresistive sensors, optical sensors, force-sensitive resistors (FSRs), magnetic sensors, inductive sensors, micro-electro-mechanical systems (MEMS) sensors, dielectric elastomer sensors, quantum tunneling composite (QTC) sensors, fiber Bragg grating sensors, ultrasonic sensors, thermal sensors, electroactive polymers, triboelectric nanogenerators (TENGs), linear variable differential transformers (LVDTs), flex sensors, acoustic emission sensors, resistive touch sensors, proximity sensors, hydrogel-based sensors, smart skin technologies, magnetoelastic sensors, capacitive micromachined ultrasonic transducers (CMUTs), pressure-sensitive adhesives, electromagnetic acoustic transducers (EMATs), photonic crystal sensors, laser doppler vibrometers, electrical impedance tomography sensors, graphene-based sensors, nanowire sensors, electronic skin (e-skin) sensors, carbon nanotube-based sensors, barometric pressure sensors, eddy current sensors, microfluidic tactile sensors, nanogenerators, stretchable electronic sensors, force torque sensors, rheological sensors, haptic feedback sensors, polymer nanofiber sensors, ionic liquid-based sensors, thermocouple sensors, touch-sensitive field-effect transistors, terahertz radiation sensors, radar sensors, LIDAR sensors, infrared touch sensors, humidity sensors, mechanical limit switches, pressure mapping sensors, distributed fiber optic sensors, magnetostrictive sensors, optoelectronic sensors, surface acoustic wave (SAW) sensors, capaciflectance sensors, tribo-skin sensors, spintronic sensors, photonic touch sensors, acoustic resonant sensors, and capacitive tomography sensors, or any other suitable technology that is known to one of skill in the art.

### b. Alternative Sensors

In addition to these specifically mentioned sensors 3208, the wearable collection apparatus 3200 may incorporate a variety of additional sensors 3208, or it may obtain data from other external sensors (such as those found in a VR system), to enhance the quality of data collection and to improve the accuracy of training or control with sensor fusion improving overall system accuracy by 20-40%. For clarity, these additional sensors 3208 may be grouped by category:
Motion and Position: This category includes accelerometers with measurement ranges from ±2 g to ±200 g and bandwidths up to 5 kHz, gyroscopes with drift rates better than 10 degrees/hour, and magnetometers with resolutions of 1-10 nT (which are often combined within IMU packages 3220, 3224), flex sensors for measuring bending with resistance changes of 10-100% over their range, GPS modules for absolute outdoor positioning with accuracies of 1-10 meters, 3D cameras or depth sensors for tracking limb position relative to the body or the environment with depth resolutions of 1-10 mm, optical encoders (such as 3211-3213) with resolutions up to 20 bits, tilt sensors with accuracies of 0.01-0.1 degrees, inclinometers with measurement ranges of 180 degrees, absolute or relative position sensors with resolutions down to nanometers, velocity sensors measuring speeds from 0.01-100 m/s, displacement sensors with ranges from micrometers to meters, vibration sensors detecting frequencies from 0.1 Hz to 10 kHz, angular rate sensors, linear accelerometers, rotary encoders, potentiometers for measuring rotation angle with linearities better than 0.1%, vision-based tracking systems that use markers placed on the operator 3003 or apparatus 3200 viewed by external cameras achieving sub-millimeter tracking accuracy, or Ultra-Wideband (UWB) tags for achieving precise relative positioning with accuracies of 10-30 cm.
Environmental: This category includes acoustic sensors such as microphones with frequency responses from 20 Hz to 20 kHz, which can be used for voice commands or for ambient noise awareness, proximity sensors for detecting nearby objects at ranges of 1 mm to 10 m, temperature sensors with ranges from −40° C. to +125° C., barometric pressure sensors with resolutions of 0.1 Pa, humidity sensors measuring 0-100% RH, and ambient light sensors detecting 0.01-100,000 lux.
Force and Pressure: This category includes force-sensitive resistors (FSRs) with force ranges of 0.1-100N, pressure sensors for measuring applied pressure over an area from 1-1000 kPa, piezoelectric sensors that generate voltages of 1-1000V under stress, piezoresistive sensors that change resistance by 1-10% under stress, strain gauges for measuring deformation with gauge factors of 2-200, load cells for measuring force, torque sensors (which include types like strain gauge-based with accuracies of 0.1-1%, piezoresistive with response times under 1 ms, magnetoelastic with non-contact measurement, capacitive with resolutions of 0.01%, fiber-optic with immunity to EMI, and rotary transformers for continuous rotation), tactile sensor arrays that provide distributed pressure information similar to artificial skin with spatial resolutions of 1-5 mm, shear force sensors measuring tangential forces of 0.01-100N, bending moment sensors, compression sensors, tension sensors, and impact sensors detecting accelerations up to 10,000 g.
Other: A wide variety of other sensor types might be included based on specific application needs. These can include photodiodes for light detection with spectral responses from UV to IR, Hall effect sensors for magnetic field detection with sensitivities of 1-100 mV/mT, capacitive sensors for proximity or touch detection with sensing distances of 0-50 mm, inductive sensors for metal detection or positioning with ranges of 0.5-80 mm, ultrasonic sensors for distance measurement with ranges of 2 cm to 10 m, thermal sensors for non-contact temperature measurement from −70° C. to +380° C., radar sensors operating at 24-77 GHz, or LiDAR sensors with range resolutions of 1-5 cm, though the latter are less common on a wearable apparatus 3200 compared to their use on robots.

It should be understood that other similar sensors or sensor technologies, including emerging sensor types not listed here such as quantum sensors or neuromorphic sensors, may be utilized by the wearable collection apparatus 3200. This includes sensor types or specific sensor technologies that might be disclosed in other sections of this application or are otherwise known in the art. Sensor fusion strategies that are specific to the wearable apparatus 3200, employing algorithms such as complementary filters with time constants of 0.5-5 seconds, Kalman filters (including variants like the EKF with 15-30 state variables or UKF with sigma point selections), or machine learning-based approaches using neural networks with 103 to 10⁶ parameters, may be implemented within the control system 3202 or the computer 3110. The goal of these strategies is to combine data from multiple sensors 3208 in an effective manner, aiming to achieve more accurate and robust estimates of the pose, motion, and intent of the operator 3003 with position accuracies better than 5 mm and orientation accuracies better than 2 degrees.

In addition to the sensors already mentioned, the wearable collection apparatus 3200 may incorporate additional sensors to enhance data collection and improve training accuracy. These may include:
Electromyography (EMG) Sensors (e.g., Delsys Trigno Wireless EMG System, Advancer Technologies MyoWare Muscle Sensor, Otto Bock MyoBock System)
Force-Sensitive Resistors (FSR) or Pressure Sensors (e.g., Interlink Electronics FSR 400 Series, Tekscan FlexiForce Sensors, Honeywell FSS-SMT Series Force Sensors)
Haptic Feedback Devices (e.g., Precision Microdrives Vibration Motors, Tactile Labs Haptics Actuators, Ultrahaptics (Ultraleap))
Flex Sensors (e.g., Spectra Symbol Flex Sensor, Adafruit Flex Sensor, Flexpoint Bend Sensors)
Acoustic Sensors (e.g., Knowles MEMS Microphones (e.g., SPH0645LM4H-B), Audio Analytic's ai3 Acoustic Sensor, MaxBotix MB1000 LV-MaxSonar-EZ1)
Eye-Tracking Sensors (e.g., Tobii Eye Trackers, Pupil Labs Eye Tracking Headsets, SR Research EyeLink Systems)
Proximity Sensors (e.g., Sharp GP2YOA21YKOF Infrared Proximity Sensor, STMicroelectronics VL53LOX ToF Sensor, Pepperl+Fuchs Ultrasonic Proximity Sensors)
GPS Modules (e.g., u-blox NEO-M8N GPS Module, Adafruit Ultimate GPS Breakout v3, SparkFun GPS Dead Reckoning Breakout (NEO-M8U))
Temperature Sensors (e.g., Maxim Integrated DS18B20, Texas Instruments LM35, Sensirion STS3× Series)
3D Cameras or Depth Sensors (e.g., Intel RealSense Depth Cameras (D435, D455), Microsoft Azure Kinect DK, Structure Sensor by Occipital)

### c. Control System

The control system 3202 is coupled to data storage 3204, a battery 3206, other circuitry 3209 including power management and signal conditioning, and multiple sensors 3208 including encoders 3211-3213, hand sensors 3410 detecting finger positions, and IMUs 3220, 3224 of the wearable collection apparatus 3200. The control system 3202 includes a processor, a memory, and instructions stored in the memory configured to be executed on the processor, where the instructions include applications to facilitate the collection of sensor data using the wearable collection apparatus 3200 at sampling rates of 100-10,000 Hz. Additionally, the control system 3202 may be in data communication the computer 3110, the data storage database 2900, and/or the optional display 3150 via a network 2999A-X supporting bandwidths of 1-1000 Mbps.

The control system 3202 may be attached directly to the main support portion 3242 in a mounting region that is designed to receive electronics with appropriate thermal dissipation capabilities. In some embodiments, both the battery 3206 and the control system 3202 are carried by the base mount. In other embodiments, the control system may be remotely located from the base mount, and the base mount may be coupled to a power source that is also remotely located from the mobile wearable collection apparatus. Said electronics may include sensors operating at various sampling rates from 10 Hz to 10 kHz, communication interfaces supporting protocols such as USB 3.0, Ethernet, Wi-Fi 6, and Bluetooth 5.0, processors including ARM Cortex-A series or Intel Atom processors, data storage devices using solid-state drives or eMMC storage, or any other electronic component that is needed to facilitate obtaining and transmitting sensor data from the wearable collection apparatus 3200 to the computer 3110, and/or the data storage 3204. In some embodiments, the battery 3206 or power source for the control system 3202 may reside with the control system 3202 in a housing or be coupled separately to the main support portion 3242 and electrically connected to the control system 3202 through power cables rated for 5-50 W. In some embodiments, the main support portion 3242 is configured to support at least the battery 3206 and/or control system 3202 with vibration isolation providing 20-40 dB attenuation at target frequencies.

The control system 3202 may also be configured to integrate various software applications or functionalities (e.g., running on embedded Linux or real-time operating systems). These applications may include a sensor tracking application operating at 500-1000 Hz update rates, which may incorporate a drift correction algorithm to enhance tracking accuracy to sub-degree levels. For example, the sensor tracking application is tasked with the real-time acquisition of data from the array of sensors 3208 that are distributed across the wearable apparatus 3200, managing data streams totaling 10-100 MB/s. The sensor tracking application communicates this collected sensor data to the computer 3110 for further processing through TCP/IP or UDP protocols, or it may process the data locally within the control system 3202 using edge computing capabilities. The computer 3110 and/or the on-board processors that are located within the control system 3202 then operate to refine the raw sensor data through filtering, calibration, and fusion algorithms in order to generate robot-free training data.

### d. Display

The data collection system 3020 may include a display 3150 that provides visual feedback to the operator 3003 from the robot 1 and/or from the operator's viewpoint with refresh rates of 60-144 Hz and resolutions from Full HD to 8K. To provide this visual feedback with minimal latency, the display 3150 can be incorporated into one or more types of devices, including but not limited to: standard computer monitors that use technologies like liquid crystal display (LCD) with response times of 1-5 ms, organic light-emitting diode (OLED) with infinite contrast ratios, microLED with brightness exceeding 1000 nits, or quantum dot displays with color gamuts covering 100% of DCI-P3, virtual reality (VR) or augmented reality (AR) headsets (e.g., Sony PlayStation VR with 120 Hz refresh rate, the HTC Vive with 2K per eye resolution, the Apple Vision Pro with micro-OLED displays, and the Meta Quest series with inside-out tracking), which may function as the headset device, and other head-mounted display (HMD) configurations, including those where a mobile device is positioned within a headset frame (e.g., Google Cardboard-style viewers supporting phones with 5-7 inch displays, Merge VR Goggles with adjustable lenses, Carl Zeiss VR One Plus with 100-degree field of view, Xiaomi Play2 with focus adjustment, and similar models, as well as projected displays with lumens ratings of 3000-10000). A headset device may include a head position sensor, such as an internal IMU, configured to determine a position of a head of the operator and provide head positional data to the control system.

Additionally, the display 3150 may be alternatively implemented using technologies such as transparent displays with 50-80% transparency, holographic projectors creating 3D images without glasses, electronic ink (e-ink) panels with power consumption under 10 mW, laser projection systems with 4K resolution, multi-panel display arrays creating wrap-around views, curved monitors with 1000R-1800R curvature, flexible displays that can be rolled or folded, retinal projection systems directly imaging onto the retina, and/or any other known display or display system technology that is suitable for presenting the visual feed of the robot 1. Projection mapping systems with 10,000+ lumens could serve as an alternative for the display 3150, projecting the view of the robot 1 or related information onto surfaces within the environment of the operator 3003, an approach which offers a different form of immersion or situational awareness when compared to head-mounted displays.

The display 3150 and/or the data collection system 3020 may also include capabilities for integrating additional sensor modalities to provide an enriched interaction experience for the operator 3003 with multi-modal feedback improving task performance by 15-30%. Multi-modal interaction serves to enhance the level of control precision and situational awareness. These modalities may include eye-tracking sensors with accuracies of 0.5-1 degree and sampling rates of 120-250 Hz, gesture recognition systems which may use cameras or other sensors detecting 20-50 distinct gestures, capacitive or resistive touch interfaces with response times under 10 ms which may be on associated controllers or on the display 3150 itself, voice control systems with vocabulary sizes of 1000-10000 words, or biometric sensors like heart rate monitors (30-250 BPM) or galvanic skin response sensors (0.01-100 S) providing physiological feedback. These additional sensors provide alternative input channels for the operator with recognition accuracies above 95%.

Eye-tracking technology that is integrated into a VR headset is particularly relevant in this context with calibration times under 30 seconds. Eye-tracking has several applications in VR enhancing both performance and user experience. It enables gaze-contingent rendering, which involves rendering higher detail only in the area where the operator 3003 is currently looking (typically 20-30 degrees), and it also enables foveated encoding, which involves compressing the video stream more aggressively in the peripheral vision areas with compression ratios of 10:1. These techniques serve to optimize both rendering performance and bandwidth usage by 40-60%. Both of these techniques can significantly reduce the computational load and the network bandwidth for rendering and transmitting the high-resolution video stream from the robot 1. The resulting efficiency gains are substantial, enabling higher resolution displays or reduced hardware requirements.

Furthermore, other sensor modalities, beyond those related to the interaction of the operator 3003, may be incorporated to enhance the ability of the display 3150. These may include depth-sensing cameras that provide depth maps with 1-10 mm accuracy at 30-60 fps, infrared sensors for enhanced vision in low-light conditions down to 0.001 lux, electromagnetic motion tracking systems for providing precise positional awareness of tracked objects or controllers with sub-millimeter accuracy, environmental microphones that are integrated into the display 3150 device for spatial audio processing with 360-degree sound localization, thermal imaging sensors for detecting heat signatures, and/or any other sensors that are disclosed elsewhere herein as being part of the robot 1 or the system 3020.

Integrating spatial audio rendering with 7.1 or Atmos support, which is synchronized accurately with the visual feed presented on the display 3150 with audio-visual sync within 40 ms, can further enhance the immersion and situational awareness of the operator 3003 for teleoperation tasks improving task completion rates by 10-20%. Haptic feedback mechanisms that are integrated into the display 3150 device or its associated controllers, such as vibrating motors operating at 20-1000 Hz or force feedback elements providing up to 40N, could provide tactile cues that correspond to events in the environment of the robot 1 or provide feedback related to the actions of robot 1, thereby complementing the visual and audio information with response times under 20 ms.

Operationally, the display 3150 can be physically configured in multiple ways to accommodate different use cases and operator preferences. It might be designed to use headset cameras with 4-6 cameras or outside—in tracking using external sensors with sub-millimeter precision. Additionally or alternatively, the display 3150 may include capabilities to provide augmented reality (AR) overlays with registration accuracies of 1-5 mm. These overlays would utilize environmental mapping techniques, such as simultaneous localization and mapping (SLAM) algorithms processing 30-60 fps, which could run either on the robot 1 or on the AR display device itself with dedicated processors. This would enable the dynamic alignment of virtual information or graphics with the view of the operator 3003 of their physical surroundings with update rates of 60-90 Hz, as seen either directly or through the cameras of the robot 1. Further, machine learning-based predictive tracking algorithms with prediction horizons of 20-100 ms may be implemented to anticipate the head movements of the operator 3003 more accurately and preemptively begin rendering the corresponding visuals, which further contributes to the reduction of perceived latency by 30-50%.

### e. Data Storage

The data storage database 3204 collects and stores robot-free data generated by the system 3020. The robot-free data collected and stored by the data storage database 3204 can be filtered, labeled, refined, and/or modified to generate training data that can be used for training of networks that will run on one or more robots 1. The data storage database 3204 may be a server, a hard drive, a computer, or other device or devices suitable to collect and store data. Similar to the discussion regarding the location of the computer 3110, the data store 3204 may be local to the robot 1 with direct bus connections, the wearable collection apparatus 3200 (e.g., integrated with control system 3202), or the computer 3110 with high-speed interfaces. In other examples, the data store 3204 may not be local and instead may be remote relative to one or more of the robot 1, the wearable collection apparatus 3200, or the computer 3110, connected through network links.

### 2. Robot-Free Data Collection Using the Data Collection System

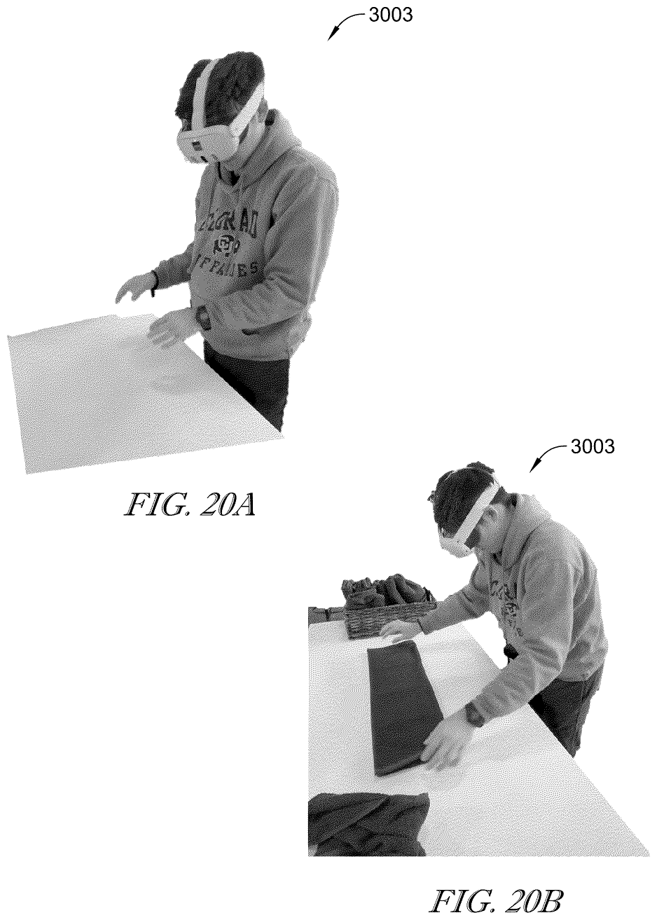

FIGS. 20A-20B illustrate an example of the data collection system 3020 that only includes a display 3150, and lacks all other components of the above described systems. Here, the operator 3003 is engaged in a towel-folding task. The robot-free training data collected by the data collection system 3020 during this task may include several data components. A primary component is the video data stream, which may consist of a sequence of image frames capturing the entire task from the viewpoint of the operator 3003. This visual data may be time-synchronized with operator state data, which can also be captured by the display 3150. This state data may include the three-dimensional position and orientation of the hands and head of the operator 3003, tracked continuously throughout the episode. This multimodal dataset, containing synchronized video and motion data, can be used to train a BAM model or policy to associate visual scenes with the demonstrated actions to complete a task, which in turn can facilitate the generation of actions for the robot 1.

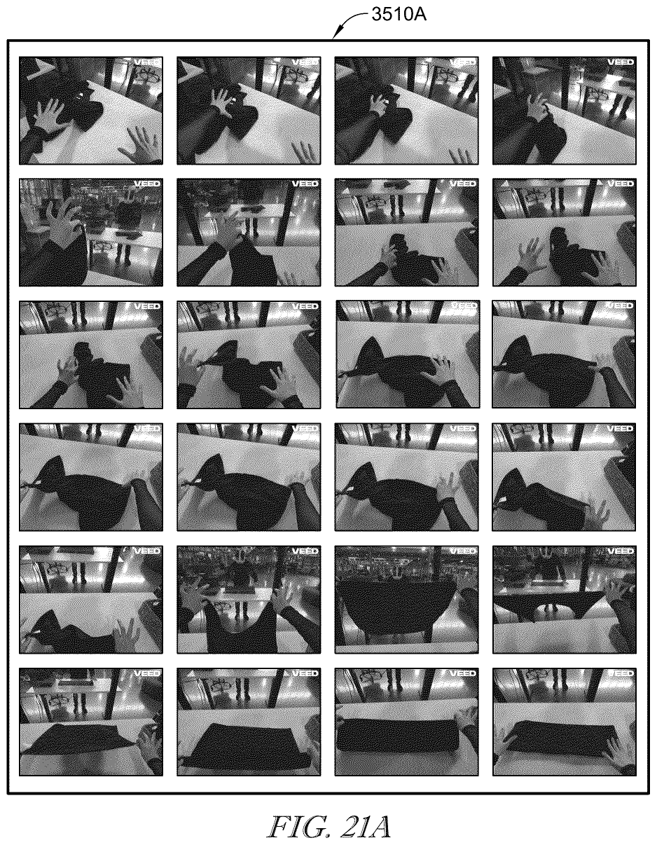

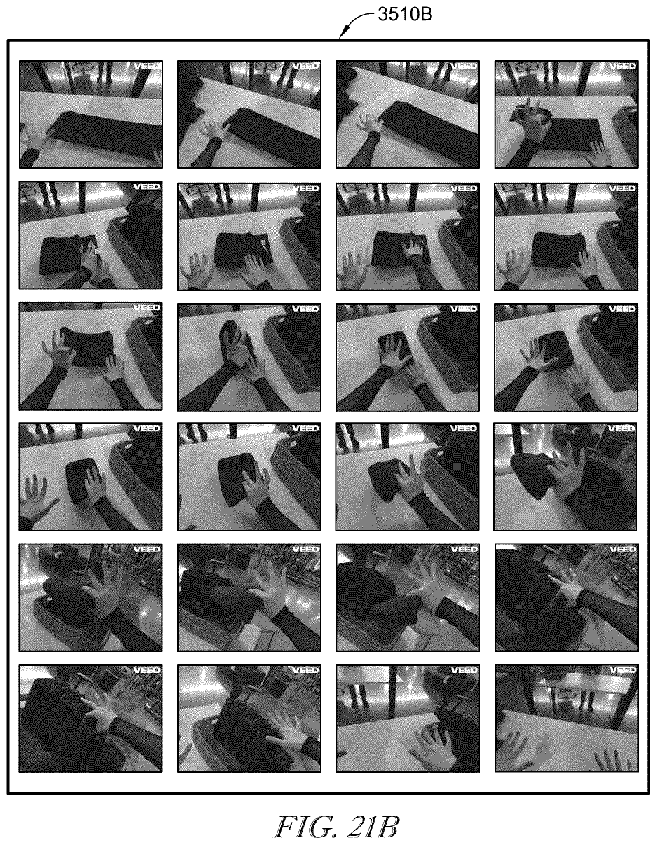

FIGS. 21A-21B show the corresponding datasets 3510A and 3510B, which are composed of sequential video snapshots of the bimanual manipulation task. The operator 3003 utilizes both hands in a coordinated manner to pick up a towel, perform a series of folds to reduce its size, and subsequently place the folded towel into a nearby basket. For this towel-folding task, the collected data provides a detailed record of a complex manipulation sequence. The datasets 3510A and 3510B provide the complete video episode from the first-person perspective of the operator 3003. Synchronized with this video is the continuous tracking of the state of the operator 3003, including the precise position and orientation of both hands of the operator 3003 as they perform the intricate folding motions. This data captures the bimanual coordination, dexterity, and procedural steps to complete the task. Such datasets, collected in a robot-free manner, may be used to train a foundation model to understand and generate action sequences for complex, multi-step manipulation tasks that involve the use of two arms.

### a. Source-to-Robot Data Retargeting

While the robot-free training data represents a potentially more scalable paradigm for data acquisition, said robot-free training data may not be usable as direct training data due to the embodiment mismatch between the operator 3003 and the robot 1. To overcome this embodiment mismatch, the robot-free training data may be retargeted or translated from robot-free training data to robot training data. This retargeting or translation may be achieved using different approaches, which include: (i) optimization-based kinematic mapping methodologies, or (ii) learning-based methodologies. In some embodiments, these approaches may be used in combination, such as using a kinematic method to generate an initial dataset for training a learning-based model.

### b. Kinematic Mapping

Kinematic mapping represents a class of methodologies for motion retargeting, specifically for translating robot-free training data to robot training data, that operates by defining and solving for a geometric or mathematical relationship between the kinematic structure of the source and that of the target robot. Such methods may be formulated to translate motion data from a source skeleton to a target robot skeleton by establishing correspondences between the two structures. This process can be broadly categorized into two primary formulations: joint-space (or configuration-space) methods and task-space (or Cartesian-space) methods. In many embodiments, these approaches are implemented as an optimization problem, wherein a set of robot joint configurations is sought that best matches the robot-free motion according to a defined set of objectives and constraints.

Joint-space mapping approaches may operate by attempting to establish a direct mapping between the joint angles contained in the robot-free data and the corresponding joint angles of the target skeleton. This may involve, for example, manually defining a mapping of joint values contained in the robot-free data to target joint values, taking into account the robot's specific kinematic structure. A system implementing this approach may constrain a robot's upper body gestures to follow the movement of the arm and torso as set forth in the robot-free data.

Instead of mapping joint configurations directly, task-space methods emphasize matching the positions and/or orientations of specific key points, or “end-effectors,” in 3D Cartesian space. For example, a system may identify the 3D position of hands, feet, and head, which are contained in the robot-free training data, as task-space targets. The retargeting problem is then formulated as an inverse kinematics (IK) problem, wherein the system solves for a set of robot joint angles that result in the robot's corresponding end-effectors (e.g., its grippers, feet, and head sensor) reaching the target task-space poses. This formulation may allow for a closer resemblance to the human-like motion, as the IK solver can find a feasible robot-specific configuration that achieves the same task-space goal, even if the joint-level solution is substantially different from the human's.

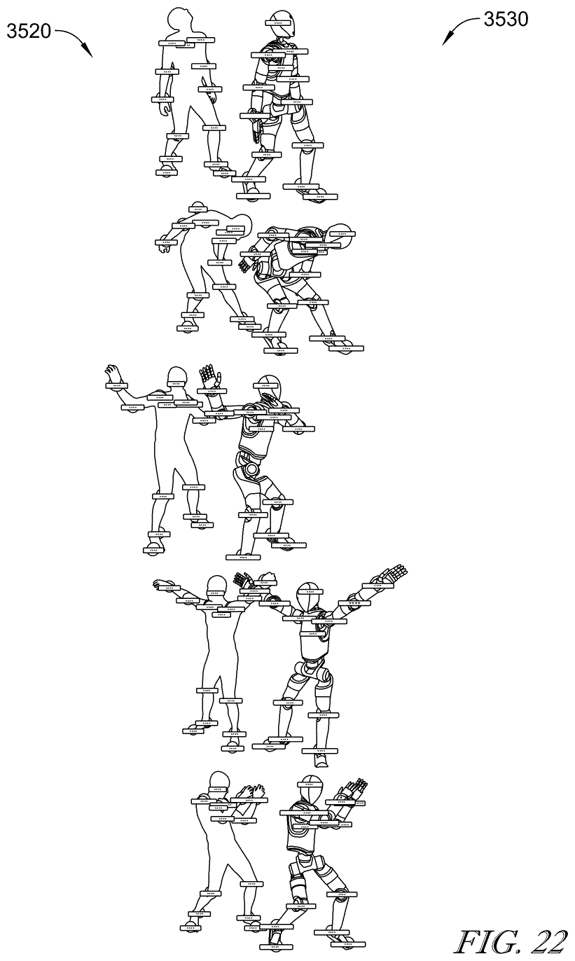

An example of this kinematic mapping process is depicted in FIG. 22. Specifically, the robot-free training data may include the sequence of human body poses, shown in column 3520. The retargeting system processes this robot-free training data frame-by-frame or over a time horizon. For each pose in 3520, the system computes a corresponding, kinematically valid pose for the target robot, as shown in the sequence in column 3530. This translation may be effected by a task-space optimization, for example, the 3D positions of the human's hands in 3520 are used as target coordinates for the robot's end-effectors in 3530. In many embodiments, the kinematic mapping process can be formulated as a trajectory optimization problem. A system may seek to find a sequence of robot joint angles q_{1:L}^{robot} that minimizes an objective function, such as the Euclidean distance between the target task-space poses (derived from the human) and the robot's forward kinematics FK(ξ^{robot}, q_{1:L}^{robot}) This optimization may be performed subject to a set of inequality constraints, g(ξ^{robot}, q_{1:L}^{robot})≥0. These constraints are operative to enforce the physical limitations of the robot, and may include, but are not limited to, joint angle limits, joint velocity and acceleration limits, self-collision avoidance constraints, and dynamic stability constraints. For example, a stability constraint may ensure that the robot's center of mass (CoM) remains within the support polygon defined by its feet, thereby allowing the system to generate motions that are not only imitative of the human but also physically feasible and stable for the specific robot embodiment.

### c. Learning Based Retargeting

Learning-based methodologies may be employed as an alternative or augmentation to kinematic mapping techniques. Such methods, often utilizing deep neural networks, may provide a system to learn complex, non-linear translations between the robot-free training data and the robot data. This approach can be advantageous as it may learn to capture and transfer meaningful features of a motion, such as the relationship between intermediate joints or the semantic intent of a gesture (e.g., a contact between two hands), which may not be correctly translated by kinematic methods that focus primarily on end-effector positions or direct joint orientation-copying.

Learning-based methodologies may be trained using unsupervised methods. The objective can be to learn a mapping function that disentangles the domain-invariant “motion information” (e.g., the motion's category, velocity, or semantic goal) from the domain-specific “performer information” (e.g., the human's specific bone lengths, joint flexibility, or balance characteristics, as described in the robot-free training data). An architecture for such a system may comprise an encoder-decoder model. The encoder may be configured to receive a motion from the source domain and infer a latent variable or representation that captures the disentangled motion information. The decoder may then receive this latent variable, as well as conditioning information about the target domain, for example, the robot's specific bone lengths or kinematic structure, and output a predicted motion sequence in the target domain.

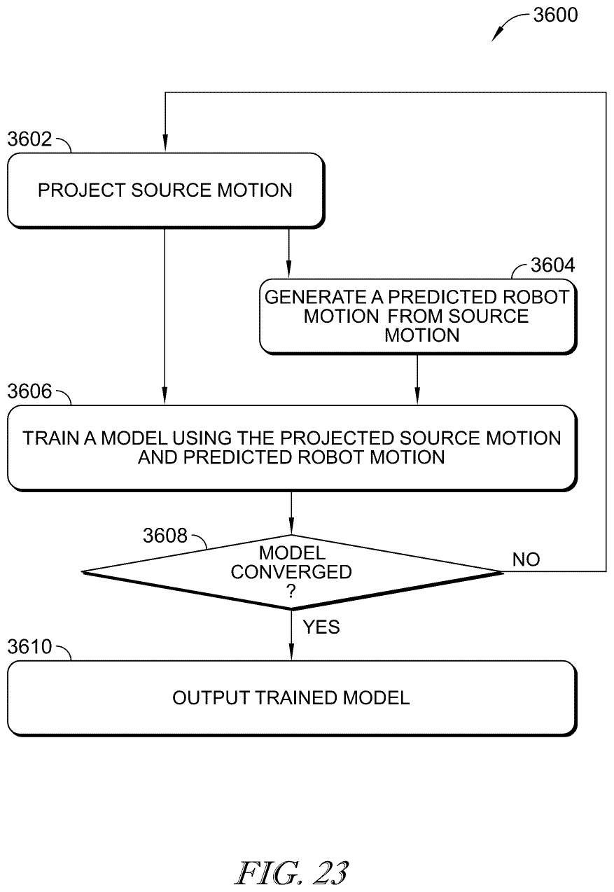

A flowchart depicting an example training process 3600 for such a system is provided in FIG. 23. At step 3602, source motion (as recorded in the robot-free training data) may be projected, for example, an input human motion sequence, x_{H}, is processed by an encoder network to project it into a latent space representation z. At step 3604, this latent representation z is used to generate a predicted robot motion \hat{x}_{R}. This step may be performed by a decoder network that is conditioned on target robot information. This forward translation function ƒ_{H→R} represents the generator component of the system.

Step 3606 may then be executed to train a model using the projected source motion x_{H} and the predicted robot motion \hat{x}_{R} in an unsupervised framework. To ensure the predicted motion \hat{x}_{R} is plausible and resides within the domain of valid robot motions, an adversarial training component may be introduced. A discriminator model may be trained to distinguish between \hat{x}_{R} and real motion samples from the unpaired robot motion dataset. The generator (ƒ_{H→R}) is then trained with an adversarial loss to produce “fake” motions \hat{x}_{R} that the discriminator classifies as “real.” To ensure the generator preserves the content of the motion rather than just producing any valid robot motion, a cycle-consistency constraint may be employed. The predicted robot motion \hat{x}_{R} from step 3604 is passed through a second translator, ƒ_{R→H}, to generate a reconstructed source motion \hat{x}_{H}. A cycle-consistency loss is then computed by comparing the original source motion x_{H} from step 3602 with the reconstructed motion \hat{x}_{H}. The system may be trained by iteratively updating the generator and discriminator models in step 3606 until the model losses converge, as determined in step 3608, at which point step 3610 outputs the trained model to provide the final, operative ƒ_{H→R} translator.

An alternative embodiment may provide a system for one-shot imitation learning from unpaired robot-free training data and robot data, particularly in contexts where a mismatch in execution style (e.g., variations in speed, or bimanual human actions versus unimanual robot actions) exists. In such an embodiment, a shared visual encoder may first be trained on the unpaired video data from both source and robot domains to map videos into a common embedding space. A training process may then be operative to automatically generate a “paired” dataset by associating robot trajectories with semantically equivalent source video snippets. This association may be achieved by processing a long-horizon robot trajectory (comprising video v_{R} and actions ξ_{R}) and “imagining” a corresponding source demonstration. This “imagining” process may involve segmenting the robot video embedding sequence z_{R} and, for each robot segment, retrieving the closest matching source video snippet from a large, unpaired robot-free dataset. This matching process may utilize a sequence-level similarity metric, such as an optimal transport distance, which calculates the minimum cost to align the entire sequence of embeddings from the robot segment to a human snippet. This sequence-level-matching approach may provide robustness against frame-level visual dissimilarities or timing mismatches. The retrieved human snippets are then concatenated to form a complete, synthetic human demonstration embedding \hat{z}_{H}. A robot policy may then be trained in a hybrid fashion, learning to predict the robot actions ξ_{R} by conditioning on both the original robot video embedding z_{R} and the “imagined” human video embedding \hat{z}_{H}.

Another alternative embodiment may utilize a co-training scheme that leverages a large corpus of human-only videos in conjunction with a small set of teleoperated robot demonstrations to bridge the domain gap. In this scheme, the human-only video data may first be processed to generate corresponding “action labels.” This can be accomplished by applying a pose estimation module (e.g., OpenPose, MediaPipe Pose, YOLOv8, and MoveNet) to the human videos to extract 3D hand and wrist poses, and subsequently applying a kinematic retargeting module (e.g., a motion adaptation or an inverse kinematics optimization) to translate these human poses into a sequence of actions in the robot's specific action space (aₜ^{h→r}). Concurrently, a temporal mapping may be established between the human demonstration sequences (now associated with retargeted actions) and the available robot demonstration sequences. This mapping may be computed using a sequence-alignment algorithm, such as dynamic time warping (DTW), to find correspondences between human timesteps and robot timesteps based on a defined distance metric, such as the distance between the retargeted human action aₜ^{h→r} and the teleoperated robot action aₜ^{r}. A robot policy may then be co-trained using both the robot data and the robot-free data. When training on a robot-free data batch, the scheme may use the pre-computed DTW map to retrieve a corresponding robot data point for a given human data point. An interpolated data sample may then be generated by performing a linear interpolation between the robot-free data (observation zₜ^{h} and retargeted action aₜ^{h→r}) and its mapped robot data (observation zₜ^{r}, and actionaₜ^{r}. This interpolation, governed by a mixing coefficient, may create intermediate data points that bridge the domain gap, allowing for a smooth adaptation from the source domain to the robot domain.

### v. Model Training

FIGS. 24-25 illustrate a general process for generating the BAM through iterative optimization and validation cycles. The process may start with the selection or generation of the deployment configuration determining computational resource allocation, the architecture defining model connectivity and information flow, and the model types specifying inductive biases and learning paradigms in step 3002. An example of the selections and/or generations that may be performed may include: (i) selecting a deployment configuration where a beta model 3102 runs on a first GPU installed within the robot's torso 1, 2700A-X, and an alpha model 3101 runs on a second GPU installed within the robot's torso 1, 2700A-x, (ii) identifying a two-model architecture with hierarchical processing, wherein a single beta model 3102 is connected to a single alpha model 3101 via a latency vector, and (iii) obtaining a VLM that was trained on internet data using a cross-entropy loss function and outputs discrete data, along with generating a cross-attention encoder-decoder transformer that was trained on robot teleoperation demonstrations using a regression loss function and outputs continuous floating-point numbers representing control signals.

Along with the selection or generation of these elements forming the model foundation, the designer may need to process, refine, structure, and enrich the collected training data through comprehensive preprocessing pipelines in step 4202. This preprocessing stage may involve annotation and labeling with semi-automated tools, where video data is segmented into distinct, meaningful segments using shot detection algorithms, each marked with timestamps aligned across sensors. These segments can then be assigned detailed natural language descriptions generated by vision-language models that explain the actions and interactions occurring within them, including object states, contact events, and task progress indicators. The entire task trajectory may also be labeled with its final outcome through automated evaluation, such as “success” with task completion metrics or “failure” with diagnostic information, to allow the model to learn from both positive and negative examples through contrastive learning. Other preprocessing techniques may include random sampling with stratification to create manageable training sequences from long demonstrations while preserving task diversity, and trajectory filtering using quality metrics to remove low-quality or irrelevant data, such as trajectories with significant occlusions detected through visibility analysis or noisy sensor readings identified through statistical outlier detection.

Other processing, refining, or structuring of the training data may include or exclude: (i) event-triggered slicing of multi-sensor streams (contact/fault/state-change) with precise temporal alignment, (ii) calibration handling (intrinsic/extrinsic updates with distortion correction, drift compensation through sensor fusion), (iii) quality control and curation (de-duplication using perceptual hashing, outlier removal with statistical methods, missing-data imputation through interpolation, checksum validation for data integrity), (iv) signal cleanup (denoising/smoothing with Kalman filtering, detrending, removing systematic biases, artifact suppression eliminating sensor glitches), (v) event/binning at byte or packet level (burst or keyframe-grouped bins) for efficient storage, (vi) kinematic reconstruction (forward/inverse kinematics solving joint configurations, twist/wrench computation for velocity and force), (vii) derived signals (contact state from force thresholds, center-of-pressure from force distribution, occupancy/height maps from depth sensors, SDFs from point clouds, cost/reward traces from task objectives), (viii) sequence/trajectory assembly with teacher-forcing or rollout annotations for supervised learning, (ix) self-supervised target generation (masking/denoising targets for reconstruction, contrastive pairs/triplets for metric learning, next-step prediction for dynamics modeling, temporal order/reversal for sequence understanding), (x) weak/explicit labeling (heuristics from domain knowledge, simulation providing perfect labels, programmatic rules encoding priors, human annotation for ground truth), (xi) data augmentation and domain randomization (spatial/photometric/temporal/viewpoint/dynamics variations; noise injection, cutout/mixup for robustness), (xii) balancing and sampling strategies (class/scene balance addressing skew, curriculum sampling with increasing difficulty, hard-negative mining focusing on errors), (xiii) compression and quantized feature caches (e.g., NF4/FP8/INT8) for storage/throughput optimization, (xiv) privacy/security filtering (anonymization removing identifiers, PII/PHI redaction for compliance, access-control tagging for permissions), (xv) metadata/provenance attachment (sensor IDs for tracking, calibration versions for reproducibility, environment/task/policy tags for organization), (xvi) retrieval indices and memory tables for RAG-style conditioning enabling knowledge grounding, (xvii) teacher/assistant signal preparation for distillation (logits as soft targets, intermediate features for matching, attention maps for structure transfer), (xviii) dataset partitioning (train/val/test with no leakage, temporal/domain/robot splits for generalization evaluation), (xix) online/streaming ingestion with back-pressure and late-bound labeling for continuous learning, (xx) any combination thereof creating comprehensive pipelines, (xxi) any processing, refining, or structuring disclosed in a paper that is incorporated herein by reference advancing best practices, and/or (xxii) any processing, refining, or structuring that is obvious to one of skill in the art.

Data augmentation may also be employed to enhance the dataset with temporal and sensory context. This can include creating a vision memory by providing the model with a sequence of recent video frames, rather than a single instantaneous frame, to improve its understanding of dynamic scenes. Similarly, a state history, comprising a temporal window of past robot or human tracking states, can be used to provide context for generating smoother and more reactive motions. The input observations may also be augmented by integrating force feedback data from tactile or force sensors, providing the policy with a sense of touch to better modulate its physical interactions. Furthermore, when training with mixed datasets of source and robot data, data alignment techniques may be used. This can involve removing robot-specific state information or randomly masking sensor data fields that are not present in the source data, which forces the model to learn from the shared data streams and improves its ability to generalize across different embodiments.

The core process of creating the BAM begins with ingestion of the training data in step 4204. Said ingestion may focus on data modifications that alter the prepared training data into information that can be consumed in the process of training the BAM, wherein said data modifications include: (i) tokenization/discretization into discrete IDs (e.g., BPE/WordPiece/Unigram for text; vector-quantized codes via VQ-VAE/RVQ, product/k-means codes for images/audio/features); (ii) patchification/tiling of images or video (fixed-size patches/tubelets) and linear projection to embedding dimension; (iii) framing/windowing of time-series or audio with fixed hop sizes; (iv) padding/truncation and bucketing to normalize sequence lengths, with optional special markers (CLS/SEP/BOS/EOS); (v) feature scaling/normalization (per-channel mean-std, min-max, whitening, log scaling, clipping to valid ranges); (vi) rate conversion/resampling and time alignment/interpolation to common sampling grids; (vii) precision casting/quantization of inputs (e.g., float32→bfloat16/float16 or INT8) for compute compatibility; (viii) embedding/projection layers that map continuous inputs (pixels, forces, IMU, tabular fields) to fixed-width vectors; (ix) positional/temporal encodings (sinusoidal/learned, rotary/relative) appended or fused with inputs; (x) coordinate-frame canonicalization (e.g., transforming sensor/EE frames to a world frame; centering/orienting 3D data; unit-cube/sphere normalization); (xi) serialization to tensor layouts utilized by the backbone (e.g., (B,T,D), (B,C,H,W), contiguous memory; ragged/sparse tensors as needed); (xii) graph construction for GNNs (node-feature matrices, edge index/adjacency in COO/CSR; batching with graph IDs); (xiii) 3D representation building (voxel/TSDF grids, occupancy/SDF fields, ray bundles for NeRF, point-cloud subsampling/quantization, mesh→point/graph conversion, normal maps); (xiv) audio representations (STFT/mel spectrograms, MFCCs, magnitude/phase splits) normalized to model-specific ranges; (xv) label/target encoding into model-readable forms (class indices, one-hot/multi-hot, normalized boxes/segments, heatmaps/keypoints, regression tensors); (xvi) masking/corruption transforms that generate masked inputs for masked-modeling objectives (e.g., MLM/MAE span masks) while preserving model-expected shapes; (xvii) multimodal fusion prep (time-locking modalities, length-matching via padding/resampling, channel/time concatenation, or projection into a shared embedding space); (xviii) sparsity formats (structured/unstructured indices) for sparse backbones or memory-efficient loaders; (xix) value/unit harmonization (unit conversions, bias/offset removal) to match learned scaling; (xx) sample/chunk packaging into fixed, indexed records (shards/TFRecord/WebDataset/LMDB) that present tensors and metadata in the exact shapes and types the network expects; and/or (xxi) any combination thereof, any method of ingestion that is disclosed in papers that are incorporated herein by reference, and/or any other method that is obvious to one of skill in the art based on this disclosure.

Once the training data has been ingested in step 4204, a training methodology can be applied to generate the BAM in step 4208. Said training methodology includes a learning method and a loss function/reward. The learning methods may include: (i) supervised learning techniques (e.g., classification, regression, behavior cloning, etc.), (ii) unsupervised learning (e.g., clustering, dimensionality reduction, anomaly detection, etc.), (iii) transfer learning (e.g., by leveraging pre-trained models), (iv) reinforcement learning (e.g., model-free methods, model-based methods), (v) semi-supervised learning (e.g., training with labeled and unlabeled data), (vi) any combination thereof, and/or (vii) any method that is disclosed in papers that are incorporated herein by reference, and/or any other method that is obvious to one of skill in the art based on this disclosure.

After a general learning method is selected, the designer can then select a loss function or develop a reward function. Examples of loss functions that may be selected can include: (i) cross-entropy (with label smoothing) and BCE-with-logits, (ii) negative log-likelihood (token-level NLL, perplexity), (iii) focal loss and Hinge/Max-margin, (iv) regression losses (MSE/L2, MAE/L1, Huber/Smooth-L1, Charbonnier, Log-cosh), (v) segmentation/detection losses (Dice, IoU/Jaccard, Tversky/Focal-Tversky, Lovisz-Softmax; box L1/GIoU/DIoU/CIoU), (vi) metric/contrastive losses (Triplet, Contrastive, N-pair, Circle, Center; Cosine-similarity; ArcFace/AAM-Softmax, CosFace), (vii) self-supervised objectives (InfoNCE/NT-Xent, BYOL/Barlow Twins/DINO; masked-modeling MLM/MAE reconstruction), (viii) autoregressive maximum-likelihood (teacher-forcing NLL, sequence-level risk), (ix) VAE objectives (ELBO, 3-VAE, KL annealing/free-bits), (x) GAN losses (non-saturating/logistic, Hinge, LS-GAN, WGAN-GP, Relativistic GAN), (xi) normalizing-flow likelihood (exact log-likelihood/bits-per-dim, FFJORD), (xii) diffusion/score matching (F-prediction MSE, v-param, xo-prediction, VLB, consistency/distillation), (xiii) audio/speech losses (STFT/multi-res STFT, spectral convergence, SI-SDR/SI-SNR with PIT, CTC, RNN-T), (xiv) 3D/geometry losses (Chamfer, EMD, point-to-surface, normal consistency, Eikonal/SDF, occupancy BCE), (xv) Perceptual/quality losses (feature/VGG, LPIPS, SSIM/MS-SSIM, total variation), (xvi) tokenizer/codebook losses (VQ commitment/codebook/EMA, Gumbel-Softmax straight-through), (xvii) distillation losses (temperature-scaled CE, KL to teacher, intermediate feature/attention transfer), (xviii) regularization terms (weight decay/L2, L1/Group-Lasso, dropout, spectral norm, orthogonality, gradient penalty, Jacobian/contractive, entropy/confidence penalties), (xix) RL policy losses (REINFORCE, PPO-Clip with value and entropy, TRPO, A2C/A3C), (xx) RL value/Q losses (TD error for DQN/Double-DQN, critic losses for DDPG/TD3, SAC entropy-regularized objective), (xxi) imitation learning losses (behavior cloning CE, GAIL discriminator, inverse RL), (xxii) any combination thereof, any method disclosed in papers that are incorporated herein by reference, or any method that is obvious to one of skill in the art based on this disclosure.

In a first example, the designer of a BAM that outputs actions in a discretized action space (e.g., discrete bins) may use a cross-entropy loss function or a negative log-likelihood (NLL) function to measure the difference between the predicted probability distribution over the action bins and the true action. In another example, the designer of the BAM that outputs actions in a continuous space may use a regression-based loss function such as mean absolute error (MAE or L1 loss) or mean squared error (MSE or L2 loss).

Additionally/alternatively, the following list of reward functions may be utilized: (i) task success and progress (sparse success, dense shaping, time penalties), (ii) safety and constraints (collisions and limit violations), (iii) control costs (action L2, energy/torque use, smoothness/jerk penalties), (iv) environment/resource rewards (throughput, latency, energy/battery, cost/revenue, risk/CVaR), (v) exploration and intrinsic motivation (entropy bonus, novelty counts, curiosity/prediction error, empowerment, information gain), (vi) preference-based/human-feedback rewards (pairwise preference models, rule-based shaping), (vii) imitation-derived rewards (inverse RL, GAIL/AIRL discriminator scores), (viii) metric-based rewards for perception/NLP (BLEU/ROUGE/CIDEr, WER, F1, PSNR/SSIM), (ix) multi-objective composition (weighted sums, lexicographic ordering, constrained/Lagrangian optimization), (x) any combination thereof, and/or (xi) any method that is disclosed in papers that are incorporated herein by reference, and/or any other method that is obvious to one of skill in the art based on this disclosure.

As shown in FIG. 25, the designer can then use the selected training methodology in connection with the previously obtained/generated components of the BAM to generate said BAM. For example, the designer may utilize supervised learning in order to modify the internal parameters of components (e.g., both the alpha and beta models 3101, 3102) of the BAM in order to minimize the error between robot action predictions and the actual robot actions provided in the training data, thereby refining its ability to generate accurate and contextually relevant text and robot actions based on human commands, images, and other visual cues. Specifically, to train both the beta model 3102 and the alpha model 3101 end-to-end (e.g., from input of the beta model 3102, through the latent vector, and to the output of the alpha model 3101), a batch of ingested training data is sampled from the preprocessed training dataset 4002 and fed to said alpha and beta models 3101, 3102 at different frequencies. The observation or “data set” 4006, derived from the training data, may include a sequence of historical video frames, other sensor data, and the robot's state. The action or “desired action” 4008, also from the training data, may be represented by an action chunk, which is a sequence of target actions for the robot that extends over a future time horizon. The observation data from the batch is ingested by the network, and the resulting observations are used by the BAM to predict an output action chunk. In various embodiments, observation data may be time-aligned to the action chunk using timestamps and interpolation, sensor inputs may be normalized to a fixed scale, and missing fields may be masked so that the BAM conditions on valid channels. The beta model 3102 may provide a latent vector that captures visual token embeddings, task text tokens, and state features, and the alpha model 3101 may incorporate this latent vector through cross-attention to produce control trajectories. The models may process sequences with positional encodings, a defined context length, and a control rate that matches the robot controller update period, so that each element of the action chunk maps to a specific future step on the horizon.

The selected loss function can then be used to calculate the loss between the action chunk output by the alpha model 3101 and the expert action chunk from the demonstration data/ground truth action. This calculated loss is backpropagated through the network. Specifically, the gradients descend from the alpha model 3101 output back to the alpha model 3101 transformer network and then through the latent vector connection into the beta model 3102. An optimization algorithm, such as Adam, is used to update the network weights to reduce the error. This training loop continues until a convergence criterion is met, such as the training loss plateauing or after a predetermined number of epochs. The output of this process is a trained model capable of generating action chunks based on visual inputs.

In certain embodiments, the loss may combine a regression term on joint targets or task-space poses with a temporal smoothness penalty across the action chunk, and may include a consistency term that aligns beta outputs with alpha-derived latent plans. The system may apply gradient clipping, weight decay, and a learning-rate schedule with warmup and cosine decay, and may use mixed precision for throughput. Convergence may be assessed on a validation split using sequence-level metrics such as horizon-integrated error, collision flags computed by a kinematic model, and satisfaction of joint and velocity limits. Batch size, horizon length, and update frequency may be selected to balance memory use and BAM stability on long sequences.

In addition to supervised learning, unsupervised learning techniques can be employed to further enhance the BAM. These techniques do not rely on actual robot actions provided in the training data but instead focus on identifying patterns and structures within the data itself. For example, the model can be trained using unsupervised methods such as clustering or self-supervised learning, where it learns to group: (i) similar human commands together, (ii) similar visual and textual features together, and (iii) predict missing parts of robot actions, images, or text. For example, teleop data may be collected for a subset of the waypoints for a given task or movement. The unsupervised learning techniques can then determine the missing waypoints for the given tasks or movements. This helps the model develop a deeper understanding of the underlying relationships between robot actions, visual, and textual information, making it more robust and adaptable to new, unseen data. In one approach, masked sequence modeling may be used over video tokens, state sequences, and action tokens so that the model reconstructs withheld segments, and contrastive objectives may align command text with visual clips and state descriptors. Latent dynamics models may predict future state embeddings from observations, which may improve action inference when labels are sparse.

Transfer learning is another method used to train the BAM. In this approach, the model is first pre-trained on a large, general-purpose dataset and then fine-tuned on a smaller, domain-specific dataset. This allows the model to leverage the knowledge it has already acquired during pre-training and apply it to more specialized tasks, significantly reducing the amount of data and computational resources for training. Reinforcement learning can also be applied to fine-tune or train the BAM, particularly in scenarios where the model needs to interact with its environment and receive feedback on its performance. In this method, the model is trained to make decisions based on inputs, with the goal of maximizing a reward signal. This can involve methods like Q-learning, which learns the value of taking actions in particular states, or policy gradient methods like proximal policy optimization (PPO), which directly optimize the policy's parameters. A hybrid approach, reinforcement learning from human feedback (RLHF), can also be used, where human preferences are used to shape the reward function, guiding the model towards more desirable behaviors without needing a manually specified reward function. Over time, the model learns to generate robot actions that not only accurately move the robot to the desired position, but also minimize the cost (e.g., battery, avoid singularities, etc.) in moving to the desired position. Finally, semi-supervised learning techniques can be utilized to fine-tune or train the BAM when only a limited amount of actual robot actions is available. In this approach, the BAM is trained on a combination of actual robot actions and unlabeled input data, allowing it to learn from the labeled actual robot action while also extracting useful information from the unlabeled input data. This method can improve the model's generalization capabilities and reduce the reliance on large, annotated datasets, making it more efficient and scalable. In various embodiments, the reward may include penalties for torque, jerk, and proximity to joint limits, along with task completion bonuses and safety margins based on distance fields. On-policy rollouts may occur in simulation with domain randomization over textures, lighting, mass, and friction, and off-policy updates may draw from a replay buffer seeded with teleop trajectories. Human feedback for RLHF may be gathered as pairwise preferences over short clips of behavior, with an aggregation process that yields a learned reward model used to fine-tune the policy. Additionally, it should be understood that the designer may freeze certain layers, features, portions, or models during the training. For example, the designer may freeze the alpha model after a predefined time/number of training cycles, while they continue to train the beta model. Likewise, the designer may freeze the beta model after a predefined time/number of training cycles, while continuing to train the alpha model.

Following the initial training, the BAM may undergo an iterative process of testing and evaluation to validate and improve its performance. The BAM may be deployed on a physical or simulated humanoid robot, which is then monitored as it attempts to perform a manipulation task autonomously. If the task is performed successfully, the BAM is considered validated for the encountered states. If the robot fails to complete the task, a process for collecting corrective demonstrations may be initiated. In this process, an operator may take control of the robot from the failure state and provide a new, expert demonstration showing the correct sequence of actions to recover and complete the task. This new corrective demonstration is then added to the original training dataset, and the model is retrained on this enriched dataset. This iterative loop of testing, collecting corrective data from failure states, and retraining allows the BAM to be progressively improved, making it more robust and capable of handling a wider range of situations. Evaluation may track success rate, path efficiency, contact forces, and time to completion, and logs may include synchronized video, proprioception, and controller signals for audit and replay. The system may stage deployments from simulation to a lab mockup and then to target environments, with versioned BAM artifacts and rollback plans, and dataset aggregation may bias sampling toward states that produced prior errors to speed correction.

Following the above validation process, the BAM can be further refined through an optional fine-tuning process. Optionally, one or more features of the received training data 4002 may be modified, for example, by using a simulation engine to alter backgrounds, objects, or environmental characteristics in the training images. The BAM can be iteratively trained using this modified data. This iterative training can involve a variety of fine-tuning strategies to adapt the general-purpose pretrained model to specific tasks, environments, or embodiments. In one configuration, the simulation engine may vary camera pose, lens parameters, illumination, object placement, textures, and physics coefficients within set ranges to generate domain-randomized scenes, while preserving action labels through pose retargeting. Data augmentation may include geometric transforms, cutout masks, and text paraphrases of commands, and the system may rebalance class frequency to expose the BAM to rare states. Sensor calibration and time offset correction may be applied so that observation 4006 aligns with desired action 4008 across all synthetic and real sequences.

One effective strategy for finetuning is co-finetuning, where the model is trained on a mixture of its original, large-scale pretraining data (e.g., internet-scale image and text data) and the smaller, domain-specific robotics dataset. This approach may help prevent catastrophic forgetting, where the model loses its general knowledge while specializing on the new data, thereby enhancing its ability to generalize to novel situations. For large models, full fine-tuning can be computationally prohibitive. In such cases, parameter-efficient fine-tuning (PEFT) methods may be employed. Techniques such as low-rank adaptation (LoRA) introduce a small number of trainable parameters in the form of low-rank matrices into the model, allowing for efficient adaptation without updating the entire set of original model weights. Other efficiency-focused techniques include model quantization, which reduces the precision of the model's weights to decrease its memory footprint and accelerate inference speed. Mixture sampling for co-finetuning may use a fixed ratio or a curriculum that increases the share of domain data over time, and replay of pretraining examples may be chosen by similarity to current tasks. LoRA ranks may be set per layer and targeted to attention and feedforward blocks, while the base weights remain frozen so that deployment footprint stays stable. Quantization may use per-channel scaling with 8-bit or 4-bit weights and calibrated activation ranges, and knowledge distillation from a larger teacher may align logits or intermediate features.

This optional iterative fine-tuning process can also be used to teach the BAM to generalize tasks and actions. For instance, a model initially trained to pick up a cup can be further trained on a diverse set of objects to learn a general “pick up” skill applicable to objects it has never seen before. This may involve training on a task-oriented subset of data or using corrective demonstrations collected from task failures to progressively improve the BAM. Finally, the fine-tuned BAM can be returned, ready for deployment on a humanoid robot. In various embodiments, skills may be encoded as goal-conditioned policies that accept object descriptors, pose targets, or language goals, and the action chunk may incorporate gripper control, force setpoints, and end-effector velocities. The deployment artifact may include the BAM, configuration files, normalization statistics for observation 4006 and desired action 4008, safety envelopes based on reachable workspace and load limits, and interface shims for common robot controllers, so that integration with existing control stacks proceeds with consistent reference numbers and terminology.

### b. Deployment of BAM and Action Output

FIG. 26 illustrates a deployed bipedal action model 5008 at runtime. The system 5000 continuously receives multimodal inputs from its environment and a human user. Robot sensor data 5002, which may include a history of recent image frames from various onboard cameras, is processed by a vision encoder 5001 to generate a sequence of vision tokens. Concurrently, a user input 5004, such as a natural language command like “carry load and walk from A to B,” is processed by a language encoder 5003. The robot's current proprioceptive state 5006, including joint angles and end-effector poses, is processed by a state encoder 5005. These three streams of encoded information are then fed into the deployed bipedal action model 5008. The model's output is a series of parallel-generated action chunks 5010, which includes Aₜ to Aₜ₊ₖ, representing a sequence of future actions. For example, an action Aₜ may be a matrix (Δa₁, . . . , Δa₆₂), where each row Δa₁ corresponds to the desired change for a specific degree of freedom of the robot, such as a vector representing changes in position and orientation (δx, δy, δz, δθₓ, δθ_{y}, δθ_{z}) for a joint. The full matrix Aₜ may have a row dimension of 62, corresponding to all 62 degrees of freedom of the robot. In other embodiments, the BAM may output a full matrix Aₜ that can have any number of rows that correspond to any number of degrees of freedom. For example, the BAM may output a matrix that includes only two rows, 18 rows, 32 rows, any number larger than 50, or any number below 150. If the BAM is tasked to output an action chunk for a subset of the robot's body, such as the upper body, then the action vector Aₜ may be a matrix with fewer rows. This sequence of chunks may cover a short future time horizon, for example, the next 10 to 500 milliseconds (preferably 50 to 150), and can be sent to the robot's low-level controllers for execution.

Action chunking is a technique where a BAM predicts and executes a sequence of multiple future actions in a single inference step, rather than generating one action at a time. In the context of vision-language-action (VLA) models, a BAM can make a single, complex decision to predict a sequence, or “chunk,” of k future actions. This chunk typically represents the target robot states (e.g., joint positions), or changes from current states for the next k timesteps. The robot then executes this sequence of actions, either fully or partially, before the BAM is queried again for the next chunk. This method reframes the learning problem from low-level mimicry to high-level trajectory generation, which can be well-suited for sequence modeling architectures like the transformer.

The use of action chunking may provide several key benefits for robotic control. A primary advantage is the mitigation of compounding errors, a common problem in imitation learning where small prediction errors accumulate over time, causing the robot to deviate from the desired trajectory. By predicting a sequence of k actions at once, the BAM makes k times fewer independent decisions, which reduces the opportunities for errors to compound and shortens the effective horizon of the task. Action chunking can also help handle non-Markovian behaviors often present in human demonstration data, such as pauses, by allowing the BAM to implicitly model temporal information within the action sequence. Furthermore, it can enable high-frequency robot control with low-frequency inference from large, computationally intensive models. The BAM can operate at a reduced frequency and at each step output a chunk of actions, while a low-level controller can execute at a much higher frequency to ensure smooth and stable motion. Action chunking may also introduce a trade-off between temporal consistency and short-term reactivity. Longer action chunks result in smoother, more consistent motion but make the system less responsive to unexpected environmental changes. Conversely, shorter action chunks allow for more frequent replanning and greater reactivity, but can increase the risk of compounding errors. The optimal chunk size, therefore, may depend on both the specific task and the latency of the model, thus requiring careful adjustments.

The disclosed BAM constitutes a material and substantial improvement over conventional robotic control systems, overcoming fundamental limitations inherent in the prior art. Whereas conventional models are narrowly circumscribed to controlling only a 7-degree-of-freedom (“DoF”) end-effector-treating the robot as little more than a disembodied arm—the disclosed BAM architecture is engineered to command the full sixty-two degrees of freedom of the humanoid robot. This comprehensive, whole-body control paradigm represents a significant departure from the state of the art. It enables the robot to execute highly coordinated, human-like motions that leverage its entire physical structure for dynamic balance adjustments, extended reach through torso and leg positioning, and sophisticated obstacle negotiation. These are capabilities that are simply unattainable with simplistic end-effector-only controllers, which cannot, by design, coordinate the robot's posture or center of gravity with the manipulation task at hand.

Furthermore, the BAM's operational modality represents a significant technical advancement. Unlike prior systems that generate discrete, binned-value outputs-thereby artificially constraining motion to a limited set of predefined poses and introducing perceptible jerkiness and imprecision—the BAM generates continuous control outputs in real time. The prior art's reliance on discrete actions is analogous to a film running at a low frame rate; motion is stilted and incapable of nuanced adjustment. The BAM's continuous control stream, by contrast, facilitates the seamless composition and blending of complex actions, a concept referred to as action chunking, which results in demonstrably smoother, more fluid, and time-consistent robotic movements. Consequently, the BAM is not merely an incremental improvement; its architecture directly remedies the deficiencies in motion quality and behavioral range that plague conventional systems. This full-body, continuous-output design allows the robot to make micro-adjustments on the fly, yielding a system that exhibits markedly enhanced robustness to environmental variations and unforeseen operational contingencies-a notable advantage for real-world deployment where conditions are seldom static.

The technical and functional superiority of the BAM is not merely theoretical but is substantiated by rigorous comparative performance data. In complex manipulation tasks involving both semantic generalization (e.g., recognizing an object's function regardless of its specific appearance) and motion generalization (e.g., placing an object in a novel position and orientation), the alpha/beta-model BAM achieved an approximate 90% success rate. This performance unequivocally surpasses that of established prior art systems, which demonstrated success rates of approximately 48% (OpenVLA), 46% (RT-2-X), 25% (RT-1-X), and a mere 4% (Octo). The disclosed system, therefore, provides a nearly two-fold performance increase over its closest competitors, elevating the technology from the level of a laboratory experiment to one approaching practical, real-world reliability.

Moreover, the BAM architecture achieves this superior performance with unprecedented parameter efficiency, underscoring its sophisticated and optimized design. The beta-only BAM variant, comprising a relatively lean 80 million parameters, achieves a success rate of approximately 40%. This level of performance is comparable to or materially exceeds that of vastly larger and more computationally demanding models, including the 7-billion-parameter OpenVLA and the 55-billion-parameter RT-2-X. The practical implications of this efficiency are profound, translating to lower hardware costs, reduced power consumption, and faster decision-making. That the disclosed BAM can outperform models that are approximately 87 to 687 times its size provides compelling evidence of its advanced and more effective architecture. Collectively, these interconnected attributes-namely, the expanded 62-DoF control scope and continuous control output that serve as the foundation for the empirically validated superiority in task success, environmental robustness, and parameter efficiency-demonstrate that the disclosed BAM offers profound and tangible technical benefits over conventional models.

### F. Alternative Embodiments

In some embodiments, the visuomotor subsystems may utilize alternative sensor and processing hardware. The perception system 1420 may comprise event-based or neuromorphic vision sensors that asynchronously report pixel-level brightness changes, which can be processed with lower latency and reduced data bandwidth. Further, the bipedal action model (BAM) may be executed on neuromorphic processing units (NPUs), which are optimized for sparse, asynchronous data, or Field-Programmable Gate Arrays (FPGAs) to create a custom, deterministic hardware pipeline for lower-latency inference. Additionally, the robot's 1 reliance on visual data may be supplemented or replaced by non-visual ranging sensors, such as LiDAR, sonar, or radar systems, to provide direct geometric information that is robust to challenging environmental conditions like poor lighting or occlusions from smoke.

The architecture defining the interaction between cognitive and reactive subsystems may also be modified. An alternative embodiment may feature a bi-directional communication link, allowing the alpha model 3101 to transmit a feedback signal (e.g., indicating high prediction error) to the beta model 3102, thereby enabling event-driven replanning. The information channel between the models 3001.1, 3001.2 may be varied; for instance, instead of a single latent vector, a structured vector with disentangled components for task goal, waypoints, and motion style could be used. In another alternative, the beta model 3102 could output a sub-goal as a natural language text string (e.g., “grasp the red box”) to be used as a direct conditioning prompt for the alpha model 3101, or a declarative set of constraints to be solved by a downstream motion planner acting as the alpha model 3101.

The hierarchical structure may be varied. For example, a “Council of Experts” architecture may employ multiple specialized models (e.g., for locomotion, manipulation, balancing) that operate in parallel, with a gating network to weigh and fuse their outputs. Another embodiment may extend the hierarchy to an alpha-beta-gamma structure, where a third-level gamma model handles high-frequency, reflexive actions.

The methods for training and deploying the BAM may be altered. An alternative embodiment may employ evolutionary algorithms or genetic programming for gradient-free optimization of the BAM. Another variation concerns runtime execution, where an event-driven cognitive process allows the beta model 3102 to remain dormant until triggered by a specific event, thereby conserving computational resources. For a fleet of robots, the retraining process may be implemented using federated learning, where anonymized model updates are computed locally on each robot and aggregated on a central server to improve a global BAM, enhancing data privacy and reducing network bandwidth.

Further embodiments may integrate the BAM with other technologies. A deployed BAM may be integrated with a real-time digital twin of the robot and its environment, allowing the BAM to simulate and validate candidate action chunks before physical execution. In another configuration, the BAM may be architected to use a predictive world model, simultaneously outputting a motor action and a prediction of the next sensory state, using the prediction error as a high-speed feedback mechanism for real-time correction. Safety may be enhanced by a hardware-based “reflex chip,” a hard-real-time coprocessor programmed with a fixed set of high-priority safety reflexes that operate independently of the main BAM stack.

The training paradigm may also be varied. Generative Adversarial Imitation Learning (GAIL) can be used, wherein the BAM (a generator) learns to produce trajectories that are indistinguishable from expert demonstrations to a discriminator network. Alternatively, the BAM can be trained using adversarial self-play in simulation against a “saboteur” agent to develop policies that are more robust to unforeseen disturbances. Meta-learning frameworks, such as Model-Agnostic Meta-Learning (MAML), may be used to train the BAM not for a single task, but to be efficient at learning new skills from a very small number of demonstrations.

### G. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a wheeled base with a torso, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. Aₜ other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/352,959, 19/355,393, 19/321,022, 19/355,531, 19/355,786, 19/357,879, 19/358,414, 19/362,617, and 19/363,293; and (iii) U.S. Design Patent Application Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A control system for a humanoid robot, the system comprising:
a bipedal action model (BAM) comprising a hierarchical architecture including:
a beta model configured to execute on one or more processors to perform cognitive tasks at a first, lower frequency, the beta model ingesting multimodal sensory inputs including visual data and natural language instructions; and
an alpha model configured to execute on one or more processors to perform reactive tasks at a second, higher frequency, the alpha model being communicatively coupled to receive a task-conditioning representation from the beta model;
wherein the BAM is trained on a dataset comprising retargeted robot training data derived from robot-free training data; and
wherein the BAM is configured to, at runtime, output a sequence of continuous control commands as parallel-generated action chunks to control motion of at least 18 degrees of freedom.

2. The system of claim 1, wherein the beta model has a larger number of parameters and a lower operating frequency than the alpha model.

3. The system of claim 1, wherein the BAM is deployed in a split configuration, wherein the beta model is executed on a remote AI system and the alpha model is executed on a local AI system physically integrated within the humanoid robot.

4. The system of claim 1, wherein the BAM is deployed in a fully local configuration, wherein both the beta model and the alpha model are executed on a local AI system physically integrated within the humanoid robot.

5. The system of claim 1, wherein the BAM is deployed in a fully remote configuration, wherein both the beta model and the alpha model are executed on a remote AI system, and wherein the humanoid robot operates as a thin client.

6. The system of claim 1, wherein the beta model is configured to output a latent vector, and the alpha model is configured to ingest the latent vector via a cross-attention mechanism to produce the continuous control commands.

7. The system of claim 1, wherein the continuous control commands are output as floating-point action vectors and are not selected from a discrete set of binned values.

8. The system of claim 1, wherein the robot-free training data was collected using a wearable collection apparatus comprising articulated arms and gloves with integrated sensors.

9. The system of claim 1, wherein the robot-free training data was retargeted using a kinematic mapping methodology that enforced a dynamic stability constraint to ensure a center of mass of the humanoid robot remained within a support polygon.

10. A system for generating a bipedal action model (BAM) for a humanoid robot, the system comprising:
a data collection system configured to generate robot-free training data, said data collection system comprising a wearable collection apparatus configured to be worn by a human operator, wherein the wearable collection apparatus includes a plurality of sensors configured to capture movement data of the human operator while the operator performs tasks without a physical or kinematic connection to the humanoid robot;
a retargeting module communicatively coupled to the data collection system, the retargeting module comprising one or more processors configured to:
receive the robot-free training data; and
translate the robot-free training data into retargeted robot training data by applying a motion retargeting methodology to solve an embodiment mismatch between a kinematic structure of the human operator and a kinematic structure of the humanoid robot; and
a training subsystem configured to train the bipedal action model (BAM) using the retargeted robot training data, wherein the trained BAM is configured to ingest multimodal sensory inputs and output continuous control commands to control a plurality of degrees of freedom of the humanoid robot.

11. The system of claim 10, wherein the wearable collection apparatus comprises:
a base mount configured to be worn on a torso of the human operator;
a pair of articulated arms pivotably attached to the base mount, each articulated arm comprising a plurality of rigid links coupled by sensor joints; and
a pair of gloves, each glove coupled to a distal end of one of the articulated arms.

12. The system of claim 11, wherein the sensor joints of the articulated arms (S1-S7) are configured to substantially correspond with a relative location and orientation of actuators (J1-J7) of an arm assembly of the humanoid robot.

13. The system of claim 11, wherein each glove includes a plurality of hand position sensors configured to capture kinematic data of the operator's fingers, said hand position sensors comprising a plurality of mechanical linkages, wherein each mechanical linkage couples a fingertip receptacle to a respective finger encoder.

14. The system of claim 13, wherein each mechanical linkage comprises a deformable member configured to bend more easily in a first curling direction than in a second lateral direction.

15. The system of claim 11, wherein each glove includes a plurality of hand position sensors comprising an electromagnetic field (EMF) source configured to generate a controlled magnetic field and a plurality of magnetic sensors configured to detect the magnetic field, and wherein the system is configured to determine a position and rotation of the operator's fingers by analyzing signal strength attenuation or phase difference.

16. The system of claim 11, wherein each glove further comprises a plurality of motors configured to provide haptic feedback to the human operator.

17. The system of claim 10, wherein the retargeting module is configured to translate the robot-free training data using a kinematic mapping methodology by solving an inverse kinematics (IK) problem to match task-space positions of the human operator's end-effectors to corresponding end-effectors of the humanoid robot.

18. The system of claim 17, wherein the kinematic mapping methodology solves the IK problem subject to a plurality of constraints, said constraints including joint angle limits, self-collision avoidance, and a dynamic stability constraint operative to ensure a center of mass (CoM) of the humanoid robot remains within a support polygon.

19. The system of claim 10, wherein the retargeting module is configured to translate the robot-free training data using a learning-based methodology, said methodology comprising an encoder-decoder neural network trained to disentangle domain-invariant motion information from domain-specific performer information.

20. The system of claim 10, wherein the continuous control commands are output as floating-point action vectors, and wherein said commands control at least 18 degrees of freedom of the humanoid robot.
